(19) United States
(12) Patent Application Publication
(10) Pub. No.: US 2026/0196235 A1
(43) Pub. Date: Jul. 9, 2026

(54) APPARATUS, METHOD, COMPUTER PROGRAM AND BITSTREAM FOR QUALITY CONTROL AND/OR ENHANCEMENT OF AUDIO SCENES

(71) Applicant: FRAUNHOFER-GESELLSCHAFT ZUR FÖRDERUNG DER ANGEWANDTEN FORSCHUNG E.V., München (DE)

(72) Inventors: Matteo TORCOLI, Erlangen (DE); Adrian MURTAZA, Erlangen (DE); Harald FUCHS, Erlangen (DE); Yannik GREWE, Erlangen (DE); Emanuel HABETS, Erlangen (DE)

(21) Appl. No.: 19/457,433

(22) Filed: Jan. 23, 2026

Related U.S. Application Data
(63) Continuation of application No. PCT/EP2024/071374, filed on Jul. 26, 2024.

(30) Foreign Application Priority Data
Jul. 26, 2023 (EP) 23187968.5

(51) Int. Cl. G10L 21/0272; G10L 19/008

(52) U.S. Cl. CPC G10L 21/0272; G10L 19/008

(57) ABSTRACT

Embodiments according to the invention comprise apparatuses, methods, computer programs and bitstreams for quality control and/or enhancement of audio scenes.

Embodiments according to the invention are related to apparatuses and methods for quality control and enhancement of audio scenes.

### CROSS-REFERENCE TO RELATED APPLICATIONS

This application is a continuation of copending International Application No. PCT/EP2024/071374, filed Jul. 26, 2024, which is incorporated herein by reference in its entirety, and additionally claims priority from European Application No. EP 23187968.5, filed Jul. 26, 2023, which is also incorporated herein by reference in its entirety.

Embodiments according to the invention comprise apparatuses, methods, computer programs and bitstreams for quality control and/or enhancement of audio scenes.

### BACKGROUND OF THE INVENTION

Difficulties in following speech due to loud background sounds are often reported for audio mixes for television (broadcasting or streaming). Loud music and effects in the background of the audio mix can mask the dialogue in the foreground, causing fatigue and frustration in the audience [1]. This has been a known issue for decades [2]. Modern audio coding systems, e.g. Next Generation Audio (NGA) systems provide functionalities providing technological solutions on the user side. These solutions include Dynamic Range Compression (DRC) and the possibility of personalizing the speech level, also known as Dialogue Enhancement [3]. Yet these conventional approaches still do not yield satisfactory results.

Therefore, it is desired to get a concept, which achieves a better compromise between a quality, e.g. in the form of a hearing impression (for example with regard to intelligibility), of an audio scene having a speech portion and a background portion, a computational efficiency for a provision, representation, encoding, decoding and/or rendering of said scene and a computational complexity of the concept.

### SUMMARY

An embodiment may have an audio decoder for providing a decoded audio representation on the basis of an encoded media representation, wherein the audio decoder is configured to obtain a quality control information from the encoded media representation; and wherein the audio decoder is configured to provide the decoded audio representation in dependence on the quality control information.

According to another embodiment, a method for providing a decoded audio representation on the basis of an encoded media representation may have the steps of: obtaining a quality control information from the encoded media representation; and providing the decoded audio representation in dependence on the quality control information.

Another embodiment may have a non-transitory digital storage medium having a computer program stored thereon to perform the inventive method for providing a decoded audio representation on the basis of an encoded media representation, when said computer program is run by a computer.

Embodiments according to the invention (e.g. according to a first aspect) comprise an audio analyzer, e.g. for supporting audio production, post-production or quality control phase, wherein the audio analyzer is configured to obtain, e.g. to receive, an audio content, e.g. an audio scene, e.g. in a format commonly used in audio production, comprising a speech portion and a background portion.

Optionally, the audio analyzer may, for example, be configured to obtain the audio content comprising the speech portion and the background portion, e.g. to obtain a “final mix” in which the speech portion and the background portion are combined, or to obtain separate signals representing the speech portion of the audio content and the background portion of the audio content separately.

Furthermore, the audio analyzer is configured to determine a short-term intensity difference (e.g. a single short-term intensity difference value describing the short-term intensity difference, or a set of short-term intensity difference values describing the short-term intensity difference for a plurality of different frequencies or frequency ranges) between a speech portion, e.g. in the sense of a “dialogue” type audio content, of the audio content (e.g. speech, and/or commentary, and/or audio description) and a background portion (e.g. music and/or effects, e.g. diffuse sound, e.g. a stadium atmosphere) of the audio content (e.g. a short-term intensity difference between an audio signal representing a speech portion of the audio content and audio signal representing a background portion of the audio content). Alternatively or in addition, the audio analyzer is configured to determine a short-term intensity information of a speech portion of the audio content.

Furthermore the audio analyzer is configured to provide a representation of the short-term intensity difference (e.g. a single short-term intensity difference value per portion of the audio content, or a set of short-term intensity difference values describing the short-term intensity difference for a plurality of different frequencies or frequency ranges, e.g. a coarsely quantized representation of the short-term intensity difference, e.g. quantized down to only 2 quantization steps, or quantized down to only three quantization steps, or quantized down to only four quantization steps) and/or a representation of the short-term intensity information of the speech portion as an analysis result, e.g. as a quality control report, or the audio analyzer is configured to derive an analysis result (e.g. a binary or ternary or quaternary value, or an information about critical passages, e.g. passages of an audio scene for which specific signal characteristics of at least one audio component (audio portion) in the audio scene do not meet one or more desired (predefined) criteria) from the short-term intensity difference (e.g. using a comparison between the short-term intensity difference and one or more threshold values, or using a comparison between the short-term intensity difference values describing the short-term intensity difference for a plurality of different frequencies or frequency ranges and respective (e.g. frequency-dependent) associated threshold values) and/or from the short-term intensity information of the speech portion.

The inventors recognized that short-term intensity differences between speech portions and background portions as well as short-term intensity information of speech portions of an audio content may be crucial indicators and adjustment tools for a quality of the audio scene, e.g. regarding hearing impression and in particular intelligibility.

It was recognized that an analysis of such short-term intensity measures (e.g. information or differences, e.g. in absolute or relative values) allows identifying critical passages of the audio scene (e.g. critical with regard to a quality of the audio scene). The inventors further recognized that even a “criticalness” of such an audio passage may be determined based on a relationship of short-term intensities of the speech portion, e.g. an acoustic foreground (e.g. also referred to as dialogue, although not limited to human talk) and of the background portion or based on a short-term intensity of the speech portion in absolute terms.

In particular, the inventors recognized that short-term intensity measures may provide a profound metric for a needed listening effort and intelligibility, wherein said measures can be obtained with low computational effort. Furthermore, based on such measures, the inventors recognized that a manipulation, e.g. improvement, of the audio scene can be performed in a straight forward manner, such as locally (e.g. temporally local, e.g. spatially local, e.g. in a certain frequency range, e.g. in a section of a time-frequency domain) changing intensity differences or ratios, e.g. in the form of energy ratios or loudness differences.

Furthermore, an audio scene may be directly modified based on the measured audio-signal characteristics, e.g. by altering the audio mix, or respective modifications may be provided or captured as metadata elements that can be applied in the receiving device and/or playback device. Hence, it was further recognized that audio enhancement based on short-term intensity measures can be provided efficiently as bitstream elements in the form of metadata, hence allowing for a good flexibility of the inventive concept.

Furthermore, embodiments do not rely on analyzing higher-order cognitive factors and can therefore be performed independent from influences such as unfamiliar vocabulary or accent or level of fluency in the language (although embodiments may optionally comprise such an analysis in addition). Hence, by using factors that do not rely primarily or even exclusively on characteristics of individual listeners or even a current cognitive state of a listener, audio scene enhancement can be performed more efficiently.

Beyond that, usage of short-term intensity measures allows providing statistics, e.g. inter alia, about the quantity, the severity as well as about the temporal locations of critical passages. This enables providing differentiated improvements for different aspects and/or portions of the audio scene, for example even allowing—although not necessarily demanding—user specific settings, e.g. such that a preferred level of intelligibility may be set by a respective end user.

According to embodiments of the invention (e.g. according to the first aspect), the short-term intensity difference and/or the short-term intensity information comprises a temporal resolution of no more than 3000 ms (e.g., short-term loudness, e.g. according to EBU TECH 3341), or comprises a temporal resolution of no more than 1000 ms, or comprises a temporal resolution of no more than 400 ms [e.g. for momentary loudness, e.g. according to EBU TECH 3341], or comprises a temporal resolution of no more than 100 ms, or comprises a temporal resolution of no more than 40 ms, or comprises a temporal resolution of no more than 20 ms. Alternatively, the short-term intensity difference and/or the short-term intensity information comprises a temporal resolution between 3000 ms and 400 ms.

The inventors recognized that such temporal resolutions in absolute terms allow providing a conclusive analysis result with fine temporal granularity.

According to embodiments of the invention (e.g. according to the first aspect), the short-term intensity difference and/or the short-term intensity information of the speech portion comprises a temporal resolution of one audio frame, or the short-term intensity difference and/or the short-term intensity information of the speech portion comprises a temporal resolution of two audio frames, or the short-term intensity difference and/or the short-term intensity information of the speech portion comprises a temporal resolution of no more than 10 audio frames.

The inventors recognized that a temporal resolution depending on a frame size may achieve a good compromise between a granularity, computational effort and conclusiveness of the analysis result.

According to embodiments of the invention (e.g. according to the first aspect), the short-term intensity difference is a short-term loudness difference, e.g. between speech or dialogue and background, or a momentary loudness difference, e.g. between speech or dialogue and background. Alternatively or in addition, the short-term intensity information of the speech portion is a short-term loudness, e.g. of speech or dialogue, or a momentary loudness, e.g. of speech or dialogue.

The inventors recognized that a loudness difference or loudness information may allow obtaining a conclusive analysis result with low computational effort.

According to embodiments of the invention (e.g. according to the first aspect), the short-term intensity difference is a short-term energy ratio, e.g. between speech or dialogue and background, or a momentary energy ratio, e.g. between speech or dialogue and background and/or the short-term intensity information of the speech portion is a short-term energy or a momentary energy.

The inventors recognized that an energy ratio or an energy information may allow obtaining a conclusive analysis result with low computational effort.

Furthermore, a determination of loudness or energy measures may be implemented in a straight forward manner, hence limiting added complexity for the inventive approach.

According to embodiments of the invention (e.g. according to the first aspect), the short-term intensity difference and/or the short-term intensity information is a low level characteristic of the audio content, which, for example, does not consider temporal correlation between different portions of the audio content, and/or which, for example, does not consider a meaning of the speech portion of the audio content and/or a vocabulary of the speech portion of the audio content, and/or an accent of the speech portion of the audio content, and/or a speed of the speech portion of the audio content, and/or a level of fluency of the speech portion of the audio content, and/or a complexity of a sentence of the speech portion of the audio content, and/or a speed of delivery of the speech portion of the audio content, and/or a phoneme articulation of the speech portion of the audio content, and/or a mumbling of the speech portion of the audio content, and/or a muffled dialogue of the speech portion of the audio content, and/or a cognitive-related intelligibility of the audio content.

Hence, audio enhancement may be performed with low computational complexity, e.g. irrespective of a complicated analysis of higher-order cognitive factors. This may be particularly advantageous, because high-level cognitive factors may be highly individual factors, based on which no (or only in a complicated manner) generic audio improvements may be performed (e.g. such that a broad audience experiences the audio scene as improved) Hence, embodiments allow reducing a computational effort by enabling to provide a “mean” improvement instead of a plethora of highly individual improvement options).

According to embodiments of the invention (e.g. according to the first aspect), the audio analyzer is configured to provide the analysis result independent from features of the speech portion of the audio content which go beyond an intensity feature, e.g. independent from a temporal correlation between different portions of the speech content; e.g. independent from a meaning of the speech portion of the audio content, and/or independent from a vocabulary of the speech portion of the audio content, and/or independent from an accent of the speech portion of the audio content, and/or independent from a speed of the speech portion of the audio content, and/or independent from a level of fluency of the speech portion of the audio content, and/or independent from a complexity of a sentence of the speech portion of the audio content, and/or independent from a speed of delivery of the speech portion of the audio content, and/or independent from a phoneme articulation of the speech portion of the audio content, and/or independent from a mumbling of the speech portion of the audio content, and/or independent from a muffled dialogue of the speech portion of the audio content; e.g. beyond an intensity characteristic; e.g. beyond a measure for an intensity.

It was recognized that the inventive approach allows providing an analysis result for audio scene enhancement based, for example only, on intensity measures, hence allowing to achieve a low complexity of the approach. Furthermore, intensity measures may be easily obtainable from existing frameworks, hence facilitating integration of the inventive concept.

According to embodiments of the invention (e.g. according to the first aspect), the audio analyzer is configured to provide the analysis result solely in dependence on one or more features of the audio content (e.g. in dependence on the short-term intensity difference measure and optionally also in dependence on an absolute intensity measure) which can be modified by a scaling, e.g. an intensity scaling or a level scaling or an energy scaling, of one or more portions, e.g. of a speech portion and/or of a background portion, of the audio content.

It was recognized that a scene modification by scaling allows achieving a good compromise for a scene enhancement with regard to computational effort and quality improvement, hence allowing to reduce an analysis effort only on those characteristics modifiable by the scaling, hence reducing computational costs for the analysis.

According to embodiments of the invention (e.g. according to the first aspect), the audio analyzer is configured to separate an obtained audio content, e.g. a “final mix”, into a speech portion of the audio content and a background portion of the audio content, e.g. using a source separation.

This may be beneficial for some audio scenes, in order to obtain an analysis result, based on which the scene can be improved efficiently. In particular, this may facilitate determining an intensity ratio or difference of an acoustic foreground and background and hence a manipulation thereof.

According to embodiments of the invention (e.g. according to the first aspect), the audio analyzer is configured to determine or estimate an intensity of a speech portion of the obtained audio content, e.g. of a “final mix”, and an intensity of a background portion of the obtained audio content, e.g. of a “final mix”, e.g. without actually separating the speech portion of the audio content and a background portion of the audio content, e.g. using a “measurement tool”.

The inventors recognized that using estimates for the intensity measures allows achieving a good compromise between an accuracy of the analysis result and computational costs.

According to embodiments of the invention (e.g. according to the first aspect), the audio analyzer is configured to provide a meta information of an audio content and/or encoded audio content as the analysis result, wherein the meta information may, for example, control a modification of the audio content.

It was recognized that it may be computationally efficient to provide meta information of an audio content and/or encoded audio content as part of the analysis result, hence reducing computational load on subsequent processing steps.

According to embodiments of the invention (e.g. according to the first aspect), the audio analyzer is configured to provide the analysis result in a character-encoded form, e.g. as a readable text, or in an xml-format, or in the form of comma-separated values (csv), and/or in binary form.

It was recognized that such a character-encoded form allows representing the inventive analysis with few bits and in a straight forward manner for subsequent processing (hence, e.g. easy to implement and to process further, e.g. easy to integrate into existing frameworks).

According to embodiments of the invention (e.g. according to the first aspect), the audio analyzer is configured to provide a visualization of the analysis result, e.g. in a form in which the analysis result is plotted over time, wherein, for example, a coloration is determined in dependence on the short-term level difference.

The inventors recognized that the inventive way of determining the analysis result may be illustrated in a straight-forward manner, hence, simplifying a determination of a subsequent individual setting, e.g. parametrization, for the scene enhancement (e.g. with regard to a desired intelligibility level), e.g. for a respective content creator.

According to embodiments of the invention (e.g. according to the first aspect), the audio analyzer is configured to obtain the short-term intensity difference and/or the short-term intensity information of the speech portion on the basis of a local power of one or more audio signals, or on the basis of a local power of a plurality of portions of the audio content. Alternatively, the audio analyzer is configured to obtain the short-term intensity difference and/or the short-term intensity information of the speech portion on the basis of a short-term or momentary loudness as per ITU-R BS. 1770 and EBU R 128 or a variation of them, e.g. using a different time window size.

This way of determining of the short-term intensity measures allows achieving a good compromise between a conclusiveness of the measures and a computational effort for a determination thereof. Furthermore, determination according to ITU-R BS. 1770 and EBU R 128 allows a simple integration into respective frameworks.

According to embodiments of the invention (e.g. according to the first aspect), the audio analyzer is configured to obtain the short-term intensity difference and/or the short-term intensity information of the speech portion on the basis of, e.g. using, one or more filtered portions of the audio content, wherein a filtering may, for example, be configured to mimic a frequency selective sensitivity of a human ear.

Filtering may allow manipulating the audio scene, so as to improve a conclusiveness of the short-term measures, e.g. by mimicking the frequency selective sensitivity of the human ear.

According to embodiments of the invention (e.g. according to the first aspect), the audio analyzer is configured to obtain the short-term intensity difference and/or the short-term intensity information of the speech portion using a computational model of loudness, which may, for example, be adapted to derive a short-term intensity value of a portion of the audio content using a linear or non-linear processing of a time interval of the audio content.

This may achieving a good compromise between a conclusiveness of the short-term intensity measure and a computational effort.

According to embodiments of the invention (e.g. according to the first aspect), the audio analyzer is configured to obtain the short-term intensity difference and/or the short-term intensity information of the speech portion using one or more artificial-intelligence-based short-term intensity estimates.

The inventors recognized that an artificial intelligence, e.g. using a neural network, may be trained to efficiently provide the short-term intensity measures.

According to embodiments of the invention (e.g. according to the first aspect), the audio analyzer is configured to combine a plurality of portions of the audio content (e.g. a plurality of portions of the audio content which are of speech type; e.g. a plurality of speech portions of the audio content originating from different speakers; e.g. a plurality of portions of the audio content which are of background type) in order to obtain the short-term intensity difference and/or in order to obtain the short-term intensity information of the speech portion. Alternatively or in addition, the audio analyzer is configured to combine a plurality of audio signals of the audio content (e.g. a plurality of audio signals of the audio content which are of speech type; e.g. a plurality of speech portions of the audio content originating from different speakers; e.g. a plurality of audio signals of the audio content which are of background type; e.g. based on a weighted combination; e.g. combining short-term intensities of portions; e.g. combining short-term intensities of audio signals), in order to obtain the short-term intensity difference and/or in order to obtain the short-term intensity information of the speech portion.

It was recognized that it may be advantageous to combine portions, e.g. sections, e.g. aspects, of the audio content, in order to provide a sufficient information basis for the inventive analysis, hence preventing to perform an analysis based on an isolated portion of the content comprising only insufficient information about its relationship to other portions of the scene.

According to embodiments of the invention (e.g. according to the first aspect), the audio analyzer is configured to determine one or more critical passages (e.g. passages in which a speech understandability or in which an intelligibility is considered as endangered, e.g. in terms of beginning/end/duration/one bit per frame), of the audio content based on the short-term intensity difference and/or based on the short-term intensity information of the speech portion, wherein a critical passage is a portion of the audio content in which an intensity of the speech portion is low, e.g. below a threshold in absolute terms and/or relatively to the background portion and wherein the analysis result comprises an information about the one or more critical passages.

It was recognized that the inventive approach allows improving an audio scene in particular with regard to passages which comprise a critical relationship between a speech portion and a background portion.

According to embodiments of the invention (e.g. according to the first aspect), the audio analyzer is configured to determine the one or more critical passages based on a comparison of the short-term intensity difference and/or based on a comparison of the short-term intensity information of the speech portion with a single threshold and/or a plurality of thresholds.

It was recognized that based on the inventive approach, using—e.g. simple to implement-thresholds may allow obtaining the analysis result with low computational complexity.

Furthermore, using a plurality of thresholds may allow classifying a critical passage with regard to its severity. A classification with regard to severity may simplify finding a setting for a respective subsequent audio improvement, e.g. with regard to different target groups (e.g. healthy, e.g. mildly hearing impaired, e.g. hearing impaired).

According to embodiments of the invention (e.g. according to the first aspect), the audio analyzer is configured to use different thresholds for different sections, e.g. different temporal sections, of the audio content, e.g. different sections of a respective speech portion, e.g. different sections of a respective background portion. Alternatively or in addition, the audio analyzer is configured to use different thresholds for different types, e.g. of a speech type, e.g. of a background type; e.g. of a type of an acoustic scene of the audio content, of audio signals of the audio content.

It was recognized that the inventive threshold concept can be adapted, e.g. with regard to a value of a threshold and the amount of threshold to the specifics of the audio scene or audio content, hence improving a conclusiveness of the analysis result.

According to embodiments of the invention (e.g. according to the first aspect), the audio analyzer is configured to use one or more frequency-dependent thresholds, e.g. according to the frequency selective sensitivity of the human ear or other psychoacoustic model; e.g. using one threshold per frequency band; e.g. in order to provide a signal in case a predetermined number of thresholds are crossed; e.g. a signal indicating that an intelligibility of the speech portion and the background portion is in danger or not given anymore.

This may hence allow adapting the analysis to characteristics of human hearing.

According to embodiments of the invention (e.g. according to the first aspect), the audio analyzer is configured to adapt one or more thresholds using artificial intelligence, e.g. using a neural network; e.g. using a manual classification as a training.

This may yield an efficient way to adapt the thresholds selectively, e.g. in view of a target audience and/or specific scene characteristics.

According to embodiments of the invention (e.g. according to the first aspect), the audio analyzer is configured to perform an inference of a neural network in order to determine one or more critical passages of the audio content, wherein a critical passage is a portion of the audio content in which an intensity of the speech portion is locally low in absolute terms and/or relatively to the background portion and wherein the analysis result comprises an information about the one or more critical passages.

It was recognize that using a neural network may allow providing the analysis result efficiently.

According to embodiments of the invention (e.g. according to the first aspect), the audio analyzer is configured to determine an information, e.g. statistical information, e.g. a statistic, of at least one of a start, an end, a duration, a quantity, a severity and/or criticalness (e.g. regarding an intelligibility level and/or listening effort needed to understand the critical passage), and/or a level of the criticalness (which may, for example be associated with an intelligibility level or listening effort needed to understand the critical passage) and/or a temporal location of the one or more critical passages. Furthermore, the analysis result comprises said information.

Hence, a differentiated analysis result may be provided, in order to allow improving the audio content purposefully, e.g. in a target-oriented manner.

According to embodiments of the invention (e.g. according to the first aspect), the audio analyzer is configured to determine an information about a severity and/or criticalness, e.g. regarding an intelligibility level and/or listening effort needed to understand the critical passage, of the one or more critical passages using two or more states.

This may allow providing the analysis result with a good compromise regarding complexity and granularity.

According to embodiments of the invention (e.g. according to the first aspect), the audio analyzer is configured to provide the analysis result in the form of a binary analysis result, e.g. indicating whether a characteristic of the audio content fulfills a condition (e.g. audio signal is easy to understand) or not (e.g. audio signal is not easy to understand; e.g. audio signal is hard to understand). Alternatively, the audio analyzer is configured to provide the analysis result in the form of a ternary analysis result, e.g. distinguishing three different classification levels of the characteristic or three different grades of the characteristic or three different ranges of values of the characteristic, e.g. indicating whether the audio content or a portion thereof is understandable with low, medium and/or high listening effort. Alternatively, the audio analyzer is configured to provide the analysis result in the form of a quaternary analysis result, e.g. indicting to which degree a characteristic of the audio content fulfils a condition; e.g. distinguishing four different classification levels of the characteristic or four different grades of the characteristic or four different ranges of values of the characteristic.

This may allow providing the analysis result with a good compromise regarding complexity and granularity.

According to embodiments of the invention (e.g. according to the first aspect), the audio analyzer is configured to determine the short-term intensity difference and/or the short-term intensity information of the speech portion as an approximation for an intelligibility or listening effort for the audio content.

Hence, a low level characteristic may be used in order to approximate a high level cognitive characteristic, which allows achieving a good compromise regarding a conclusiveness of the analysis and a computational effort.

According to embodiments of the invention (e.g. according to the first aspect), the audio analyzer is configured to determine an additional quality control information, e.g. loudness compliance; peak level, based on the audio content.

Such an additional information may allow improving a subsequent scene enhancement.

According to embodiments of the invention (e.g. according to the first aspect), the audio analyzer is configured to use at least one absolute or relative threshold on one or more audio components, e.g. portions of the audio content, or on one or more groups of audio components as one or more desired criteria, e.g. in order to identify critical passages, wherein absolute thresholds are related to the short-term intensity of, for example respective, one or more selected audio components, e.g. a speech portion of the audio content, or groups of audio components, and wherein relative thresholds are related to the short-term intensity differences between audio components, e.g. between a speech portion of the audio content and a background portion of the audio content, or groups of audio components.

According to embodiments of the invention (e.g. according to the first aspect), the audio analyzer is configured to combine multiple audio signals of the same or similar type to form component groups.

This may allow improving an information basis for the subsequent analysis, e.g. incorporating information about a relationship of the combined signals, instead of individual analysis, e.g. allowing to determine or use relative thresholds.

According to embodiments of the invention (e.g. according to the first aspect), the audio analyzer is configured to combine multiple audio signals of the same or similar type to form component groups based on an importance of the multiple audio signals, where the importance of the audio signals is manually set or determined based on the speech parts contained in the signal, and/or based on the contribution of each audio signal to the final mix, considering audio masking effects and the properties of the human hearing system.

This may allow achieving an analysis with respect to an importance of a respective audio signal or group of audio signals. Hence, this may allow introducing a parameter for emphasizing certain aspects of the audio content, e.g. with regard to their intelligibility.

According to embodiments of the invention (e.g. according to the first aspect), the audio analyzer is configured to obtain an averaged speech information of the audio content, to compare the short-term intensity information (e.g. as an absolute (short-term) intensity of speech) to the averaged speech information in order to obtain a comparison result (e.g. a quantitative comparison result, e.g. an information about a ratio or difference between the short-term intensity information and the averaged speech information) and to derive an analysis result comprising an information about a deviation of the short-term intensity information from the averaged speech information, based on the comparison result. The analysis result may, hence optionally, be the comparison result, or, for example, an interpreted version thereof, e.g. indicating a severity of the deviation.

According to embodiments of the invention (e.g. according to the first aspect), the averaged speech information comprises at least one of an information about an averaged speech level or about an averaged speech intensity or about an averaged speech loudness of the audio content.

According to embodiments of the invention (e.g. according to the first aspect), the audio analyzer is configured to determine the averaged speech information based on an averaging, e.g. integration, over a predetermined time interval of the audio content, e.g. audio program.

According to embodiments of the invention (e.g. according to the first aspect), the audio analyzer is configured to provide the analysis result based on a combined evaluation of the short-term intensity difference and the deviation of the short-term intensity information from the averaged speech information.

According to embodiments of the invention (e.g. according to the first aspect), the audio analyzer is configured to determine an information about a local speech level as the short term intensity information; determine the averaged speech information based on a speech loudness averaged over the full audio content, or averaged over a time period having a length which is at least ten times longer than a duration over which the short term intensity difference or the short term intensity information is determined; compare the local speech level to the averaged speech information in order to obtain the comparison result; and derive an analysis result based on an evaluation of the comparison result with regard to a threshold, e.g. in order to classify a severity of the deviation.

According to embodiments of the invention (e.g. according to the first aspect), the audio analyzer is configured to determine an information about an evolution over time of a short-term intensity difference between a speech portion of the audio content and a background portion of the audio content, and/or the audio analyzer is configured to determine an information about an evolution over time of a short-term intensity information of a speech portion of the audio content, and the audio analyzer is configured to derive an analysis result (102, 622) from the information about the evolution over time of the short-term intensity difference and/or from the evolution over time of the short-term intensity information of the speech portion.

The absolute intensity of speech may, for example, be an important addition to the short-term loudness difference between speech and background, based on which according to embodiments an analysis result is provided. In particular, the evolution over time of the absolute intensity of speech is of interest, according to some embodiments. In other words, some embodiments, e.g. in particular the above-discussed, may be based on the idea to detect whether the speech level (e.g. as indicated by a short-term intensity) deviates too much from the average speech level (e.g. as indicated by an averaged speech information) during the full program (or a temporal interval of the audio content), e.g. even regardless of its relation to the background.

Hence, embodiments optionally comprise an evolution over time of respective short-term intensity information or short-term intensity differences. Another inventive idea according to embodiments is to detect critical passages if the absolute level of speech locally deviates by a certain threshold, e.g. 10 LU, from the speech loudness integrated over the full program (or for example over a section of the program). In particular a combined analysis of absolute speech loudness deviation and short-term speech loudness relative to the background may be performed according to embodiments.

Furthermore, embodiments comprise an audio analyzer (100, 600, 800), wherein the audio analyzer is configured to obtain an audio content (101, 601, 631, 1001, 1201, 1241) of an audio scene comprising a speech portion and a background portion; wherein the audio analyzer is configured to determine a short-term intensity difference (112, 812) between a speech portion of the audio content and a background portion of the audio content, and/or wherein the audio analyzer is configured to determine a short-term intensity information (112, 612, 1112) of a speech portion of the audio content, and wherein the audio analyzer is configured to derive an analysis result (102, 622) from the short-term intensity difference and/or from the short-term intensity information of the speech portion, in order to provide an information about critical passages of the audio scene for which specific signal characteristics of at least one audio component in the audio scene do not meet one or more predefined criteria.

As an example, a final goal of the analysis may for example, be the concept of critical passages (possibly leading to increased listening effort (e.g. identifying sections needing increased listening effort), or more in general “not meeting one or more desired criteria”) and hence an enhancement of the audio content with regard to such passages.

Embodiments according to the invention (e.g. according to a second aspect) comprise an audio analyzer, e.g. supporting audio production, post-production or quality control phase, wherein the audio analyzer is configured to obtain, e.g. receive, an audio content (e.g. an audio scene, e.g. in a format commonly used in audio production) comprising a speech portion and a background portion, e.g. to obtain a “final mix” in which the speech portion and the background portion are combined, or to obtain separate signals representing the speech portion of the audio content and the background portion of the audio content separately. Furthermore, the audio analyzer comprises a neural network configured to derive a quality control information (e.g. a representation of a short-term intensity difference; e.g. a representation of a short-term intensity of the speech portion; e.g. a single short-term intensity difference value per portion of the audio content, or a set of short-term intensity difference values describing the short-term intensity difference for a plurality of different frequencies or frequency ranges; e.g. a coarsely quantized representation of the short-term intensity difference, e.g. quantized down to only 2 quantization steps, or quantized down to only three quantization steps, or quantized down to only four quantization steps, e.g. an information about critical passages, e.g. passages of an audio scene for which specific signal characteristics of at least one audio component (audio portion) in the audio scene do not meet one or more desired (predefined) criteria) on the basis of the audio content.

The inventors recognized that embodiments according to the first aspect may be implemented or their respective functionality may be achieved, using a neural network. Hence, the analysis result may correspond to the quality control information, or the quality control information may comprise the analysis result. Hence, embodiments according to the second aspect of the invention may comprise any features, functionalities and/or details of embodiments according to the first aspect of the invention both individually or taken in combination. Optionally, embodiments according to the first aspect may be used in order to train a respective neural network. Once trained, neural networks may excel with regard to the processing speed of the audio content, e.g. in comparison to implementations according to the first aspect without neural network.

According to embodiments of the invention (e.g. according to the second aspect), the neural network is configured, e.g. trained, to obtain a representation of a short-term intensity difference between a speech portion of the audio content and a background portion of the audio content (e.g. a single short-term intensity difference value per portion of the audio content, or a set of short-term intensity difference values describing the short-term intensity difference for a plurality of different frequencies or frequency ranges, e.g. a coarsely quantized representation of the short-term intensity difference, e.g. quantized down to only 2 quantization steps, or quantized down to only three quantization steps, or quantized down to only four quantization steps) and/or a representation of a short-term intensity information of the speech portion of the audio content as an analysis result. Furthermore, the audio analyzer is configured to provide the representation of the short-term intensity difference and/or the representation of the short-term intensity information of the speech portion of the audio content as the quality control information.

According to embodiments of the invention (e.g. according to the second aspect), the neural network is trained using an audio analyzer according to embodiments (e.g. according to the first aspect), e.g. wherein the audio analyzer and the neural network are provided with a same input and wherein, for example, the neural network is adapted and/or optimized in order to approximate a respective output of the audio analyzer.

According to embodiments of the invention (e.g. according to the second aspect), the audio analyzer is configured to separate the speech portion and a background portion of the audio content in order to provide the separated speech portion and/or background portion to the neural network, e.g. to perform a source separation before performing an inference using the neural network; e.g. to perform a preprocessing.

According to embodiments of the invention (e.g. according to the second aspect), the audio content comprises the speech portion and the background portion in a combined manner, e.g. in a mixed manner; e.g. in the form of a combined audio signal into which the speech portion and the background portion are combined. Furthermore, the audio analyzer is configured to provide the neural network with the speech portion and the background portion in the combined manner (e.g. as a “final mix”).

According to embodiments of the invention (e.g. according to the second aspect), the audio analyzer is configured to provide the neural network with the speech portion and the background portion in the form of individual signals, hence, as an example, speech portion and background portion separately.

According to embodiments of the invention (e.g. according to the second aspect), the audio analyzer comprises a first neural network for deriving the quality control information based on an audio mix, e.g. comprising the speech portion and the background portion in an interleaved manner, of the audio content and the audio analyzer comprises a second neural network for deriving the quality control information based on the speech portion and the background portion of the audio content provided as separate entities of information.

It was recognized that combining results of an analysis of the audio content as a whole (e.g. speech+background) as well as in separated form may increase a conclusiveness of the result. Using neural networks may allow limiting the computational costs although having such a twofold approach.

According to embodiments of the invention (e.g. according to the second aspect), the audio analyzer comprises an end-to-end detector, e.g. a module, e.g. artificial-intelligence based or neural net based, to detect critical passages, e.g. of the audio content, directly from one or more input signals.

It was recognized that a neural network may be trained so as to provide an information about critical passages in one step.

According to embodiments of the invention (e.g. according to the second aspect), the end-to-end detector, e.g. module, is configured to switch between to submodules (e.g. a first submodule configured to detect critical passages in a mix signal representation of the audio content and a second submodule configured to detect critical passages in a separate-signal representation of the audio content) depending on an input format type.

Hence, an inventive analysis may be performed in a manner optimized for a respective input format.

Embodiments according to the invention (e.g. according to a third aspect) comprise an audio processor for processing an audio content, wherein the audio processor is configured to obtain, e.g. receive, an audio content comprising a speech portion and a background portion. Furthermore, the audio processor is configured to determine a short-term intensity difference (e.g. a single short-term intensity difference value describing the short-term intensity difference, or a set of short-term intensity difference values describing the short-term intensity difference for a plurality of different frequencies or frequency ranges) between a speech portion of the audio content and a background portion of the audio content. Alternatively or in addition, the audio processor is configured to determine a short-term intensity of the speech portion. Furthermore, the audio processor is configured to modify the audio content in dependence of the short-term intensity difference and/or in dependence on the short-term intensity of the speech portion (e.g. in order to (optionally selectively) improve a speech intelligibility (e.g. for portions of the audio content having a comparatively low short-term intensity difference), e.g. by (optionally selectively) modifying the speech portion of the audio content and/or the background portion of the audio content and/or a parameter information of the audio content (e.g. a gain value, or a processing parameter) (e.g. for portions of the audio content having a comparatively low short-term intensity difference), e.g. to thereby (optionally selectively) increase an intensity difference between the speech portion of the modified audio content and the background portion of the modified audio content when compared to the original intensity difference (e.g. for portions of the audio content having a comparatively low short-term intensity difference), or wherein the audio processor is, for example, configured to determine a metadata information about the audio content based on the short-term intensity difference and/or based on the short-term intensity of the speech portion, so that based on the metadata information a relationship between the speech portion and the background portion of the audio content can be modified and/or so that speech, e.g. in form of the speech portion, can be modified or enhanced (e.g. by modifying its intensity and/or by applying a frequency-dependent filtering) (e.g., so that its absolute level is boosted, e.g. so that it is compressed, e.g. by applying a frequency-dependent filter) (for example regardless of the relationship with the background) [for example in case there are portions where speech is low in absolute terms and not relatively to the background; which may, for example be addressed by a decoder; which may, for example, be important for speech-only passages (e.g. no or only little background at all), for example but also for cases in which it might be considered a better idea to apply compression or equalization to the full mix instead of a rebalancing).

Furthermore, the audio processor may, for example, be configured to provide a file or stream as a result of the modification of the audio content, wherein the file or stream comprises the unmodified audio content and the metadata information.

Alternatively, the audio processor is configured to determine a metadata information about the audio content based on the short-term intensity difference and/or based on the short-term intensity of the speech portion and to provide a file or stream, e.g. Audio Master file, wherein the file or stream comprises the, e.g. unmodified; e.g. uncompressed, audio content and the metadata information (e.g, wherein the audio processor is configured to alter or modify the audio content or to add additional information to the audio content, e.g. to keep the audio content itself unchanged but to add additional metadata information, e.g. based on the short-term intensity difference and/or in dependence on the short-term intensity of the speech portion, wherein, for example, the audio processor is configured to amend the audio content using an alteration of an audio content representation that is input into the audio processor, or using an addition of additional metadata information to the audio content representation that is input into the audio processor, in dependence of the short-term intensity difference and/or in dependence on the short-term intensity of the speech portion).

An audio processor according to embodiments of the invention may optionally comprise a functionality as discussed in the context of audio analyzers according to the first and/or second aspect, e.g. with regard to processing the audio content, in order to determine short-term intensity measures. Hence, an audio processor according to the third aspect may comprise any or all of the functionalities, details and/or features as discussed in the context of audio analyzer according to the first and/or second aspect, both individually or taken in combination.

Furthermore, the inventors recognized that an inventive audio processor may allow modifying the audio content, e.g. directly, and/or to provide metadata information about the audio content (based on which a subsequent modification may, for example, be performed).

Hence, the inventors recognized that based on the short-term intensity measures, apart from direct audio improvements, metadata information may be incorporated in a stream, in order to allow for decoder sided or end-user sided audio improvement.

According to embodiments of the invention (e.g. according to the third aspect), the audio processor is configured to modify, e.g. in a time-variant manner, a short-term intensity difference between a speech portion of the audio content and a background portion of the audio content, in order to obtain a processed version of the audio content. Alternatively, or in addition, the audio processor is configured to modify, e.g. in a time-variant manner, a short-term intensity of a speech portion of the audio content, in order to obtain a processed version of the audio content.

The inventors recognized that modifying such an intensity measure may allow improving audio content yielding good results, e.g. in particular with regard to intelligibility, and limited computational costs.

According to embodiments of the invention (e.g. according to the third aspect), the audio processor is configured to modify the obtained audio content with a temporal resolution of no more than 3000 ms, e.g., short-term loudness, e.g. according to EBU TECH 3341, or with a temporal resolution of no more than 1000 ms, or with a temporal resolution of no more than 400 ms, e.g. for momentary loudness, e.g. according to EBU TECH 3341, or with a temporal resolution of no more than 100 ms, or with a temporal resolution of no more than 40 ms, or with a temporal resolution of no more than 20 ms, in order to obtain a processed version of the audio content. Alternatively, the audio processor is configured to modify the obtained audio content with a temporal resolution between 3000 ms and 400 ms.

According to embodiments of the invention (e.g. according to the third aspect), the audio processor is configured to modify the obtained audio content with a temporal resolution of one audio frame, or with a temporal resolution of two audio frames, or with a temporal resolution of no more than 10 audio frames, in order to obtain a processed version of the audio content.

According to embodiments of the invention (e.g. according to the third aspect), the audio processor is configured to scale a speech portion of the obtained audio content and/or a background portion of the obtained audio content, in order to obtain a processed version of the audio content, optionally such that, for example, an audio mix is altered directly.

According to embodiments of the invention (e.g. according to the third aspect), the audio processor is configured to provide or alter metadata (e.g. a gain information describing one or more gains to be applied to one or more different portions of the audio content at the side of an audio decoder, e.g. to thereby effect a scaling of a speech portion of the obtained audio content and/or a scaling of a background portion of the obtained audio content, e.g. at the side of an audio decoder), in order to obtain a processed version of the audio content, optionally such that, for example, an audio mix is altered indirectly.

It was recognized that the inventive approach, addressing intensity measures, allows improving a quality of an audio scene with limited impact on a scene representation, namely by altering or providing metadata of the scene. Hence, a scene improvement may be performed with low computational effort.

According to embodiments of the invention (e.g. according to the third aspect), the audio processor is configured to determine a metadata information about the audio content based on the short-term intensity difference and/or based on the short-term intensity of the speech portion, so that based on the metadata information a relationship between the speech portion and the background portion of the audio content can be modified and/or so that based on the metadata information the speech portion, e.g. speech, can be modified (e.g. by modifying its intensity and/or by applying a frequency-dependent filtering, e.g. enhanced; e.g. so that speech is enhanced (e.g., so that its absolute level is boosted, e.g. so that it is compressed, e.g. by applying a frequency-dependent filter); for example regardless of the relationship with the background, for example in case there are portions where speech is low in absolute terms and not relatively to the background; which may, for example be addressed by a decoder; which may, for example, be important for speech-only passages (e.g. no or only little background at all), for example but also for cases in which it might be considered a better idea to apply compression or equalization to the full mix instead of a rebalancing.

Furthermore, the audio processor is configured to provide a modified audio content, comprising the audio content, e.g. in an unmodified manner, and the metadata information, e.g. so that the modified audio content comprises the original audio content or at least an unmodified audio signal thereof and corresponding metadata information for a manipulation of the audio content or audio signal, e.g. with respect to relationship of a speech portion and a background audio portion.

According to embodiments of the invention (e.g. according to the third aspect), the audio processor is configured to format the metadata information according to an audio data frame rate of the audio content.

Hence, embodiments may allow a seamless integration in existing frameworks.

According to embodiments of the invention (e.g. according to the third aspect), the audio processor is configured to separate the speech portion and the background portion of the audio content.

According to embodiments of the invention (e.g. according to the third aspect), the audio processor comprises an audio analyzer according to one of the above-discussed embodiments, e.g. according to the first and/or second aspect, wherein the audio processor is configured to modify the audio content in dependence on the analysis result.

According to embodiments of the invention (e.g. according to the third aspect), the audio processor comprises an audio analyzer according to one of the above-discussed embodiments, e.g. according to the first and/or second aspect wherein the audio processor is configured to modify or generate a or the metadata information according to the results, e.g. in dependence on the analysis result, of the audio analyzer.

According to embodiments of the invention (e.g. according to the third aspect), the audio processor comprises an audio analyzer according to one of the above-discussed embodiments, e.g. according to the first and/or second aspect, wherein the audio processor is configured to store a or the metadata information aligned with the audio data in a file or stream, e.g. an Audio Master file or stream. Hence, embodiments may allow a seamless integration in existing frameworks, e.g. adapted to the specifics of the respective file or stream format.

Embodiments according to the invention (e.g. according to a fourth aspect) comprise a bitstream provider, e.g. for providing an audio bitstream or for providing transport stream, wherein the bitstream provider is configured to include an encoded representation of an audio content, e.g. an encoded representation of an audio content comprising a speech portion and a background portion, and a quality control information, e.g. quality control metadata, into a bitstream (e.g. into an audio bitstream comprising both the encoded representation of the audio content and the quality control information, or into a transport bitstream comprising an audio bitstream and the quality control information; wherein, for example, the quality control information may be embedded into descriptors for MPEG-2 Transport Stream or into file format boxes for ISOBMFF][wherein, for example, the quality control information may be provided in a syntax element of the bitstream which is suited for a pass-through by (legacy) devices which do not evaluate or process the quality control information).

The quality control information may comprise metadata information as discussed with regard to embodiments according to the third aspect of the invention and/or an information about an analysis result, as discussed with regard to embodiments according to the first and/or second aspect of the invention (e.g. as a basis for the metadata information or separately).

Hence, a bitstream provider according to embodiments of the invention may comprise a functionality as discussed in the context of audio analyzers according to the first and/or second aspect, e.g. with regard to processing the audio content, in order to determine short-term intensity measures and/or may comprise a functionality as discussed in the context of audio processors according to the third aspect of the invention.

In other words, a bitstream provider according to embodiments according to the fourth aspect may comprise any or all of the functionalities, details and/or features as discussed in the context of audio analyzer according to the first and/or second aspect and/or in the context of audio processors according to the third aspect of the invention, both individually or taken in combination.

It was recognized that for example based on the inventive analysis, a quality control information may be provided in a bitsteam, which enables improving the audio scene efficiently, so as to cause only little or limited additional load on a respective bitstream and good enhancement results.

According to embodiments of the invention (e.g. according to the fourth aspect), the quality control information enables or supports a decoder-sided, e.g. selective, modification of a relationship between an intensity of a speech portion of the audio content and a background portion of the audio content. Alternatively or in addition, the quality control information enables or supports a decoder-sided modification, e.g. enhancement, of the speech portion, e.g. the speech (e.g. so that based on the quality control information the speech portion can be modified; e.g. by modifying its intensity and/or by applying a frequency-dependent filtering; e.g. enhanced; e.g. so that speech is enhanced (e.g., so that its absolute level is boosted, e.g. so that it is compressed, e.g. by applying a frequency-dependent filter); for example regardless of the relationship with the background; for example in case there are portions where speech is low in absolute terms and not relatively to the background; which may, for example be addressed by a decoder; which may, for example, be important for speech-only passages (e.g. no or only little background at all), for example but also for cases in which it might be considered a better idea to apply compression or equalization to the full mix instead of a rebalancing).

According to embodiments of the invention (e.g. according to the fourth aspect), the quality control information enables or supports a decoder-sided, e.g. selective, improvement of a speech intelligibility of a speech portion of the audio content, e.g. in the presence of a background portion of the audio content reducing the speech intelligibility.

According to embodiments of the invention (e.g. according to the fourth aspect), the quality control information selectively, e.g. in a time-dependent manner, enables and disables a decoder-sided improvement of a speech intelligibility of a speech portion of the audio content (e.g. in the presence of a background portion of the audio content reducing the speech intelligibility; e.g. although, for example, actually the quality control information may not actively enable a decoder-side improvement, but conversely, it may, for example, indicate (e.g. selectively) where a decoder-side improvement may make sense or may be appropriate).

Alternatively, the quality control information indicates for which passages of the audio content a decoder-sided improvement of a speech intelligibility of a speech portion of the audio content, e.g. in the presence of a background portion of the audio content reducing the speech intelligibility, is allowable.

It was recognized that the inventive analysis of the audio content allows obtaining an information defining constraints for a scene modification, in order to prevent modifications, which would lead to a deterioration of speech and background portions.

According to embodiments of the invention (e.g. according to the fourth aspect), the quality control information comprises an information, e.g. a dedicated information; e.g. a dedicated flag or a dedicated quantitative value, with respect to (e.g. an information about; e.g. an information signaling; e.g. an information describing) critical time portions, e.g. passages, of the audio content (e.g. an information signaling critical time portions of the audio content and/or an information indicating how critical different time portions of an audio content are, or an information indicating whether a time portion is critical).

According to embodiments of the invention (e.g. according to the fourth aspect), the quality control information comprises an information, e.g. a dedicated information; e.g. a dedicated flag or a dedicated quantitative value, indicating for which passages of the audio content a decoder-sided improvement of a speech intelligibility of a speech portion of the audio content is considered recommendable under hindered listening conditions, e.g. in a noisy listening environment, or, for example, in the presence of an unstable hearing environment, or for example, in the presence of a hearing impairment of the listener, or for example, in the case of fatigue of a listener.

Hence, a decision for a subsequent audio content adaptation may be facilitated. In particular, user-specific adaptations may be enabled by providing such an information. In particular, average end-users (e.g. without specific knowledge in the field of audio processing) may be empowered to perform a solid decision regarding whether or not to perform respective modifications.

According to embodiments of the invention (e.g. according to the fourth aspect), the quality control information comprises an information, e.g. a dedicated information; e.g. a dedicated flag or a single dedicated quantitative value, indicating whether a portion of the audio content comprises a speech intelligibility measure, e.g. a single numeric value describing a speech intelligibility of the speech portion, or a speech intelligibility related characteristic (e.g. a short-term intensity difference between a speech portion of the audio content and a background portion of the audio content, or a level of a speech portion of the audio content) which is in a predetermined relationship with one or more threshold values (e.g. a single threshold value or a plurality of threshold values, e.g. associated with different frequencies, e.g. larger than, or equal to, or smaller than the one or more threshold values.

Hence, metadata may be provided which comprises a differentiated information on a quality of the audio content with regard to speech intelligibility.

According to embodiments of the invention (e.g. according to the fourth aspect), the quality control information comprises an information (e.g. a dedicated information; e.g. a dedicated flag or a single dedicated quantitative value) quantitatively describing a speech intelligibility related characteristic of a portion of the audio content (e.g. a short-term intensity difference between a speech portion of the audio content and a background portion of the audio content, or a level of a speech portion of the audio content).

Having a numeric metric allows quantifying a severity of intelligibility problems and hence and “intensity” of needed modifications. Furthermore, this may allow categorizing an audio scene for specific audiences (e.g. people with hearing impairment).

According to embodiments of the invention (e.g. according to the fourth aspect), the quality control information comprises an information, e.g. a dedicated information; e.g. a dedicated flag or a single dedicated quantitative value, indicating whether an audio scene is considered to be hard to understand or easy to understand.

According to embodiments of the invention (e.g. according to the fourth aspect), the quality control information comprises an information (e.g. a dedicated information; e.g. a dedicated flag or a single dedicated quantitative value) indicating whether an audio scene is considered to be understandable with low listening effort, or to be understandable with medium listening effort, or to be understandable with high listening effort.

According to embodiments of the invention (e.g. according to the fourth aspect), the quality control information comprises an information indicating passages in the audio content in which a short-term intensity difference between a speech portion of the audio content and a background portion of the audio content is smaller than a threshold value or equal to a threshold value. Alternatively or in addition, the quality control information comprises an information indicating passages in the audio content in which a short-term intensity of a speech portion of the audio content is smaller than a threshold value or equal to a threshold value.

It was recognized that based on the inventive analysis approach audio content may be categorized or classified with regard to a quality (e.g. easily understandable or not), selectively for certain temporal sections, spatial sections as well as certain frequency intervals of the audio scene or audio content. Hence, a differentiated manipulation of the audio content may be performed based on such a knowledge.

According to embodiments of the invention (e.g. according to the fourth aspect), the quality control information describes a short-term intensity difference (e.g. with a temporal resolution of no more than 3000 ms, e.g., short-term loudness, e.g. according to EBU TECH 3341, or with a temporal resolution of no more than 1000 ms, or with a temporal resolution of no more than 400 ms, e.g. for momentary loudness, e.g. according to EBU TECH 3341, or with a temporal resolution of no more than 100 ms, or with a temporal resolution of no more than 40 ms, of with a temporal resolution of no more than 20 ms; or with a temporal resolution between 3000 ms and 400 ms) between a speech portion of the audio content and a background portion of the audio content. Alternatively or in addition, the quality control information describes a short-term intensity of the speech portion of the audio content.

According to embodiments of the invention (e.g. according to the fourth aspect), the bitstream provider is configured to add the quality control information, e.g. quality control metadata, to pre-existing metadata, e.g. such metadata provided from a production session, e.g. metadata already present in the encoded representation of the audio content.

Hence, a seamless integration to existing frameworks may be provided.

According to embodiments of the invention (e.g. according to the fourth aspect), the bitstream provider is configured to adapt processing parameters for a decoding of the audio content, e.g. filter coefficients, gain values, etc., in dependence on a short-term intensity difference (e.g. a single short-term intensity difference value describing the short-term intensity difference, or a set of short-term intensity difference values describing the short-term intensity difference for a plurality of different frequencies or frequency ranges) between a speech portion of the audio content and a background portion of the audio content and/or in dependence on a short-term intensity of the speech portion, e.g. in order to implicitly signal critical time portions; e.g. in order to implicitly trigger a decoder-sided improvement of a speech intelligibility.

According to embodiments of the invention (e.g. according to the fourth aspect), the bitstream provider is configured to include the quality control information into an extension payload of a bitstream stream, e.g. into a payload which can be enabled and disabled, e.g. using a flag or list entry indicating the presence (or absence) of the payload; e.g. into a payload which is defined as being optional; e.g. an MHAS packet in case of the MPEG-H 3D Audio codec and/or bitstream extension elements, e.g. usacExtElement in case of the MPEG-H 3D Audio codec and/or USAC resp. xHE-AAC audio codec; e.g. in compliance with XHE-AAC and/or MPEG-H 3D audio.

These approaches may hence allow implementing an inventive scene enhancement with limited impact on an already existing framework. Furthermore, additional computational as well as bandwidth costs may be kept to a minimum.

According to embodiments of the invention (e.g. according to the fourth aspect), the bitstream provider comprises an audio analyzer according to one of the previously discussed embodiments, e.g. according to the first and/or second aspect, wherein the bitstream provider is configured to determine the quality control information in dependence on the analysis result, and/or the bitstream provider comprises an audio processor according one of the above-discussed embodiments, e.g. according to the third aspect.

According to embodiments of the invention (e.g. according to the fourth aspect), the bitstream provider is configured to format the quality control information into quality control metadata packets, e.g. aligned to an audio frame rate.

According to embodiments of the invention (e.g. according to the fourth aspect), the bitstream provider is configured to encapsulate quality control metadata, e.g. the quality control metadata packets, in data packets, and to insert the data packets into an audio bitstream when performing an encoding.

Again, said approaches may hence allow implementing an inventive scene enhancement with limited impact on an already existing framework. Furthermore, additional computational as well as bandwidth costs may be kept to a minimum.

According to embodiments of the invention (e.g. according to the fourth aspect), the bitstream provider is implemented using a neural network, wherein the neural network is configured to receive a representation of an audio content (e.g. a “final mix” or a plurality of audio signals representing different portions of an audio content, e.g. one audio signal representing a speech portion of the audio content and one audio signal representing a background portion of the audio content) and to provide, on the basis thereof, the quality control information. Furthermore, the neural network is trained using training audio scenes (i.e. audio content) which are labeled, e.g. classified, with respect to a speech intelligibility (e.g. hard to understand/easy to understand; e.g. understandable with low listening effort/understandable with medium listening effort/understandable with high listening effort) wherein parameters of the neural network are, for example, adjusted in such a manner that an output of the neural network which is provided in response to the training audio scenes approximates the respective labels that are associated with the respective training audio scenes.

According to embodiments of the invention (e.g. according to the fourth aspect), the bitstream provider is implemented using a neural network, wherein the neural network is configured to receive a representation of an audio content (e.g. a “final mix” or a plurality of audio signals representing different portions of an audio content, e.g. one audio signal representing a speech portion of the audio content and one audio signal representing a background portion of the audio content) and to provide, on the basis thereof, the quality control information, wherein the neural network is trained using an audio analyzer according to one of the above embodiments, e.g. according the first aspect, and wherein the audio analyzer is configured to provide a reference quality control information for the training of the neural network on the basis of a plurality of audio scenes, i.e. audio content.

According to embodiments of the invention (e.g. according to the fourth aspect), the quality control information comprises clarity information metadata, or accessibility enhancement metadata, or speech transparency metadata, or speech enhancement metadata, or understandability metadata, or content description metadata (which may, for example, be intelligibility-related; wherein the content description metadata may, for example, be a low-level and audio oriented;), or local enhancement metadata, or signal descriptive metadata.

It was recognized that based on the inventive analysis of the audio content the above-discussed metadata elements may be provided, hence allowing an in depth analysis and hence improvement of the audio content.

According to embodiments of the invention (e.g. according to the fourth aspect), the bitstream provider is configured to include the quality control information (e.g. the audio quality control metadata qcInfo( )) and information about the audio quality control metadata, e.g. information qcInfoCount how many data structures qcInfo( )) carrying audio quality control metadata are present in an MHAS packet, and/or information when the audio quality control metadata should be applied (e.g. qcInfoActive), and/or information in which cases the audio quality control metadata should be applied, and/or information in which cases a respective decoder may choose to apply the audio quality control metadata, and/or information (qcInfoType) indicating whether the audio quality control metadata (e.g. qcInfo( )) is associated with a specific (e.g. single) audio element or with an audio scene defined by a combination of audio elements) into an MHAS packet (e.g. into an MPEG-H 3D audio stream packet, e.g. into a dedicated MHAS packet, which may, for example, solely comprise quality control information).

Hence a seamless integration in existing frameworks may be achieved.

According to embodiments of the invention (e.g. according to the fourth aspect), the bitstream provider is configured to provide audio quality control metadata (e.g. qcInfo( )) and an information about the audio quality control metadata (wherein the audio quality control metadata may, for example, quantitatively describe a speech intelligibility related characteristic of a portion of the audio content, and/or wherein the audio quality control metadata may, for example, comprise information as defined in one of the previously discussed embodiments, e.g. according to the fourth aspect). Furthermore, the information about the audio quality control metadata describes how many data structures qcInfo( )) carrying audio quality control metadata are present in an MHAS packet, and/or the information about the audio quality control metadata describes, or gives an indication, when the audio quality control metadata should be applied (e.g. qcInfoActive), and/or the information about the audio quality control metadata describes, or gives an indication (e.g. provides information about a criterion which can be used in a decoder-sided decision), in which cases the audio quality control metadata should be applied, and/or the information about the audio quality control metadata describes, or gives an indication (e.g. provides information about a criterion which can be used in a decoder-sided decision), in which cases a respective decoder or respective renderer may choose to apply the audio quality control metadata, and/or the information about the audio quality control metadata, e.g. qcInfoType, indicates whether the audio quality control metadata, e.g. qcInfo( )) is associated with a specific, e.g. single, audio element or with an audio scene defined by a combination of audio elements; and/or the information about the audio quality control metadata, e.g. qcInfoType, indicates a type of audio content (e.g. a single audio element or e.g. an agglomeration of audio elements or e.g. a plurality of audio elements) the audio quality control metadata is associated with; and/or the information about the audio quality control metadata, e.g. qcInfoType, indicates to which type of audio content the audio quality control metadata may be applied to, in order to manipulate the an audio element with the respective type; and/or the information about the audio quality control metadata comprises an identifier, e.g. mae_groupID, e.g. mae_groupPresetID, indicating to which audio element or group, e.g. combination, of audio elements a respective audio quality control metadata is associated.

The above implementation allows for a particularly efficient audio content enhancement.

According to embodiments of the invention (e.g. according to the fourth aspect), the bitstream provider is configured to provide, e.g. within a MHAS packet, audio quality control information with a first granularity (e.g. with a first temporal granularity, or with an individual association with specific audio elements) and audio quality control information with a second granularity, e.g. with a first temporal granularity; e.g. without an association with specific audio elements. Hence, a provision of quality control information may be adapted to application specific constrains, e.g. such as a currently available bandwidth for an audio stream.

According to embodiments of the invention (e.g. according to the fourth aspect), the bitstream provider is configured to provide, e.g. within a MHAS packet, a plurality, e.g. a listing, of different audio quality control metadata, e.g. different qcInfo( )) data structures, associated with different audio elements and/or different combinations of audio elements, and optionally also extension audio quality control metadata, which may, for example, be common for all audio elements and combinations of audio elements.

Hence, differentiated metadata information may be provided for selectively improving a respective aspect of the audio scene.

Embodiments according to the invention (e.g. according to a fifth aspect) comprise an audio decoder for providing a decoded audio representation, e.g. one or more decoded audio signals, on the basis of an encoded media representation (e.g. on the basis of an encoded audio representation; e.g. on the basis of an audio bitstream comprising the quality control information; e.g. on the basis a transport stream comprising an audio bitstream and a quality control information, and possibly additional media information like a video bitstream; e.g. on the basis of a bitstream comprising encoded data including one or more audio signals that contain at least two different audio types (e.g. different portions of the audio content) which can be characterized e.g., as dialog and/or commentator and/or background and/or music and/or effects; wherein, for example, the at least two different audio types may be contained in at least two different audio signals, e.g. stereo channel signal with music and effects and a mono dialog audio object; or wherein, for example, the at least two different audio types may be contained in the same one or more audio signals, e.g., a stereo complete main containing a mix of the music and effects with the dialog.

Furthermore, the audio decoder is configured to obtain, e.g. extract, a quality control information, e.g. quality control metadata, from the encoded media representation, e.g. using a bitstream parser, wherein the quality control information may, for example, be extracted from an audio bitstream or from a transport stream comprising the quality control information and the audio bitstream as separate information.

Furthermore, the audio decoder is configured to provide the decoded audio representation in dependence on the quality control information.

Hence, a decoder provider according to embodiments of the invention may comprise a functionality as discussed in the context of audio analyzers according to the first and/or second aspect, e.g. with regard to processing the audio content, in order to determine short-term intensity measures and/or may comprise a functionality as discussed in the context of audio processors according to the third aspect of the invention. Hence, embodiments according to the fifth aspect may comprise any or all of the functionalities, details and/or features as discussed in the context of audio analyzer according to the first and/or second aspect and/or in the context of audio processors according to the third aspect of the invention, both individually or taken in combination.

Furthermore, an audio decoder according to embodiments may form a counterpart to an inventive bitstream provider and may hence comprise corresponding (decoder sided) features functionalities and details, as disclosed in the context of bitstream providers according to the fourth aspect. Furthermore, an inventive audio decoder may additionally be configured to perform a rendering of the audio scene, and may hence comprise any or all of the previously discussed rendering functionalities.

According to embodiments of the invention (e.g. according to the fifth aspect), the encoded media representation comprises a representation of an audio content comprising a speech portion and a background portion and the audio decoder is configured to receive a quality control information comprising at least one of: an information for modifying a relationship between an intensity of the speech portion of the audio content and the background portion of the audio content; an information for modifying, e.g. enhancing (e.g. by modifying its intensity and/or by applying a frequency-dependent filtering) a speech portion, e.g. speech, of the audio content (e.g. so that based on the quality control information the speech portion can be modified (e.g. enhanced; e.g. so that speech is enhanced (e.g., so that its absolute level is boosted, e.g. so that it is compressed, e.g. by applying a frequency-dependent filter); for example regardless of the relationship with the background); for example in case there are portions where speech is low in absolute terms and not relatively to the background; which may, for example be addressed by a decoder; which may, for example, be important for speech-only passages (e.g. no or only little background at all), for example but also for cases in which it might be considered a better idea to apply compression or equalization to the full mix instead of a rebalancing); an information for improving a speech intelligibility of a speech portion of the audio content; an information for selectively enabling and disabling an improvement of a speech intelligibility of the speech portion of the audio content; an information indicating for which passages of the audio content an improvement of a speech intelligibility of the speech portion of the audio content is allowable; an information indicating critical time portions of the audio content; an information indicating for which passages of the audio content an improvement of a speech intelligibility of the speech portion of the audio content is considered recommendable under hindered listening conditions; an information indicating whether a portion of the audio content comprises a speech intelligibility measure or a speech intelligibility related characteristic which is in a predetermined relationship with one or more threshold values; an information indicating whether an audio scene is considered to be hard to understand or easy to understand, an information indicating whether an audio scene is considered to be understandable with low listening effort, or to be understandable with medium listening effort, or to be understandable with high listening effort; an information indicating passages in the audio content in which a short-term intensity difference between the speech portion of the audio content and the background portion of the audio content is smaller than a threshold value or equal to a threshold value; and/or an information indicating passages in the audio content in which a short-term intensity of the speech portion of the audio content is smaller than a threshold value or equal to a threshold value. Furthermore, the decoder is configured to provide the decoded audio information in dependence thereof (e.g. one or more of the above-discussed information).

Embodiments according to the invention allow providing differentiated information, on the one hand, about an existence and classification of problematic portions or sections of the audio content and on the other hand, in addition, optionally, information or instructions on how to mitigate or overcome such problems, e.g. with regard to intelligibility. Hence, embodiments allow for a good flexibility, since decisions regarding whether audio content is to be altered or modified may be made based on a selection (e.g. one or more) of differing evaluation information, as well as on user specific constraints (such as hearing impairment). Furthermore, based on added information for modifying and/or improving the content, a decoder sided computational effort can be kept limited, despite the availability of the choice, whether or not to change the audio content.

According to embodiments of the invention (e.g. according to the fifth aspect), the audio decoder is configured to perform a speech enhancement (e.g. an increase of an intensity difference between a speech portion of the audio content and a background portion of the audio content; e.g. an increase of at least a section or passage of an intensity of a speech portion) in dependence on the quality control information.

According to embodiments of the invention (e.g. according to the fifth aspect), the audio decoder is configured to selectively perform the speech enhancement for passages of the audio content indicated by the quality control information. Hence, additional computational costs may be kept low.

According to embodiments of the invention (e.g. according to the fifth aspect), the audio decoder is configured to selectively perform the speech enhancement for passages of the audio content for which the quality control information indicates a difficult intelligibility, e.g. of the speech portion with regard to a background portion.

According to embodiments of the invention (e.g. according to the fifth aspect), the audio decoder is configured to receive a control information, e.g. a user input, defining whether a speech enhancement should be performed, and the audio decoder is configured to, e.g. selectively, activate and deactivate the speech enhancement in dependence on the control information defining whether a speech enhancement should be performed and optionally also in dependence on the quality control information.

Embodiments may allow global, regarding the audio content, or local improvements of audio characteristics. Depending on the audio content, changes (e.g. modifications, e.g. improvements) may be performed in a very targeted manner, hence, for example, not changing audio portions already achieving an intended effect for the listener (e.g. in a quiet scene, where the background is of greater importance), but only such portions being problematic (e.g. a dialog between two people, obfuscated by background noise).

In particular, it was recognized that the inventive manipulation of audio content is particularly efficient for addressing intelligibility problems.

According to embodiments of the invention (e.g. according to the fifth aspect), the audio decoder is configured to receive a control information, e.g. a user input, defining an interaction with an audio scene (e.g. an adjustment of a level of a portion of the audio content (e.g. a level of an audio object) or an adjustment of a position of an audio object; wherein the audio content may, for example, comprise at least a portion of an description of the audio scene) and the audio decoder is configured to, e.g. selectively, activate and deactivate the speech enhancement in dependence on the control information defining an interaction with the audio scene (and optionally also in dependence on the quality control information). Alternatively or in addition, the audio decoder is configured to adjust one or more parameters of the speech enhancement in dependence on the control information defining an interaction with the audio scene and optionally also in dependence on the quality control information.

Hence, embodiments allow addressing interactive AR- and/or VR scenarios (augmented reality/virtual reality), wherein it may not be predetermined how the audio scene develops. As an example, upon introduction of an additional background noise, an intelligibility improvement according to embodiments may be triggered for improving a dialog portion of the audio scene. Because of the manipulation of optionally only low level characteristics, computational effort can be kept low, so as to allow meeting even challenging time constraints for the rendering, e.g. for real-time rendering.

According to embodiments of the invention (e.g. according to the fifth aspect), the audio decoder is configured to adjust one or more parameters of a speech enhancement (e.g. a degree by which an intensity relationship (e.g. an intensity ratio) between a speech portion of an audio content and a background portion of the audio content is adapted, for example increased (or for example decreased), by the speech enhancement) in dependence on the quality control information.

Hence, embodiments allow to fine-adjust a level of speech enhancement, e.g. in dependence on a severity of an acoustic problem, such as intelligibility issues.

According to embodiments of the invention (e.g. according to the fifth aspect), the audio decoder is configured to obtain, e.g. receive, an information about a listening environment (e.g. an information about an intensity of a noise in a listening environment; e.g. an information about a background noise in a listening environment; e.g. information about a type of listening environment (e.g. public place, living room, car, etc.); e.g. information about a position (e.g. an absolute position) of one or more listeners; e.g. an information about a position of one or more listeners in a listening environment; e.g. an information about circumstances in a listening environment affecting a listener's concentration; e.g. an information about illumination conditions in a listening environment; e.g. an information about movement in a listening environment; e.g. an information about visual stimulus in a listening environment; e.g. information about a time, e.g. a dynamic, time-variant information about a listening environment). Furthermore, the audio decoder is configured to decide (e.g. with a temporal resolution of no more than 3000 ms, e.g., for short-term loudness, e.g. according to EBU TECH 3341, or with a temporal resolution of no more than 1000 ms, or with a temporal resolution of no more than 400 ms, e.g. for momentary loudness, e.g. according to EBU TECH 3341, or with a temporal resolution of no more than 100 ms, or with a temporal resolution of no more than 40 ms, of with a temporal resolution of no more than 20 ms, or with a temporal resolution between 3000 ms and 400 ms, or with a temporal resolution of one audio frame, or with a temporal resolution of two audio frames, or with a temporal resolution of no more than 10 audio frames) whether to perform a speech enhancement or not in dependence on the information about the listening environment and in dependence on the quality control information (such that, for example, a speech enhancement is selectively performed for passages of the audio content for which the quality control information indicates an insufficient short-term intensity difference between a speech portion of the audio content and a background portion of the audio content (e.g. smaller than a threshold value which may, for example, be determined by the audio decoder in dependence on the information about the listening environment), or such that, for example, a speech enhancement is selectively performed for passages of the audio content for which the quality control information indicates a critical passage (e.g. a passage with a comparatively low short-term level difference between a speech portion of the audio content and a background portion of the audio content) if the audio decoder determines, on the basis of the information about the listening environment, that a speech enhancement should be performed for critical passages).

According to embodiments of the invention (e.g. according to the fifth aspect), the audio decoder is configured to obtain, e.g. receive, an information about a listening environment (e.g. an information about an intensity of a noise in a listening environment; e.g. an information about a background noise in a listening environment; e.g. an information about a position of one or more listeners in a listening environment; e.g. an information about circumstances in a listening environment affecting a listener's concentration; e.g. an information about illumination conditions in a listening environment; e.g. an information about movement in a listening environment; e.g. an information about visual stimulus in a listening environment). Furthermore, the audio decoder is configured to adjust one or more parameters of a speech enhancement (e.g. a degree by which an intensity relationship (e.g. an intensity ratio) between a speech portion of an audio content and a background portion of the audio content is increased by the speech enhancement) in dependence on the quality control information and in dependence on the information about the listening environment.

Hence, embodiments allow not only user-specific adaptations but as well user-surrounding specific adaptations, hence allowing to optimize a hearing experience in a very individual manner for a user.

According to embodiments of the invention (e.g. according to the fifth aspect), the audio decoder is configured to obtain, e.g. receive, a user input (e.g. an information about a user's speech intelligibility requirement, or an information about a user's concentration or cognitive load or concentrativeness (e.g. power of concentration), or an information about a user's hearing impairment, or an information from a hearing aid, or an information from one or more other devices or sensors). Furthermore, the audio decoder is configured to decide (e.g. with a temporal resolution of no more than 3000 ms [e.g., short-term loudness, e.g. according to EBU TECH 3341), or with a temporal resolution of no more than 1000 ms, or with a temporal resolution of no more than 400 ms (e.g. for momentary loudness, e.g. according to EBU TECH 3341), or with a temporal resolution of no more than 100 ms, or with a temporal resolution of no more than 40 ms, of with a temporal resolution of no more than 20 ms, or with a temporal resolution between 3000 ms and 400 ms, or with a temporal resolution of one audio frame, or with a temporal resolution of two audio frames, or with a temporal resolution of no more than 10 audio frames) whether to perform a speech enhancement or not in dependence on the user input and in dependence on the quality control information (such that, for example, a speech enhancement is selectively performed for passages of the audio content for which the quality control information indicates an insufficient short-term intensity difference between a speech portion of the audio content and a background portion of the audio content (e.g. smaller than a threshold value which may be defined by the user input), or such that, for example, a speech enhancement is selectively performed for passages of the audio content for which the quality control information indicates a critical passage).

An adjustment of low level characteristics for audio enhancement according to the invention allows keeping a computational effort low, hence enabling additional user inputs, without significantly increasing hardware requirements.

According to embodiments of the invention (e.g. according to the fifth aspect), the audio decoder is configured to obtain, e.g. receive, a system level information (e.g. an information about a system setting; e.g. an information about a dialog enhancement option; e.g. an information about setting for hearing impairment; e.g. an information about a setting for visual impairment). Furthermore, the audio decoder is configured to decide (e.g. with a temporal resolution of no more than 3000 ms, e.g., short-term loudness, e.g. according to EBU TECH 3341), or with a temporal resolution of no more than 1000 ms, or with a temporal resolution of no more than 400 ms (e.g. for momentary loudness, e.g. according to EBU TECH 3341), or with a temporal resolution of no more than 100 ms, or with a temporal resolution of no more than 40 ms, of with a temporal resolution of no more than 20 ms, or with a temporal resolution between 3000 ms and 400 ms, or with a temporal resolution of one audio frame, or with a temporal resolution of two audio frames, or with a temporal resolution of no more than 10 audio frames) whether to perform a speech enhancement or not in dependence on the user input and in dependence on the quality control information (such that, for example, a speech enhancement is selectively performed for passages of the audio content for which the quality control information indicates an insufficient short-term intensity difference between a speech portion of the audio content and a background portion of the audio content (e.g. smaller than a threshold value which may be defined by the user input), or such that, for example, a speech enhancement is selectively performed for passages of the audio content for which the quality control information indicates a critical passage.

This may allow simplifying handling of the highly flexible adjustment options, for example for an end user, provided by embodiments.

According to embodiments of the invention (e.g. according to the fifth aspect), the audio decoder is configured to obtain, e.g. receive, an information about one or more sound reproduction devices, e.g. sound transducers, (e.g. an information indicating whether internal sound transducers (e.g. speakers) of an apparatus or external sound transducers (e.g. speakers or headphones) are used for a reproduction of the audio content; e.g. an information about positions of one or more sound transducers used for a reproduction of the audio content). Furthermore, the audio decoder is configured to adjust one or more parameters of a speech enhancement (e.g. a degree by which an intensity relationship (e.g. an intensity ratio) between a speech portion of an audio content and a background portion of the audio content is increased by the speech enhancement) in dependence on the quality control information and in dependence on the information about the one or more sound reproduction devices.

Again, efficiency of audio analysis and audio content modification, e.g. based on intensity measures, allows incorporating optimization of the audio rendering with regard to characteristics of respective sound systems of the consumers.

According to embodiments of the invention (e.g. according to the fifth aspect), the audio decoder is configured to obtain one or more out of the following system level information: an information about a system setting, e.g. a preferred language setting, a dialog enhancement option setting, a hearing impairment setting, a visual impairment setting; an information about a user setting, e.g. an object level adjustment setting; e.g. an object position adjustment setting;

an information about an environment, e.g. from a sensor acoustically monitoring the environment, or from a sensor optically monitoring the environment, or from a position sensor;

and/or an information about one or more additional devices, e.g. about one or more sound transducers. Furthermore, the audio decoder is configured to perform one or more of the following functionalities in dependence on the quality control information and the system level information: decide of (e.g. decide if) a critical passage is present in the audio content, e.g. in any of the audio signals, and needs improvement (wherein, for example, the quality control information may indicate a degree of criticality of the audio content, and wherein the system level information may be used to decide whether a quality improvement (e.g. a speech enhancement) is needed for the indicated degree of criticality); decide on the level and/or intensity of the quality improvement to be applied (wherein, for example, the quality control information may describe a quality level of the audio content in the absence of a quality improvement, and wherein, for example, the system level information may describe a desired or needed quality level); derive a quality control information needed by an audio decoder to enhance an audio quality of one or more critical passages for improving an intelligibility and/or reducing a listening effort.

According to embodiments of the invention (e.g. according to the fifth aspect), the quality control information (e.g. the derived quality control information, which is obtained in dependence on the quality control information obtained from the encoded media representation) comprises one or more of: one or more gain sequences which need to be, e.g. which should be or which are to be, applied to one or more audio signals part of an audio scene or to one or more portions of an audio content; information about which signals or which portions of an audio content should be, e.g. or can be, processed in order to improve one or more critical passages; and/or information about a duration of the one or more critical passages.

According to embodiments of the invention (e.g. according to the fifth aspect), the audio decoder is configured to apply the quality control information (e.g. the derived quality control information, which is obtained in dependence on the quality control information obtained from the encoded media representation) in order to obtain a quality-enhanced version of the audio content.

According to embodiments of the invention (e.g. according to the fifth aspect), the audio decoder is configured to apply the quality control information (e.g. the derived quality control information, which is obtained in dependence on the quality control information obtained from the encoded media representation) to the audio content (e.g. to different portions of the audio content, or to one or more audio signals representing the audio content) in order to obtain a quality-enhanced, e.g. with regard to an intelligibility, version of the audio content.

According to embodiments of the invention (e.g. according to the fifth aspect), the audio decoder is configured to perform a filtering in order to obtain a quality-enhanced version of the audio content and the audio decoder is configured to determine one or more filter coefficients of the filtering in dependence on the quality control information, e.g. in dependence on the quality control information obtained from the encoded media representation.

According to embodiments of the invention (e.g. according to the fifth aspect), the audio decoder is configured to perform a filtering in order to obtain a quality-enhanced version of the audio content and the audio decoder is configured to determine one or more filter coefficients of the filtering in dependence on the quality control information, e.g. in dependence on the quality control information obtained from the encoded media representation.

It was recognized that quality control information as defined by embodiments may allow determining filter coefficients efficiently, in order to improve the audio content. Furthermore, existing filtering architectures can be reused whilst implementing the inventive audio enhancement.

According to embodiments of the invention (e.g. according to the fifth aspect), the audio decoder is configured to determine one or more filter coefficients of the filtering in dependence on a system level information (e.g. an information about a system setting; e.g. an information about a dialog enhancement option; e.g. an information about setting for hearing impairment; e.g. an information about a setting for visual impairment), and/or in dependence on an information about one or more sound reproduction devices, e.g. sound transducers (e.g. an information indicating whether internal sound transducers (e.g. speakers) of an apparatus or external sound transducers (e.g. speakers or headphones) are used for a reproduction of the audio content; e.g. an information about positions of one or more sound transducers used for a reproduction of the audio content), and/or in dependence on an information about a listening environment (e.g. an information about an intensity of a noise in a listening environment; e.g. an information about a background noise in a listening environment; e.g. information about a type of listening environment (e.g. public place, living room, car, etc.); e.g. information about a position (e.g. an absolute position) of one or more listeners; e.g. an information about a position of one or more listeners in a listening environment; e.g. an information about circumstances in a listening environment affecting a listener's concentration; e.g. an information about illumination conditions in a listening environment; e.g. an information about movement in a listening environment; e.g. an information about visual stimulus in a listening environment; e.g. information about a time, e.g. a dynamic, time-variant information about a listening environment), and/or in dependence on an information about a user input (e.g. an information about a user's speech intelligibility requirement, or an information about a user's concentration or cognitive load or concentrativeness, or an information about a user's hearing impairment).

Hence, embodiments allow incorporating a plurality of individual factors in order to provide a, for example best possible, hearing experience.

According to embodiments of the invention (e.g. according to the fifth aspect), the audio decoder is configured to apply the filtering to one or more output signals of a decoder core, or wherein the audio decoder is configured to apply the filtering to one or more rendered audio signals which are obtained using a rendering of output signals of a decoder core, e.g. to a final rendered output.

According to embodiments of the invention (e.g. according to the fifth aspect), the audio decoder is configured to trigger a time-frequency modification, e.g. a modification of the audio content in a frequency-dependent and time-variant manner, in dependence on the quality control information, and optionally also in dependence on a user input and/or an information about a listening environment.

It was recognized that based on the inventive quality control information an enhancement may be performed particularly efficiently in the time-frequency domain.

According to embodiments of the invention (e.g. according to the fifth aspect), the audio decoder is configured to detect one or more critical passages present in at least one audio signal contained in the encoded media representation (e.g. to detect one or more critical passages present in at least one audio signal contained in the encoded media representation which need an improvement under (e.g. in view of) one or more current system settings, wherein the current system settings may, for example, include information about one or more user selections and/or information about an environment; wherein, for example, a passage is considered critical if the reproduction of the at least two different audio types, e.g. dialog (speech) and background, leads to an increased listening effort for the user; wherein, for example, the audio decoder may be configured to recognize a critical passage on the basis of the quality control information).

According to embodiments of the invention (e.g. according to the fifth aspect), the audio decoder is configured to decode encoded audio data and to process one or more detected critical passages, e.g. of one or more audio signals obtained by the decoding of the encoded audio data.

According to embodiments of the invention (e.g. according to the fifth aspect), the audio decoder is configured to process the one or more detected critical passages to, optionally thereby, improve an audio quality of an audio scene and/or to, optionally thereby, reduce a listening effort for the user.

According to embodiments of the invention (e.g. according to the fifth aspect), the quality control information comprises metadata associated with the audio scene containing information about critical passages present in at least on audio signal contained in the audio stream. Furthermore, the audio decoder is configured to process the information about critical passages present in at least one audio signal contained in the encoded media representation, e.g. in the audio stream, and at least one additional information coming from a system level or from other metadata in the encoded media representation, e.g. audio stream, to decide if critical passages present in at least one audio signal contained in the encoded media representation, e.g. in the encoded audio stream, can be improved. In addition, the audio decoder is configured to decode an encoded audio stream included in the encoded media representation or making up the encoded media representation, and at the decision that critical passages present in at least on audio signal contained in the audio stream can be improved, use the information about critical passages present in at least on audio signal to improve the audio quality of the complete audio scene.

Hence, an inventive decoder may decide automatically, whether or not a signal improvement is needed or advisable. Therefore, a computational effort for unnecessary signal manipulation can be prevented. Furthermore, an increase in autonomy on the decoder-side reduces a complexity for the end user.

According to embodiments of the invention (e.g. according to the fifth aspect), the information about critical passages, which may, for example, be included in the encoded media representation, contains at least one parameter associated with the short-term intensity of an audio signal, or an audio signal portion, e.g. a speech portion of an audio content, in the audio scene or associated with the short-term intensity differences between two or more audio types contained in the audio scene, e.g. between a speech portion of an audio content of the audio scene and a background portion of an audio content of the audio scene.

According to embodiments of the invention (e.g. according to the fifth aspect), the information about critical passages, which may, for example, be included in the encoded media representation, contains at least one of the following parameters: information about which audio signals contain critical passages; information about which audio signals need to be processed in order to improve the critical passages, which might not be present all audio signals; one or more gain sequences (e.g. comprising a temporal resolution of no more than 3000 ms [e.g., short-term loudness, e.g. according to EBU TECH 3341), or with a temporal resolution of no more than 1000 ms, or with a temporal resolution of no more than 400 ms (e.g. for momentary loudness, e.g. according to EBU TECH 3341), or of no more than 100 ms, or of no more than 40 ms, or of no more than 20 ms, or with a temporal resolution between 3000 ms and 400 ms, or of one audio frame, or of two audio frames, or of no more than ten audio frames] which need to be applied to one or more audio signals (e.g. in order to improve a speech intelligibility] [but which may, for example, only be applied to the one or more audio signals in case that a decoder-sided enhancement of a speech intelligibility is desired, e.g. as a result of a decoder-sided decision, which may, for example, be based on a user input, a listening environment information, or the like); information about the start, and/or end and/or duration of at least one critical passage; short-term intensity values associated with at least one audio signal; short-term intensity differences associated with at least two audio types, e.g. at least two different portions of the audio content, which can be characterized e.g., as dialog and/or commentator and/or background and/or music and effects.

It was recognized that the above approaches allow for an efficient representation or indication of critical passages.

According to embodiments of the invention (e.g. according to the fifth aspect), the audio decoder is configured to evaluate the quality control information (e.g. the audio quality control metadata qcInfo( )) and information about the audio quality control metadata, e.g. information qcInfoCount how many data structures qcInfo( )) carrying audio quality control metadata are present in an MHAS packet, and/or information when the audio quality control metadata should be applied (e.g. qcInfoActive), and/or information in which cases the audio quality control metadata should be applied, and/or information in which cases a respective decoder may choose to apply the audio quality control metadata, and/or information (qcInfoType) indicating whether the audio quality control metadata (e.g. qcInfo( )) is associated with a specific (e.g. single) audio element or with an audio scene defined by a combination of audio elements), which is included in an MHAS packet (e.g. in an MPEG-H 3D audio stream packet, e.g. in a dedicated MHAS packet, which may, for example, solely comprise quality control information.

Hence, embodiments allow for a seamless integration in existing frameworks.

According to embodiments of the invention (e.g. according to the fifth aspect), the audio decoder is configured to evaluate an audio quality control metadata (e.g. qcInfo( )) and an information about the audio quality control metadata. Optionally, the audio quality control metadata may, for example, quantitatively describe a speech intelligibility related characteristic of a portion of the audio content, and/or wherein the audio quality control metadata may, for example, comprise information as defined in one of the above-discussed embodiments, e.g. according to the fourth aspect. Furthermore, the information about the audio quality control metadata describes how many data structures qcInfo( )) carrying audio quality control metadata are present in an MHAS packet, and/or the information about the audio quality control metadata describes, or gives an indication, when the audio quality control metadata should be applied (e.g. qcInfoActive), and/or the information about the audio quality control metadata describes, or gives an indication (e.g. provides information about a criterion which can be used in a decoder-sided decision), in which cases the audio quality control metadata should be applied, and/or the information about the audio quality control metadata describes, or gives an indication (e.g. provides information about a criterion which can be used in a decoder-sided decision), in which cases a respective decoder or respective renderer may choose to apply the audio quality control metadata, and/or the information about the audio quality control metadata, e.g. qcInfoType, indicates whether the audio quality control metadata, e.g. qcInfo( )) is associated with a specific, e.g. single, audio element or with an audio scene defined by a combination of audio elements; and/or the information about the audio quality control metadata, e.g. qcInfoType, indicates a type of audio content (e.g. a single audio element or e.g. an agglomeration of audio elements or e.g. a plurality of audio elements) the audio quality control metadata is associated with; and/or the information about the audio quality control metadata, e.g. qcInfoType) indicates to which type of audio content the audio quality control metadata may be applied to, in order to manipulate the an audio element with the respective type; and/or the information about the audio quality control metadata comprises an identifier, e.g. mae_groupID, e.g. mae_groupPresetID, indicating to which audio element or group, e.g. combination, of audio elements a respective audio quality control metadata is associated.

According to embodiments of the invention (e.g. according to the fifth aspect), the audio decoder is configured to evaluate, e.g. within a MHAS packet, audio quality control information with a first granularity, e.g. with a first temporal granularity, or with an individual association with specific audio elements, and audio quality control information with a second granularity, e.g. with a first temporal granularity; e.g. without an association with specific audio elements. Hence, computational effort and/or a quality of an audio rendering may be scalable.

According to embodiments of the invention (e.g. according to the fifth aspect), the audio decoder is configured to evaluate, e.g. within a MHAS packet, a plurality, e.g. a listing, of different audio quality control metadata, e.g. different qcInfo( )) data structures, associated with different audio elements and/or different combinations of audio elements, and optionally also extension audio quality control metadata, which may, for example, be common for all audio elements and combinations of audio elements. Hence, quality control information may be provided in an audio-element specific manner, so that, for example, a respective quality control metadata is associated with a respective audio element. This may allow improving a quality of a rendering of the audio scene.

Embodiments according to the invention (e.g. according to the first aspect) comprise a method for analyzing an audio content, the method comprising: obtaining, e.g. receiving, the audio content, the audio content comprising a speech portion and a background portion (e.g. obtaining a “final mix” in which the speech portion and the background portion are combined, or obtaining separate signals representing the speech portion of the audio content and the background portion of the audio content separately); determining a short-term intensity difference (e.g. a single short-term intensity difference value describing the short-term intensity difference, or a set of short-term intensity difference values describing the short-term intensity difference for a plurality of different frequencies or frequency ranges) between a speech portion, e.g. in the sense of a “dialogue” type audio content, of the audio content, e.g. speech, and/or commentary, and/or audio description, and a background portion, e.g. music and/or effects, and/or diffuse sound, and/or stadium atmosphere, of the audio content, and/or determining a short-term intensity information of a speech portion of the audio content, and providing a representation of the short-term intensity difference (e.g. a single short-term intensity difference value per portion of the audio content, or a set of short-term intensity difference values describing the short-term intensity difference for a plurality of different frequencies or frequency ranges; e.g. a coarsely quantized representation of the short-term intensity difference, e.g. quantized down to only 2 quantization steps, or quantized down to only three quantization steps, or quantized down to only four quantization steps) and/or a representation of the short-term intensity information of the speech portion as an analysis result, e.g. as a quality control report, or deriving an analysis result, e.g. a binary or ternary or quaternary value, from the short-term intensity difference (e.g. using a comparison between the short-term intensity difference and one or more threshold values, or using a comparison between the short-term intensity difference values describing the short-term intensity difference for a plurality of different frequencies or frequency ranges and respective (e.g. frequency-dependent) associated threshold values) and/or from the short-term intensity information of the speech portion.

Embodiments according to the invention (e.g. according to the second aspect) comprise a method for analyzing an audio content, the method comprising: obtaining, e.g. receiving, the audio content comprising a speech portion and a background portion (e.g. obtaining a “final mix” in which the speech portion and the background portion are combined, or obtaining separate signals representing the speech portion of the audio content and the background portion of the audio content separately) and deriving, using a neural network, a quality control information (e.g. a representation of a short-term intensity difference; e.g. a representation of a short-term intensity of the speech portion; e.g. a single short-term intensity difference value per portion of the audio content, or a set of short-term intensity difference values describing the short-term intensity difference for a plurality of different frequencies or frequency ranges; e.g. a coarsely quantized representation of the short-term intensity difference, e.g. quantized down to only 2 quantization steps, or quantized down to only three quantization steps, or quantized down to only four quantization steps) on the basis of the audio content.

Embodiments according to the invention (e.g. according to the third aspect) comprise a method for processing an audio content, the method comprising: obtaining, e.g. receiving, the audio content wherein the audio content comprises a speech portion and a background portion;

determining a short-term intensity difference (e.g. a single short-term intensity difference value describing the short-term intensity difference, or a set of short-term intensity difference values describing the short-term intensity difference for a plurality of different frequencies or frequency ranges) between a speech portion of the audio content and a background portion of the audio content; and/or determining a short-term intensity of the speech portion, and modifying the audio content in dependence of the short-term intensity difference and/or in dependence on the short-term intensity of the speech portion (e.g. in order to (selectively) improve a speech intelligibility (e.g. for portions of the audio content having a comparatively low short-term intensity difference); e.g. by (selectively) modifying the speech portion of the audio content and/or the background portion of the audio content and/or a parameter information of the audio content (e.g. a gain value, or a processing parameter) (e.g. for portions of the audio content having a comparatively low short-term intensity difference); e.g. to thereby (selectively) increase an intensity difference between the speech portion of the modified audio content and the background portion of the modified audio content when compared to the original intensity difference (e.g. for portions of the audio content having a comparatively low short-term intensity difference)).

Embodiments according to the invention (e.g. according to the fourth aspect) comprise a method for providing a bitstream, e.g. for providing an audio bitstream or for providing transport stream, the method comprising: including an encoded representation of an audio content (e.g. an encoded representation of an audio content comprising a speech portion and a background portion) and a quality control information, e.g. quality control metadata, into a bitstream (e.g. into an audio bitstream comprising both the encoded representation of the audio content and the quality control information, or into a transport bitstream comprising an audio bitstream and the quality control information; wherein, for example, the quality control information may be embedded into descriptors for MPEG-2 Transport Stream or into file format boxes for ISOBMFF).

Embodiments according to the invention (e.g. according to the fifth aspect) comprise a method for providing a decoded audio representation, e.g. one or more decoded audio signals, on the basis of an encoded media representation (e.g. on the basis of an encoded audio representation; e.g. on the basis of an audio bitstream comprising the quality control information; e.g. on the basis a transport stream comprising an audio bitstream and a quality control information, and possibly additional media information like a video bitstream), the method comprising: obtaining, e.g. extracting, a quality control information, e.g. quality control metadata, from the encoded media representation (e.g. using a bitstream parser] [wherein the quality control information may, for example, be extracted from an audio bitstream or from a transport stream comprising the quality control information and the audio bitstream as separate information); and providing the decoded audio representation in dependence on the quality control information.

Embodiments according to the invention comprise a computer program for performing any of the above-discussed methods, e.g. according to the first, second, third, fourth and/or fifth aspect, when the computer program runs on a computer.

The methods as described above may be based on the same considerations as the respective above-described audio analyzers, audio processors, bitstream providers and audio decoders. The respective methods can, by the way, be completed with all features and functionalities, which are also described with regard to the respective audio analyzers, audio processors, bitstream providers and audio decoders, both individually and taken in combination.

Embodiments according to the invention (e.g. according to a sixth aspect) comprise a bitstream (e.g. an audio bitstream or a transport bitstream comprising an audio bitstream), the bitstream comprising: an encoded representation of an audio content (e.g. an encoded representation of an audio content comprising a speech portion and a background portion); and a quality control information (e.g. within an audio bitstream comprising both the encoded representation of the audio content and the quality control information, or within a transport bitstream comprising an audio bitstream and the quality control information).

A bitstream according to the embodiments may be a result of a bitstream provider according to fourth aspect, e.g. in particular with any of the features of an audio analyzer according the first and/or second aspect and/or with any of the features of an audio processor according to the third aspect.

Hence, a bitstream according to embodiments may comprise any feature, functionality and/or detail as disclosed in the context of the above-discussed audio analyzers and/or audio processors and in particular of the above-discussed bitstream providers.

Furthermore, a bitstream according to embodiments may be an input for a decoder according to the fifth aspect, Hence, an inventive bitstream may comprise corresponding features, functionalities and/or details as disclosed in the context of inventive decoders.

According to embodiments of the invention (e.g. according to the sixth aspect), the quality control information enables or supports a decoder-sided, e.g. selective, modification of a relationship between an intensity of a speech portion of the audio content and a background portion of the audio content. Alternatively or in addition, the quality control information enables or supports a decoder-sided modification, e.g. enhancement, of the speech portion (e.g. by modifying its intensity and/or by applying a frequency-dependent filtering, e.g. so that based on the quality control information the speech portion can be modified (e.g. enhanced); e.g. so that speech is enhanced (e.g., so that its absolute level is boosted, e.g. so that it is compressed, e.g. by applying a frequency-dependent filter); for example regardless of the relationship with the background) (for example in case there are portions where speech is low in absolute terms and not relatively to the background; which may, for example be addressed by a decoder; which may, for example, be important for speech-only passages (e.g. no or only little background at all), for example but also for cases in which it might be considered a better idea to apply compression or equalization to the full mix instead of a rebalancing).

According to embodiments of the invention (e.g. according to the sixth aspect), the quality control information enables or supports a decoder-sided, e.g. selective, improvement of a speech intelligibility of a speech portion of the audio content, e.g. in the presence of a background portion of the audio content reducing the speech intelligibility.

According to embodiments of the invention (e.g. according to the sixth aspect), the quality control information selectively, e.g. in a time-dependent manner, enables and disables a decoder-sided improvement of a speech intelligibility of a speech portion of the audio content (e.g. in the presence of a background portion of the audio content reducing the speech intelligibility; e.g. although, for example, actually the quality control information may not actively enable a decoder-side improvement, but conversely, it may, for example, indicate (e.g. selectively) where a decoder-side improvement may make sense or may be appropriate). Alternatively, the quality control information indicates for which passages of the audio content a decoder-sided improvement of a speech intelligibility of a speech portion of the audio content, e.g. in the presence of a background portion of the audio content reducing the speech intelligibility, is allowable.

According to embodiments of the invention (e.g. according to the sixth aspect), the quality control information comprises an information, e.g. a dedicated information; e.g. a dedicated flag or a dedicated quantitative value, with respect to, e.g. an information about; e.g. an information signaling; e.g. an information describing, critical time portions, e.g. passages, of the audio content (e.g. an information signaling critical time portions of the audio content and/or an information indicating how critical different time portions of an audio content are, or an information indicating whether a time portion is critical).

According to embodiments of the invention (e.g. according to the sixth aspect), the quality control information comprises an information, e.g. a dedicated information; e.g. a dedicated flag or a dedicated quantitative value, indicating for which passages of the audio content a decoder-sided improvement of a speech intelligibility of a speech portion of the audio content is considered recommendable under hindered listening conditions (e.g. in a noisy listening environment, or in the presence of an unstable hearing environment, or in the presence of a hearing impairment of the listener, or in the case of fatigue of a listener).

According to embodiments of the invention (e.g. according to the sixth aspect), the quality control information comprises an information (e.g. a dedicated information; e.g. a dedicated flag or a single dedicated quantitative value) indicating whether a portion of the audio content comprises a speech intelligibility measure, e.g. a single numeric value describing a speech intelligibility of the speech portion, or a speech intelligibility related characteristic (e.g. a short-term intensity difference between a speech portion of the audio content and a background portion of the audio content, or a level of a speech portion of the audio content) which is in a predetermined relationship with one or more threshold values, e.g. a single threshold value or a plurality of threshold values, e.g. associated with different frequencies, e.g. larger than, or equal to, or smaller than the one or more threshold values.

According to embodiments of the invention (e.g. according to the sixth aspect), the quality control information comprises an information, e.g. a dedicated information; e.g. a dedicated flag or a single dedicated quantitative value, quantitatively describing a speech intelligibility related characteristic of a portion of the audio content (e.g. a short-term intensity difference between a speech portion of the audio content and a background portion of the audio content, or a level of a speech portion of the audio content).

Embodiments according to the invention allow providing a metric for speech intelligibility, for example even with an analysis and processing of low level audio characteristics, such as intensity values.

According to embodiments of the invention (e.g. according to the sixth aspect), the quality control information comprises an information, e.g. a dedicated information; e.g. a dedicated flag or a single dedicated quantitative value, indicating whether an audio scene is considered to be hard to understand or easy to understand.

According to embodiments of the invention (e.g. according to the sixth aspect), the quality control information comprises an information, e.g. a dedicated information; e.g. a dedicated flag or a single dedicated quantitative value, indicating whether an audio scene is considered to be understandable with low listening effort, or to be understandable with medium listening effort, or to be understandable with high listening effort.

Hence, the inventive analysis allows categorizing the audio scene, making audio improvement accessible even for average end users.

According to embodiments of the invention (e.g. according to the sixth aspect), the quality control information comprises an information indicating passages in the audio content in which a short-term intensity difference between a speech portion of the audio content and a background portion of the audio content is smaller than a threshold value or equal to a threshold value; and/or the quality control information comprises an information indicating passages in the audio content in which a short-term intensity of a speech portion of the audio content is smaller than a threshold value or equal to a threshold value.

According to embodiments of the invention (e.g. according to the sixth aspect), the quality control information describes a short-term intensity difference (e.g. with a temporal resolution of no more than 3000 ms, e.g., for EBU short-term loudness, or with a temporal resolution of no more than 1000 ms, or with a temporal resolution of no more than 400 ms (e.g. for momentary loudness), or with a temporal resolution of no more than 100 ms, or with a temporal resolution of no more than 40 ms, of with a temporal resolution of no more than 20 ms; or with a temporal resolution between 3000 ms and 400 ms) between a speech portion of the audio content and a background portion of the audio content. Alternatively or in addition, the quality control information describes a short-term intensity of the speech portion of the audio content.

According to embodiments of the invention (e.g. according to the sixth aspect), the bitstream comprises an information for adapting processing parameters for a decoding of the audio content, e.g. filter coefficients, gain values, etc., based on a short-term intensity difference (e.g. a single short-term intensity difference value describing the short-term intensity difference, or a set of short-term intensity difference values describing the short-term intensity difference for a plurality of different frequencies or frequency ranges) between a speech portion of the audio content and a background portion of the audio content and/or based on a short-term intensity of the speech portion, e.g. in order to implicitly signal critical time portions; e.g. in order to implicitly trigger a decoder-sided improvement of a speech intelligibility.

According to embodiments of the invention (e.g. according to the sixth aspect), the bitstream comprises an extension payload (e.g. a payload which can be enabled and disabled, e.g. using a flag or list entry indicating the presence (or absence) of the payload; e.g. a payload which is defined as being optional e.g. an MHAS packet in case of the MPEG-H 3D Audio codec and/or bitstream extension elements, e.g. usacExtElementType in case of the MPEG-H 3D Audio codec and/or USAC resp. xHE-AAC audio codec; e.g. in compliance with XHE-AAC and/or MPEG-H; e.g. an mpegh3daConfigExtension( ) extension element or a usacConfigExtension( ) extension element, or a usacExtElement( ) extension element) and the extension payload comprises the quality control information.

This may allow a seamless integration in existing frameworks. Furthermore, the inventive approach allows integration of the information simply in a payload, hence reducing integration effort.

According to embodiments of the invention (e.g. according to the sixth aspect), the bitstream comprises quality control metadata packets to which the quality control information is formatted, e.g. aligned to an audio frame rate.

According to embodiments of the invention (e.g. according to the sixth aspect), the bitstream comprises data packets, in which the quality control metadata, e.g. the quality control metadata packets, is encapsulated.

These approaches allow simplifying a subsequent parsing of the bitstream.

According to embodiments of the invention (e.g. according to the sixth aspect), the quality control information comprises clarity information metadata, or the quality control information comprises accessibility enhancement metadata, or the quality control information comprises speech transparency metadata, or the quality control information comprises speech enhancement metadata, or the quality control information comprises understandability metadata, or the quality control information comprises content description metadata (which may, for example, be intelligibility-related; wherein the content description metadata may, for example, be a low-level and audio oriented), or the quality control information comprises local enhancement metadata, or the quality control information comprises signal descriptive metadata.

It is to be noted that in the above-discussion, embodiments were presented ordered into different aspects, however, features, functionalities and details of embodiments one aspects may be implemented in a same, similar or according manner in embodiments according to another aspects, both individually and taken in combination. The ordering into different aspects was performed in order to facilitate understanding embodiments the invention.

### BRIEF DESCRIPTION OF THE DRAWINGS

Embodiments of the present invention will be detailed subsequently referring to the appended drawings, in which:

FIG. 1 shows a schematic view of an audio analyzer according to embodiments of the invention;

FIG. 2 shows a schematic view of an audio analyzer comprising a neural network according to embodiments of the invention;

FIG. 3 shows a schematic view of an audio processor according to embodiments of the invention;

FIG. 4 shows a schematic view of a bitstream provider according to embodiments of the invention;

FIG. 5 shows a schematic view of an audio decoder according to embodiments of the invention;

FIG. 6 shows a schematic view of an audio analyzer with optional features according to embodiments of the invention;

FIG. 7 shows a schematic example visualization of short-term loudness differences (ST-LD) for quality control (QC) according to embodiments of the invention;

FIG. 8 shows a schematic view of an audio analyzer for an optional determination of a short-time intensity difference according to an embodiment;

FIG. 9 shows a schematic view of an audio analyzer with a detector according to embodiments of the invention;

FIG. 10 shows a schematic view of an audio analyzer with two detectors according to embodiments of the invention;

FIG. 11 shows a schematic view of an audio processor with optional features according to embodiments of the invention;

FIG. 12 shows a schematic view of a second audio processor with optional features according to embodiments of the invention;

FIG. 13 shows a schematic view of a third audio processor with optional features according to embodiments of the invention;

FIG. 14 shows a schematic view of a bitstream provider with optional features according to embodiments of the invention;

FIG. 15 shows a schematic view of an audio decoder with optional features according to embodiments of the invention;

FIG. 16 shows a schematic view of an audio decoder with filter according to embodiments of the invention;

FIG. 17 shows a schematic view of a bitstream provider with a multiplexer according to embodiments of the invention;

FIG. 18 shows a schematic view of an audio decoder with an optional de-multiplexer according to embodiments of the invention;

FIG. 19 shows an example for a syntax of an MHASPacketPayload( ) according to embodiments of the invention;

FIG. 20 shows an example for values of MHASPacketType according to embodiments of the invention; and

FIG. 21 shows an example for a syntax of audioQualityControlInfo( ) according to embodiments of the invention.

### DETAILED DESCRIPTION OF THE INVENTION

Equal or equivalent elements or elements with equal or equivalent functionality are denoted in the following description by equal or equivalent reference numerals even if occurring in different figures.

In the following description, a plurality of details is set forth to provide a more throughout explanation of embodiments of the present invention. However, it will be apparent to those skilled in the art that embodiments of the present invention may be practiced without these specific details. In other instances, well-known structures and devices are shown in block diagram form rather than in detail in order to avoid obscuring embodiments of the present invention. In addition, features of the different embodiments described herein after may be combined with each other, unless specifically noted otherwise.

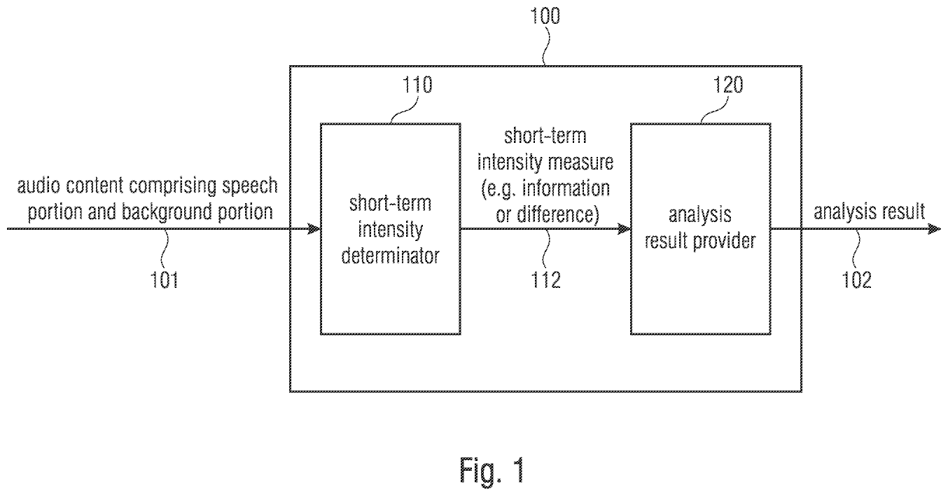

FIG. 1 shows a schematic view of an audio analyzer according to embodiments of the invention (e.g. according to the first aspect). FIG. 1 shows audio analyzer 100, comprising a short-term intensity determinator 110 and an analysis result provider 120. The audio analyzer 100 is configured to obtain an audio content 101 comprising a speech portion and a background portion and to determine, using short-term intensity determinator 110, a short-term intensity measure 112, e.g. a short-term intensity difference between a speech portion of the audio content and a background portion of the audio content and/or a short-term intensity information of a speech portion of the audio content. Furthermore, the audio analyzer 100 is configured to provide a representation of the short-term intensity difference and/or a representation of the short-term intensity information of the speech portion as an analysis result 102, or to derive an analysis 102 result from the short-term intensity difference and/or from the short-term intensity information of the speech portion, using analysis result provider 120.

Optionally, determinator 110 may comprise a filter or a filtering unit, configured to obtain the short-term intensity measure on the basis of one or more filtered portions of the audio content 101.

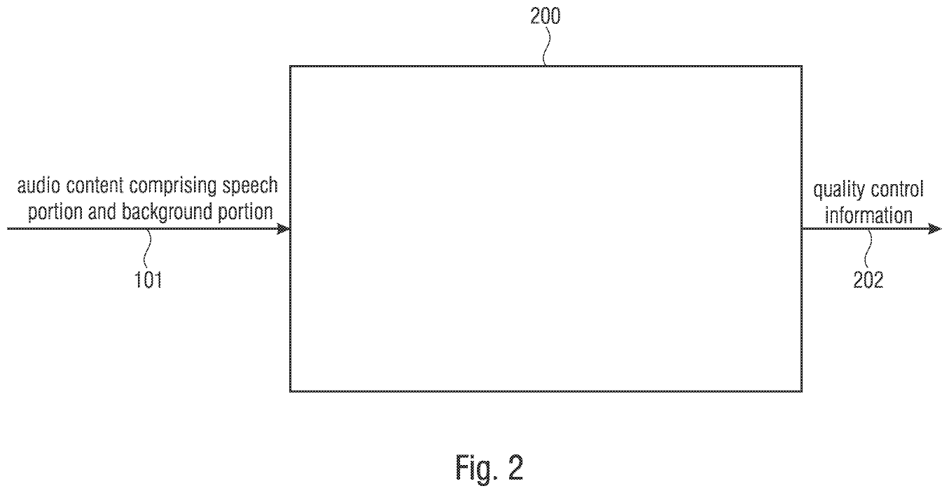

FIG. 2 shows a schematic view of an audio analyzer comprising a neural network according to embodiments of the invention (e.g. according to the second aspect). FIG. 2 shows audio analyzer 200, which is configured to obtain an audio content 101 comprising a speech portion and a background portion and which comprises a neural network configured to derive a quality control information 202 on the basis of the audio content 101. Quality control information 202 may correspond (e.g. may be similar or even identical) to analysis result 102 of FIG. 1 with the difference as being obtained based on artificial intelligence.

Here again, it is to be noted that audio analyzers in line with FIG. 2 may comprise any of the features as discussed in the context of FIG. 1.

For example, the quality control information 202 may be a representation of a short-term intensity difference and/or a representation of a short-term intensity of the speech portion and/or a single short-term intensity difference value per portion of the audio content and/or a set of short-term intensity difference values describing the short-term intensity difference for a plurality of different frequencies or frequency ranges and/or an information about critical passages, e.g. passages of an audio scene for which specific signal characteristics of at least one audio component (audio portion) in the audio scene do not meet one or more desired (predefined) criteria.

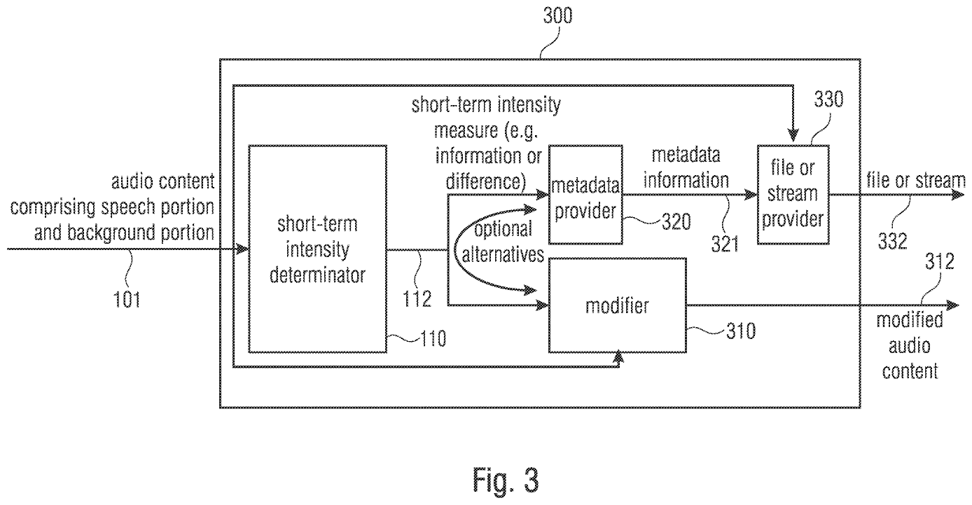

FIG. 3 shows a schematic view of an audio processor according to embodiments of the invention (e.g. according to the third aspect). FIG. 3 shows audio processor 300 comprising a short-term intensity determinator 110, which is configured to obtain an audio content 101 comprising a speech portion and a background portion. Furthermore, the audio processor 300 is configured to determine a short-term intensity difference between a speech portion of the audio content and a background portion of the audio content, and/or to determine a short-term intensity of the speech portion, using short-term intensity determinator 110, as indicated by short-term intensity measure 112. Furthermore, the audio processor 300 is configured to modify, using modifier 310, the audio content 101 in dependence of the short-term intensity difference and/or in dependence on the short-term intensity of the speech portion. Hence, as shown in FIG. 3, a modified audio content 312 may be provided. As an example, the modification may comprise a scaling of at least a portion of the audio content. As another example, modifier 310 may be configured to determine a metadata information based on the short-term intensity measure 112, in order to provide the modified audio content 310, comprising the audio content 101 and the metadata information.

As an optional alternative, the audio processor 300 may be configured, to determine, as shown in FIG. 3, using metadata provider 320, a metadata information 321 about the audio content based on the short-term intensity difference and/or based on the short-term intensity of the speech portion and to provide a file or stream 332, using file or stream provider 330 (which is hence as well optional), so that the file or stream comprises the audio content 101 and the metadata information 321.

Furthermore, as optional features, e.g. using metadata provider 320 and/or modifier 310, the audio processor may be configured to provide or alter metadata, in order to obtain a processed version 312 of the audio content. Hence, optionally, metadata already present in the audio content may be changed or additional metadata elements may be added. Accordingly, metadata provider 320 may provide metadata information 321 to a respective modifier 310 (wherein, for example, provider 330 may or may not be present).

In particular, the modified audio content may comprise a scaled version of the speech portion of the obtained audio content 101 and/or a scaled version of the background portion of the obtained audio content 101.

Furthermore, it is to be noted that embodiments are not limited to the two optional alternatives shown in FIG. 3. Hence, as an example, metadata information 321, for example based on which intensity measures can be modified, may be determined and provided for enclosing the same in a file or stream 332, or for providing such metadata information as a portion of a modified audio content such as 312. In particular, file or stream provider 330 may be configured to format the metadata information according to an audio data frame rate of the audio content 101.

Furthermore, as an optional feature, e.g. as an alternative to short-term intensity determinator 110, audio processor 300 may comprise a combination of short-term intensity determinator and an analysis result provider as show in FIG. 1, receiving audio content 101 and providing analysis result 102 to metadata provider 320 and/or modifier 310. Accordingly, audio processor 300 may comprise a neural network-based implementation discussed with regard to FIG. 2.

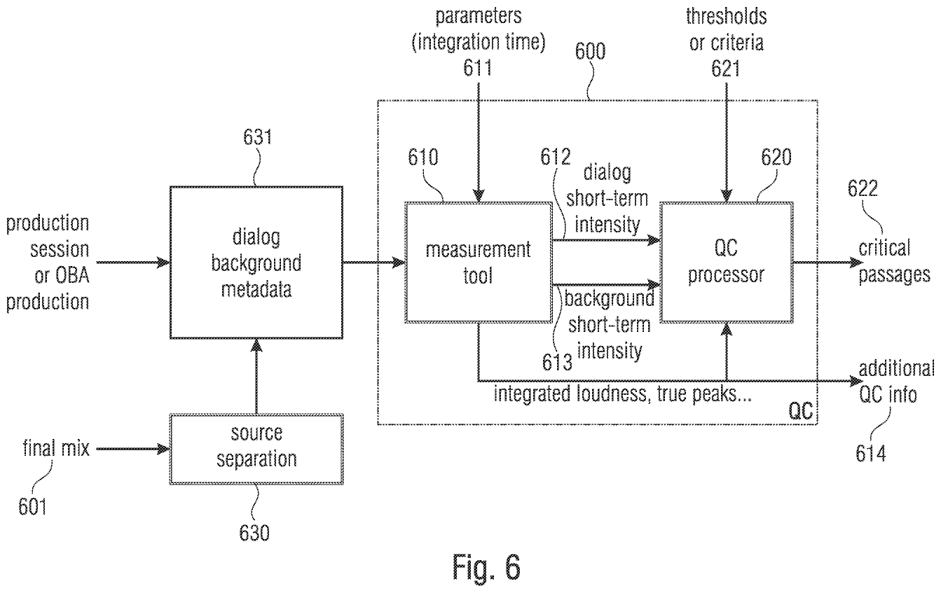

Hence, audio processor 300 may comprise an audio analyzer according to the first and/or second aspect and hence any or all of the respective features, so as to provide an accordingly determined analysis result (e.g. 101, e.g. 202, e.g. as implemented as shown in FIGS. 6 to 10) to metadata provider 320 and/or modifier 310.

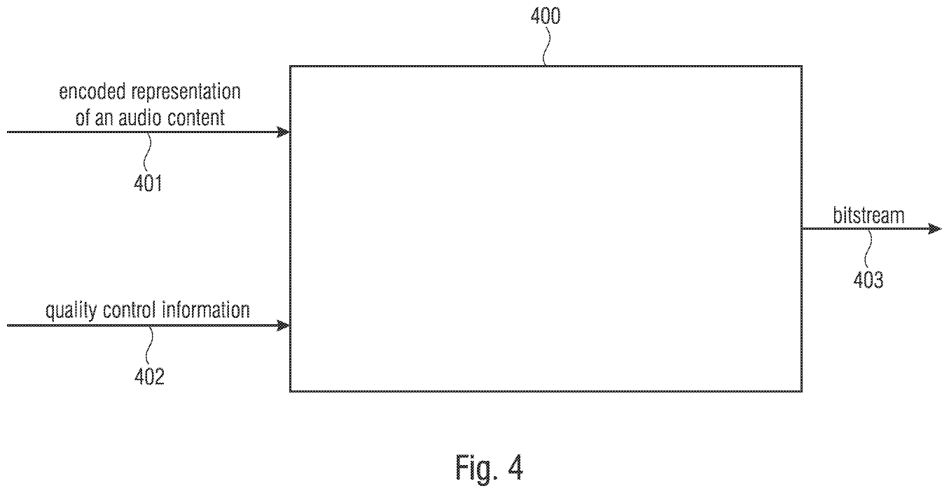

FIG. 4 shows a schematic view of a bitstream provider according to embodiments of the invention (e.g. according to the fourth aspect). FIG. 4 shows bitsteam provider 400, which is configured to include an encoded representation 401 of an audio content and a quality control information 402 into a bitstream 403. The quality control information 402 may, for example, be a quality control metadata, e.g. any kind of metadata as altered or provided or determined by a metadata provider 320 and/or a modifier 310. Hence, a bitstream provider may comprise any or all of the functionalities, details and features as discussed in the context of an audio processor according to FIG. 3, hence as well of audio analyzers according to FIGS. 1 and 2 and therefore as well according to FIGS. 6 to 18 (e.g. in a corresponding manner regarding respective decoders). Hence in particular, quality control information 402 may be determined based on an analysis result as discussed above. For example, as a difference to an analysis result in the form of intensity measures, the quality control information 402 may comprise an information about a “location”, e.g. temporal location of a problematic section of the audio content and an information based on which such a section can be improved. Information 402 may hence be an interpreted version of an analysis result, e.g. an analysis result with added optional classification information and/or instructions on how to overcome such problems, e.g. with regard to intelligibility, of a section of the audio content.

As another example, the encoded representation 401 may comprise pre-existing metadata to which the quality control information 401 is added in the bitstream 403.

Furthermore, the bitstream provider 400 may be configured, e.g. based on an interpretation of quality control information to adapt processing parameters for a decoding of the audio content

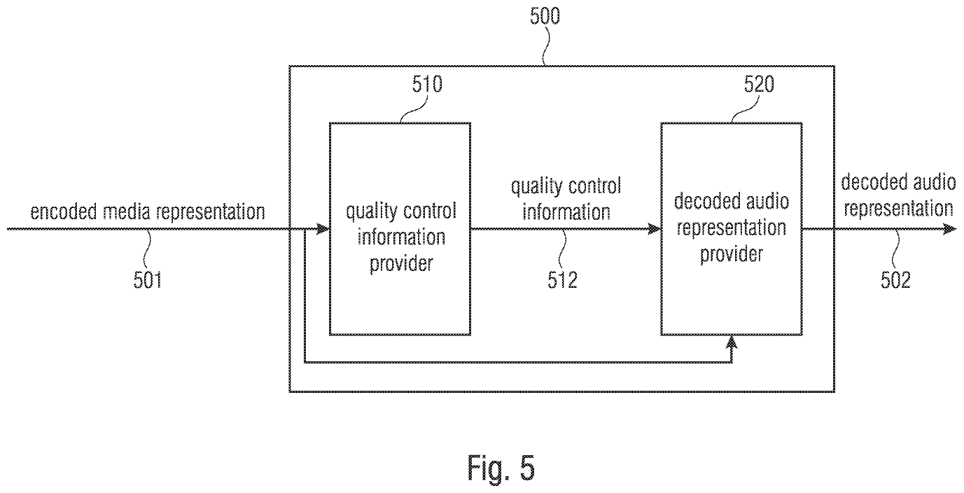

FIG. 5 shows a schematic view of an audio decoder according to embodiments of the invention (e.g. according to the fifth aspect). FIG. 5 shows audio decoder 500 comprising a quality control information provider 510 and a decoded audio representation provider 520. The audio decoder 500 is configured to obtain a quality control information 512 from an encoded media representation 501, using quality control information provider 510 and to provide a decoded audio representation 502 in dependence on the quality control information 512 and hence on the basis of the encoded media representation 501, using decoded audio representation provider 520. As an example, the encoded media representation 501 may be included in a bitsteam, such as bitstream 403 and quality control information 512 may correspond to quality control information 402.

Accordingly, embodiments as illustrated with FIG. 5 may comprise corresponding features, e.g. decoder sided, as discussed in the context of FIG. 4, e.g. in particular with regard to a corresponding quality control information 512.

In line with this, a decoder according to embodiments may be configured to determine, based on the quality control information 512, an information about a problematic section of the audio content and an information based on which such a section can be improved. Furthermore, the decoder may be configured to improve said section, e.g. in order to provide the decoded audio representation, for example as a modified audio content, e.g. in line with explanations regarding FIG. 3.

In particular, the decoder 500 may be configured to decide, based on quality control information 512, whether and which enhancements are to be performed and for which sections of the audio content. Therefore, a plurality of information, e.g. inter alia metadata information, e.g. obtained from encoded media representation 501 or obtained as an input (e.g. a decoder-sided input) may be taken into account, such as information about the listening environment, information about a user input, information about one or more sound reproduction devices and/or information about a system setting.

Such an improvement of a decoded audio content may be performed, for example, based on a filtering, wherein, for example, a parametrization of the filtering is set in dependence on the quality control information 512. The filtering may, in particular, be set according to additional information, such as a system level information, an information about one or more sound reproduction devices, an information about a listening environment and/or an information about a user input.

Problematic audio sections may be defined as critical passages, e.g. as explained in the later-discussed FIGS. 6 to 18.

It is to be noted that optionally, in the above-discussed embodiments, the short-term-intensity measures, e.g. 112, may be provided with a defined, absolute temporal resolution, e.g. no more than 3000 ms, no more than 1000 ms, no more than 400 ms, no more than 100 ms, no more than 40 ms, or no more than 20 ms or, for example, with a temporal resolution between 3000 ms and 400 ms. Furthermore, the short-term-intensity measures, e.g. 112, may as well be provided depending on a temporal resolution of an audio frame, e.g. of one, two or no more than 10 audio frames.

Furthermore, as another optional feature, in the above-discussed embodiments, the short-term-intensity measures, e.g. 112, may be determined, e.g. by a respective short-term intensity determinator 110, as a short-term loudness measure (e.g. difference such as momentary difference or loudness such as momentary loudness) or as a short-term energy measure (e.g. ratio such as momentary ratio or energy such as momentary energy).

Hence, accordingly, e.g. in the form of loudness or energy measures, the short-term intensity may be determined as a low level characteristic of the audio content. Optionally, a respective analysis result may hence rely only on such low level characteristics and may therefore be independent of higher order cognitive characteristics of the audio content.

In the following, embodiments according to the invention will be discussed further. In particular, the following section is related, inter alia, to apparatuses and methods for quality control and enhancement of audio scenes. At least some of these embodiments refer, inter alia, to methods and/or apparatuses for audio content production, post-production, and/or quality control (QC), for example, addressing different characteristics related to the measurement of audio quality, mixing levels, intelligibility, and/or listening effort. Further embodiments refer, inter alia, to methods and/or apparatuses for, for example, automatically and/or dynamically improving audio quality, mixing levels, intelligibility and/or listening effort based on transmitted metadata and/or user settings and/or other devices settings. Also, further embodiments will be defined by the enclosed claims.

It should also be noted that the present disclosure describes, explicitly or implicitly, features of content production and/or post-production QC, and/or decoding and/or encoding system and/or method.

Also, it should be noted that individual aspects described herein can be used individually or in combination. Thus, details can be added to each of said individual aspects without adding details to another one of said aspects.

It should be noted that any embodiments as defined by the claims can be supplemented by any of the details (features and functionalities) described in the following. Also, the embodiments described in the following can be used individually and can also be supplemented by any of the features in another section, or by any feature included in the claims.

Different inventive embodiments and aspects will be described in a sections related to “introduction regarding embodiments”, “terminology and definitions according to embodiments”, “problem statement and current solutions”, “embodiments according to the invention” (and in particular in respective subsections) and in a section related to “further embodiments”. Also, further embodiments will be defined by the enclosed claims.

Moreover, features and functionalities disclosed herein relating to a method can also be used in an apparatus (e.g. configured to perform such functionality). Furthermore, any features and functionalities disclosed herein with respect to an apparatus (e.g. audio analyzer, e.g. audio processor, e.g. bitstream provider, e.g. decoder) can also be used in a corresponding method. In other words, the methods disclosed herein can be supplemented by any of the features and functionalities described with respect to the apparatuses.

Also, any of the features and functionalities described herein can be implemented in hardware or in software, or using a combination of hardware and software, as will be described in the section “Implementation alternatives”.

Also, the following features, functionalities and details can be implemented as optional features in any of the embodiments discussed in the context of FIGS. 1 to 5.

### IMPLEMENTATION ALTERNATIVES

Although some aspects are described herein in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments of the invention can be implemented in hardware or in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may, for example, be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitionary.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

The apparatus described herein may be implemented using a hardware apparatus, or using a computer, or using a combination of a hardware apparatus and a computer.

The apparatus described herein, or any components of the apparatus described herein, may be implemented at least partially in hardware and/or in software.

The methods described herein may be performed using a hardware apparatus, or using a computer, or using a combination of a hardware apparatus and a computer.

The methods described herein, or any components of the apparatus described herein, may be performed at least partially by hardware and/or by software.

The herein described embodiments are merely illustrative for the principles of the present invention. It is understood that modifications and variations of the arrangements and the details described herein will be apparent to others skilled in the art. It is the intent, therefore, to be limited only by the scope of the impending patent claims and not by the specific details presented by way of description and explanation of the embodiments herein.

Next, an introduction regarding the following embodiments is provided: As stated initially, difficulties in following speech due to loud background sounds are often reported for audio mixes for television (broadcasting or streaming). Loud music and effects in the background of the audio mix can mask the dialogue in the foreground, causing fatigue and frustration in the audience [1]. This has been a known issue for decades [2]. Modern audio coding systems, e.g. Next Generation Audio (NGA) systems provide functionalities providing technological solutions on the user side. These solutions include Dynamic Range Compression (DRC) and the possibility of personalizing the speech level, also known as Dialogue Enhancement [3].

Embodiments according to the present invention comprise and/or propose a system that optionally automatically detects critical passages of an audio scene, which could, for example, be a complete audio mix, a combination of audio channels and/or audio objects as commonly used with NGA systems, and/or any other audio format used for production and delivery of audio data. According to embodiments, critical passages may be defined as the portions of the audio scene in which specific characteristics of the dialogue do not meet desired criteria. One of the most important characteristics can, for example, be an intensity measure of the foreground speech (also referred to, for example, as dialogue). Critical passages can, for example, be defined as the ones for which the intensity of the dialogue is locally too low in absolute terms and/or relatively to the background sounds, e.g. as defined by specified thresholds. As shown in [4], the relative level between dialogue and background may, for example, be an important factor determining listening effort and intelligibility, although, for example, not the only one. Other factors may comprise or may include unfamiliar vocabulary and/or accent, level of fluency in the language, complexity of the sentence, speed of delivery, mumbling, and/or muffled dialogue [5].

In the following, different inventive embodiments and aspects are described. At least some of these embodiments refer to methods and/or apparatuses for content production, post-production, and/or quality control (QC), for example comprising or including a novel approach to provide supporting information, which may, for example, give statistics about the quantity, the severity, and/or the temporal locations of the critical passages. The supporting information may, for example, include other ways to describe the critical passages of an audio scene.

Further embodiments refer to methods and/or apparatuses for efficient audio delivery (e.g. broadcast, streaming, file playback), optionally together with metadata which can, for example, include, but not limited to, information about statistics on the quantity, the severity, and/or the temporal locations of the critical passages. Based on the settings of the receiving or playback device, the user interactions with the content and/or the supporting metadata, the receiving and/or playback device can, for example, optionally automatically and/or dynamically improve the intelligibility and/or reduce the listening effort, for example, for the received content.

Further embodiments refer to methods and/or apparatuses for encoding an audio bitstream, for example, including supporting information, for example, about the temporal locations and/or the severity of the critical passages. The supporting information may, for example, be embedded into the audio bitstream and/or delivered by other means, for example, but not limited to, transport layer descriptors, for example, part of MPEG-2 Transport Stream and/or

### ISO Base Media File Format (ISO BMFF).

The methods and/or apparatuses described in the context of this application, may, for example, use the MPEG-H Audio system as an example for an audio system that can be enhanced with additional metadata and/or decoder processing elements for dynamically improving the levels of the elements composing the audio scene, for example, when they are detected as critical. It should be noted that the described methods and/or apparatus according to embodiments are not limited to the MPEG-H Audio system and can, for example, be used with other audio systems, such as MPEG-D USAC, HE-AAC, E-AC-3, AC-4, etc.

In the following, a terminology and definitions according to embodiments will be discussed: The following terminology is used in the technical field:
Audio Scene: For example, the entirety of all audio components that make up the complete audio program. The audio components comprise or even consist of audio signals (often, for example, also called audio essence) and associated metadata. Components can, for example, be objects with, e.g., associated position metadata, and/or channel signals, and/or full resp. partial mixes in a certain channel layout (e.g., stereo), and/or a mixture of all of those. A, for example essential, part of the audio scene may, for example, be that it can have associated metadata that may, for example, describe the audio components (e.g. including signal-related information like position, and/or content related information like kind), define interactivity and/or personalisation options, and/or define the relationship of the components to each other in the scene.
Dialogue: For example, speech in the foreground of an audio scene may, for example, be referred to as dialogue, optionally even though this might comprise or even consist of speakers not carrying out a dialogue. Common examples are a one-speaker voice-over commentary or multiple overlapping speakers.
NGA systems: For example, Next-generation Audio, e.g., MPEG-H Audio.
Audio Master: For example, production format file that encapsulates, optionally all, audio essences (e.g. typically in uncompressed format, e.g., PCM) and, optionally all, associated metadata.
   It may, for example, be used during audio production and/or as input format for audio encoding.
   Examples of formats in use are BWF/ADM, S-ADM in MXF, S-ADM in IMF, MPEG-H Control Track, etc.
   An Audio Master can, for example, be a file in-case of file-based post-production workflows, or a linear stream of data in case of linear realtime production workflows.

The description of the methods according to embodiments in this document may, for example, be centered around the information carried in a final mix (typically but not necessarily uncompressed) and/or in the Audio Master file and/or in the audio bitstream. For content delivery the methods are not limited to the audio bitstream and can, for example, be used with other delivery environments, such as MMT, MPEG-2 Transport Stream, DASH-ROUTE, File Format for file playback etc.

In the following, a problem statement and current solutions will be discussed: As reported in [1], producing sound which meet expectations and requirements of the audience, as well as national regulations is one of the main challenges in the production of TV shows and movies. It is a complex creative task to produce atmosphere and mood with music and other background sounds in addition to the dialogue. At the same time, the audience wish to fully understand the story and the dialogue in a comfortable way, i.e., without high listening effort. A very significant amount of the audience experiences difficulties in following speech on TV. Estimates are that 90% of the people above 60 years old have often or very often problems in understanding speech in TV [1]. This shows that state-of-the-art solutions and regulations do not suffice to deliver audio scenes that suit the needs and preferences of the audience. To tackle this problem, two main paths are identified. The first deals with supporting tools for the production, post-production, and QC phases. The second path deals with audio coding and delivery to the receiving device.

Modern QC requirements and recommendations (see e.g. [6]) include loudness specifications such as:
Overall average loudness of the program measured with some version of ITU-R BS.1770.
Overall average dialogue-gated loudness.
Peaks and true peaks.
Loudness range (LRA), over the full program and sometimes over the dialogue only.
Max Short-Term Loudness (see e.g. EBU R128 s1) to avoid strong deviations from the average loudness levels.

None of these values can, for example, capture locally critical passages. In fact, it is possible that the background elements of a scene mask the dialogue, even with very good dialogue LRA and dialogue-gated loudness.

As summarized in [7], some effort has been done to formulate recommendations for loudness differences (LDs) between dialogue and background elements. However, these did not become common practice because of two main reasons, for example as identified by the inventors: 1) they do not use short-term intensity measure but loudness values integrated over the full programs and 2) it is not trivial to compute LDs when only the final mix is available.

Embodiments according to the invention address both problems by 1) considering short-term measures such as short-term and/or momentary loudness differences between dialogue and background and 2) proposing a scalable approach for all productions formats, from final mixes (e.g. at least one of mono, stereo, surround, immersive) to a combination of audio channels and/or audio objects as commonly used with NGA systems, and/or any other audio format used for production and/or delivery of audio data.

Moreover, tools exist that measure intelligibility locally. Embodiments according to the invention (e.g. at least some) differ significantly from these tools that could, for example, be used complementarily to embodiments according to this invention. A, or for example, even the main difference and/or a or for example even the novel aspect may, for example, be, inter alia, that embodiments according to this invention may, for example, not measure intelligibility and may, for example, not necessarily consider the diverse higher-order cognitive factors determining intelligibility such as unfamiliar vocabulary and/or accent, level of fluency in the language, complexity of the sentence, speed of delivery, phoneme articulation, mumbling, and/or muffled dialogue. As an example, instead, it is proposed to consider low-level characteristics of the audio signals, such as their short-term energy ratio or short-term LDs or momentary LDs (Hence, as an example, embodiments may be configured to consider low-level characteristics of the audio signals, such as their short-term energy ratio or short-term LDs or momentary LDs). These can, for example, be proxies for intelligibility and/or listening effort, but, for example, most importantly may optionally offer the possibility of straightforward improvements such as locally changing the energy ratio or LDs. The same may, for example, not be true if intelligibility is measured, as the reason for low intelligibility can be very diverse and of cognitive nature.

Thus, using low-level characteristics of the audio signal like short-term and/or momentary LD instead of an abstract higher-order, cognitive-related intelligibility may, for example, have the advantage that the audio signal can, for example, be modified based on the measured audio-signal characteristics. This modification can, for example, be done directly with altering the audio mix, and/or indirectly by capturing the modifications as metadata that can be applied in the receiving and playback device.

At the same time those low-level characteristics can, for example, be a good estimate or a proxy for the intelligibility of dialog in audio-mixes, for example as they are produced for TV broadcast and/or streaming content, as shown in [4].

Modern audio coding systems may, for example, provide functionalities such as DRC and moreover NGA systems may, for example, enable user to personalize the speech level for better intelligibility in various listening environments, within the limits set in production. While these options can, for example, help the user to better understand the dialog, they are, for example, not sufficient for ensuring the best quality of experience in every situation and for each user. With NGA systems, the user can, for example, manually increase and/or decrease the level of the dialog during a program (e.g., a movie). Another option that is available in various audio codecs allows the user to select a DRC profile. Both options, increasing the level of the dialog in NGA systems and selecting a certain DRC profile, can, for example, improve the intelligibility for the problematic passages but may, for example, or even will also alter the rest of the mix where the content would, for example be perfectly intelligible and/or even alter passages without speech. The reason is, for example, that they are typically applied statically to the complete content of a program. For example, a critical passage may, for example, be present during the introduction trailer of a movie. The user can optionally decrease the relative level of the background and/or select a DRC profile helping intelligibility. In this way, the user may, for example, or even will understand the dialog better during this passage. However, the background can, for example, remain at decreased and/or compressed level at least partially for the complete movie, although the content would, for example, have no issue after the problematic introduction part. The user may, for example, or even will experience the movie without all the music and effects and other components designed during the content creation. In this example case, better understanding the critical passage came at the cost of less full authentic enjoyment of the remaining content.

Some NGA systems, like MPEG-H Audio, enable the delivery of dynamic metadata alongside the audio data. However, it is not defined how to set this metadata, resp. how to derive the information to write this metadata. One way may, for example, be to set this manually during audio production which may, for example, be time consuming for the sound producer.

Hence, the inventors recognized that using the information about the precise location of the problematic passages either in production for QC, for example, followed by special attention of the sound producer and/or potential re-mixing of the critical locations, and/or during playback at the receiving device, can, for example, ensure that the content is processed only during the problematic passages and, for example, not applied over the entire content. This may, for example, or even will preserve the artistic intent and optionally at the same time may, for example, reduce the listening effort and/or improve the intelligibility for the end user.

Also, creating multiple DRC sequences for various levels of enhancement can, for example, lead to a significant increase in the bitrate and/or reduced functionality based on the number of sequences transmitted. Moreover, DRC is a global tool, i.e. the selected DRC profile or sequence is applied to the whole program, thus the complete program may, for example, be processed. As described above, it may, for example, not be suitable for the case that intelligibility is only an issue in certain problematic passages of the program and/or when it is desired to avoid DRC-processing of passages without dialog.

Hence, a more effective way to carry the information about the problematic passages is proposed according to embodiments of this invention, which optionally highly optimizes the delivery of the information about the problematic passages.

In the following, different embodiments, for example covering different use cases, are presented and discussed:

First, optional details regarding generating a QC report are discussed: In a possible embodiment, a method and/or apparatus is proposed for generating a QC report of an audio scene, for example, as a supporting tool during production, post-production, and/or QC, and optionally offering, for example automatic, improvements and/or supporting a human operator to improve the audio quality of the audio scene. This method and/or apparatus may, for example, take different production audio formats as input, e.g., final mixes in mono, stereo, surround, and/or immersive formats, for example as well as a combination of audio channels and/or audio objects, for example as commonly used with NGA systems. The generated QC report may, for example, comprise or contain information about critical passages, e.g., their location and/or severity. Possible formats for the QC report may, for example, comprise or include human-readable text, and/or machine-readable formats (e.g., csv, xml), and/or as visual information, and/or as a control track, and/or as a combination of these. Optionally, automatic fixes may, for example, be proposed to enhance the critical passages. This or such an inventive system can, for example, be implemented as a stand-alone tool, and/or as a part of an audio production suite, and/or integrated in a DAW, or as a VST plug-in. This or such an inventive system can, for example, be implemented in different ways, optionally as described in the following embodiments.

Next, optional details regarding generating a QC report in a step-by-step approach (see e.g. FIG. 6) are discussed. FIG. 6 shows a schematic view of an example for generating a QC Report in a step-by-step approach according to an embodiment. It is to be noted that all elements of analyzer 600 shown in FIG. 6 are optional.

Hence, FIG. 6 shows a schematic view of an audio analyzer with optional features according to embodiments of the invention (e.g. according to the first aspect). FIG. 6 shows audio analyzer 600 comprising a measurement tool 610 and a quality control processor 620. Furthermore, audio analyzer 600 comprises an optional source separation unit 630. The source separation unit 630 may be provided with a final mix (e.g. an audio content wherein a speech portion and a background portion are mixed, e.g. optionally in addition to metadata), in order to extract different portions of the final mix, such as speech, e.g. dialog, background and metadata, see 631. Alternatively, the analyzer 600 may be provided directly with the different portions of the audio content. As another optional feature, measurement tool 610 may as well be configured to combine portions of the audio content, e.g. of a same type, such as speech or background, for the subsequent determination of the intensity measures (for example to form component groups). Optionally, measurement tool 610 may be provided with parameters 611, such as an integration time, in order to determine the short-term intensity measure, e.g. a short-term intensity information 612 for the speech portion and a short a short-term intensity information 613 for the background portion and/or in order to determine additional QC info 614. Optionally, as discussed above, differences or ratios of the speech and background portion may be determined. As another optional feature, the additional quality control information 614, e.g. comprising information such as an integrated loudness and/or true peaks, may be determined by the measurement tool 610. The short-term intensity measures 612, 613 and here as an example, the additional QC information 614 are provided to the quality control processor 620, in order to determine critical passages 622. As another optional feature, the QC processor 620 may be provided with thresholds or further criteria, see 621 (for example for determining and optionally classifying the critical passages).

It is to be noted that a pre-processing, for example using a source separation 630 and/or an optional combination of audio components may accordingly be implemented in neural network based embodiments as shown in FIG. 2 as well as in embodiments according to FIG. 3, e.g. as a pre-processing of content 101, before being provided to determinator 110.

In other words, in a possible embodiment (e.g. as shown in FIG. 6), a method and/or apparatus, e.g. 600, is proposed for generating a QC report of an audio scene as supporting tool, for example, during production, post-production, and/or QC, and/or offering automatic improvements and/or supporting a human operator to improve the audio quality of the audio scene. Such a method and/or apparatus may, for example, embody or comprise, but is not limited to, parts of the system, e.g. 600, described in FIG. 6, comprising:
an optional Measurement Tool 610, for example, configured to analyze the incoming audio signals (e.g. 601, e.g. 631) and/or determine, for example, the short-term intensities (e.g. 612, 613) of the different audio components associated with dialog type (e.g., speech, commentary, audio description, etc.) and/or with background type (e.g., music and effects, stadium atmosphere, etc.).
   The short-term intensities (e.g. 612, 613) of the audio signals may, for example, be computed using a measurement tool, e.g. 610, making use, for example of:
      The local power of the audio signals; and/or
      The power of a filtered signal where the filtering optionally mimics the frequency selective sensitivity of the human ear; and/or
      Short-term and/or momentary loudness, for example, as per ITU-R BS. 1770 [8] and/or EBU Recommendation R 128 or a variation of them, e.g., using a different time window size; and/or
      A computational model of loudness; and/or
      An AI-based intensity estimate.
In different embodiments, multiple audio signals of the same or similar type may, for example, be combined together, optionally before the measurement or determination or approximation of the short-term intensities. The process to combine the signals may, for example, be done for example based on:
   the importance of the multiple audio signals, where the importance of the audio signals may, for example, be manually set and/or determined based on the speech parts comprised or contained in the signal; and/or
   the contribution of each audio signal to the final mix, considering audio masking effects and the properties of the human hearing system.
an optional QC Processor module 620 which may, for example, be configured to receive as input the information about the short-term intensities (e.g. 612, 613) of the audio signals and/or optionally decision criteria (e.g. 621) to detect the critical passages in the audio signals.
   In a specific embodiment the decision criteria may, for example, comprise or contain at least a threshold value, see e.g. 621, and optionally the local intensity differences (e.g. between dialog and background, e.g. 612, 613) may, for example, be compared against or with this threshold value. For example, all portions of the audio signals with a local intensity difference smaller than the threshold may, for example, be marked as critical passages, e.g. 622, in the audio signals.
      In different embodiments, multiple threshold values may, for example, be used for different parts of the audio signals and/or different types of signals.
      In different embodiments, frequency-based threshold values may, for example, be set, optionally according to the frequency selective sensitivity of the human ear and/or other psychoacoustic model.
      In different embodiments, the criteria may, for example, be based on an AI-based module (e.g. DNN-based) which would or which may detect the critical passages.
The result of the detection may, for example, or would return information about the critical passages which may, for example, include but not limited to:
   The start of each critical passages in the audio signals; and/or
   The end and/or the duration of each critical passages in the audio signals; and/or
   A level of the criticalness which may, for example, be associated with the intelligibility level and/or listening effort, for example, needed to understand the critical passage; and/or
   Additional information which may, for example, be used to support the production, post-production, and/or QC phases.
an optional Source Separation module 630 (e.g. possibly AI-based as in [9]) that may for example be configured to estimate dialogue and/or background elements (see e.g. 631) given their mixture to be used if separate dialogue and/or background (e.g. respective portion of an audio content) are not available from production.

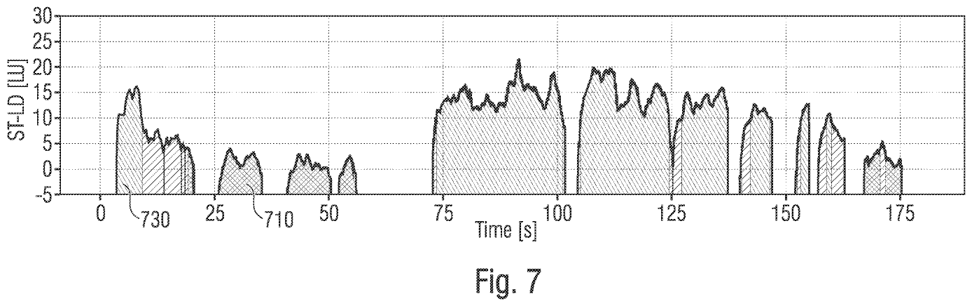

The following thresholds can, for example, be set on the short-term loudness differences.
As an example, short-term loudness differences (ST-LD) below 4 LU (e.g. loudness units) could, for example, be marked as very critical (and/or, for example, flagged in red), short-term loudness differences between 4 LU and 10 LU, for example, as mildly critical (and/or, for example, flagged in yellow) and above 10 LU can, for example, be considered as non-critical (and/or, for example, flagged in blue). These example values follow [7], with the important note that in [7] and in related works loudness values are considered integrated over the full audio program. On the contrary, embodiment according to the invention comprise a or focus on local (i.e. short-term) intensity differences.
An example output visualization can, for example, show the ST-LD over time as in FIG. 7. Hence, FIG. 7 shows a schematic example visualization of short-term loudness differences (ST-LD) for quality control (QC) according to embodiments of the invention, with sections being marked as very critical, 710, mildly critical, 720 and non-critical, 730. As an example, a visualization as shown in FIG. 7 may be provided by an audio analyzer.
Additionally, a summary can, for example, be produced, e.g., reporting the percentage of critical passages. Locations of the critical passages can, for example, be displayed or stored to an output file that can be imported by another DAW or production tool.

As another example, QC processor 620 may, for example, be configured to detect critical passages 622 if the absolute level of speech (an information of which may be included in 612) locally deviates by a threshold, such as 10 LU, from the speech loudness integrated or averaged over the full program. In particular, a combination of absolute speech loudness deviation and short-term speech loudness relative to the background may be used. Hence, the measurement tool 610 may be configured to provide an averaged speech information to the QC processor and the thresholds 621 may comprise respective information about the criteria for evaluation.

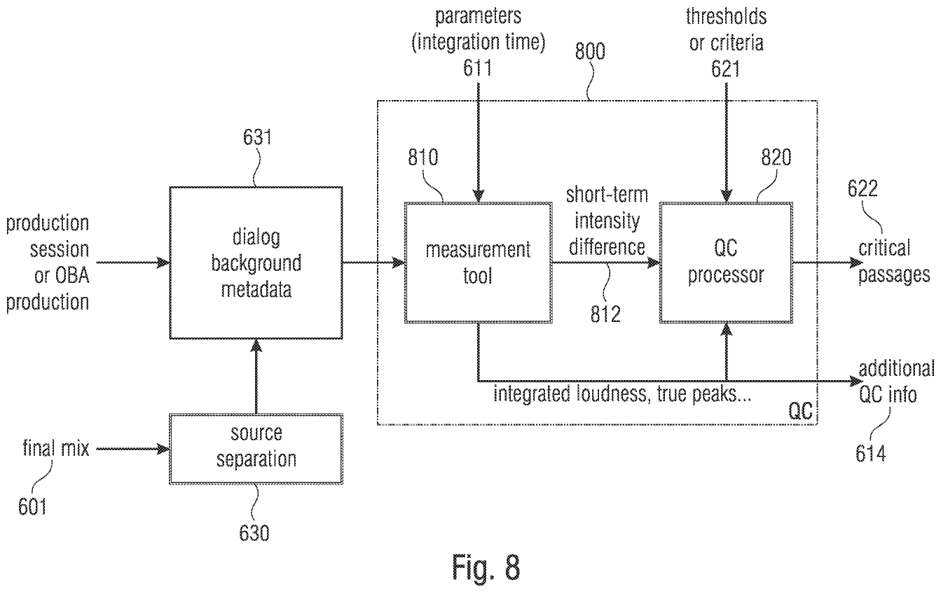

Next, reference is made to inventive aspects regarding generating QC report in a step-by-step approach where the measurement tool directly outputs short-time intensity difference instead of short-time intensity according to embodiments (see e.g. FIG. 8). FIG. 8 shows a schematic view of an audio analyzer for an optional determination of a short-time intensity difference according to an embodiment. In other words, FIG. 8 shows a schematic view of an audio analyzer for generating a QC Report in a step-by-step approach where the measurement tool directly outputs short-time intensity difference instead of short-time intensity according to an embodiment. It is to be noted that the elements of audio analyzer 800 shown in FIG. 8 are optional. Analyzer 800 comprises the elements as discussed in the context of FIG. 6, but with a measurement tool 810, which is configured to provide a short-term intensity difference (e.g. of speech and background) to the QC processor 820, in order to obtain the critical passages 622.

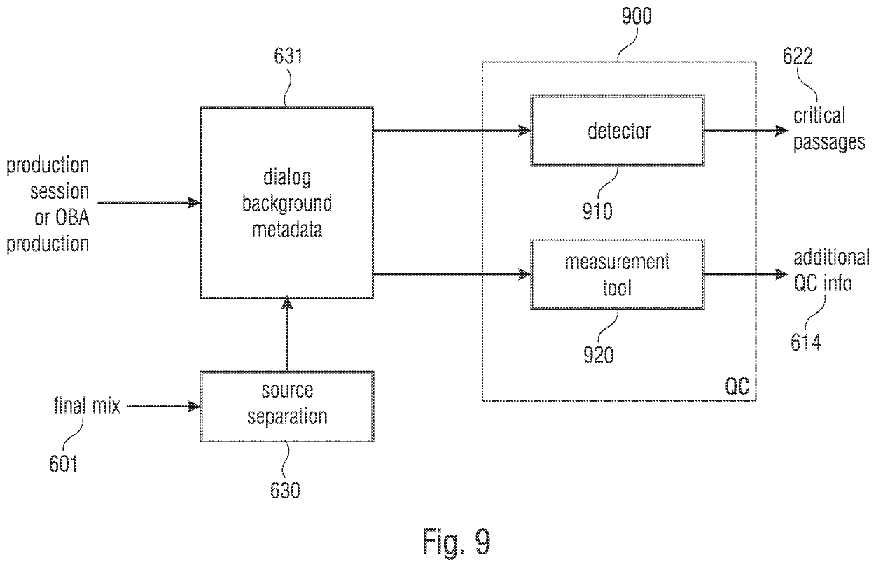

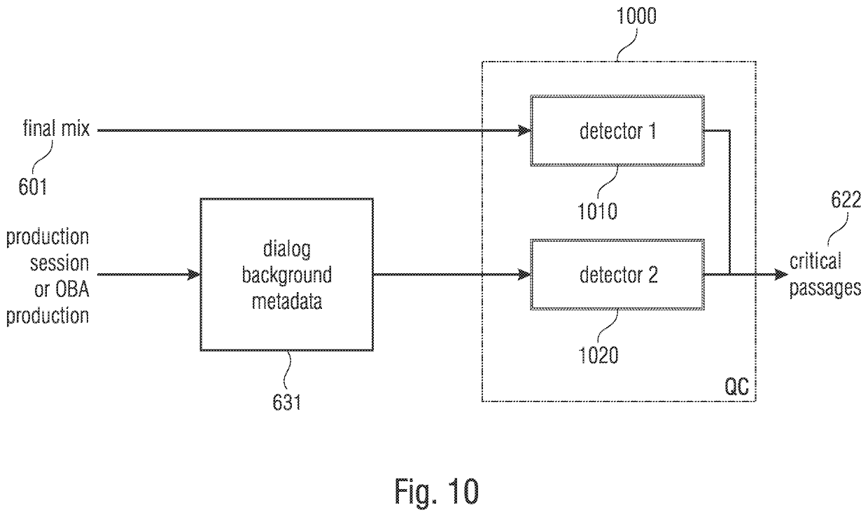

Next, reference is made to inventive aspects regarding generating a QC Report in one step according to an embodiment: In such an embodiment, critical passages are, as an example, estimated optionally directly from the audio input, e.g., by an end-to-end detector module. The detector module can, for example, be an artificial neural network (ANN), optionally trained using the previous embodiment as teacher, as shown in FIG. 9 and FIG. 10.

FIG. 9 shows a schematic view of an audio analyzer with a detector according to embodiments of the invention. In particular, FIG. 9 shows a schematic view of an example for generating a QC report in one step according to an embodiment. It is to be noted that all elements of analyzer 900 are optional. FIG. 9 shows audio analyzer 900 comprising a detector 910 and a measurement tool 920. As shown, the detector 910 may be configured to obtain critical passages 622 based on audio content in in the form of a speech portion, e.g. dialog, and a background portion, e.g. optionally with an additional metadata information, see 631. Based on the audio content 631, the measurement tool 910 may be configured to provide an optional, additional QC info 614. Again analyzer 900 may optionally comprise a source separation unit 630, for extracting information 631 from a final mix 601.

FIG. 10 shows a schematic view of an audio analyzer with two detectors according to embodiments of the invention. In particular, FIG. 10 shows an example for generating a QC report in one step without explicit source separation according to an embodiment. It is to be noted that all elements of analyzer 1000 are optional. This approach can be used in combination with a measurement tool for providing additional QC info, such as 614. The audio analyzer 1000 as shown in FIG. 10 comprises a first detector 1010 and a second detector 1020. As an example, a respective detector may be chosen based on the format or structure of the input, e.g. whether a final mix 601 is provided, or distinct portions of an audio content, such as a speech portion and a background portion, e.g. as indicated with 631.

Next, reference is made to inventive aspects regarding deriving QC metadata from the QC report and encapsulate (e.g. for encapsulating) it in an Audio Master according to an embodiment: Embodiments comprise or include generating QC metadata structures and data packets, the metadata attributes may, for example, be derived from the QC reports.

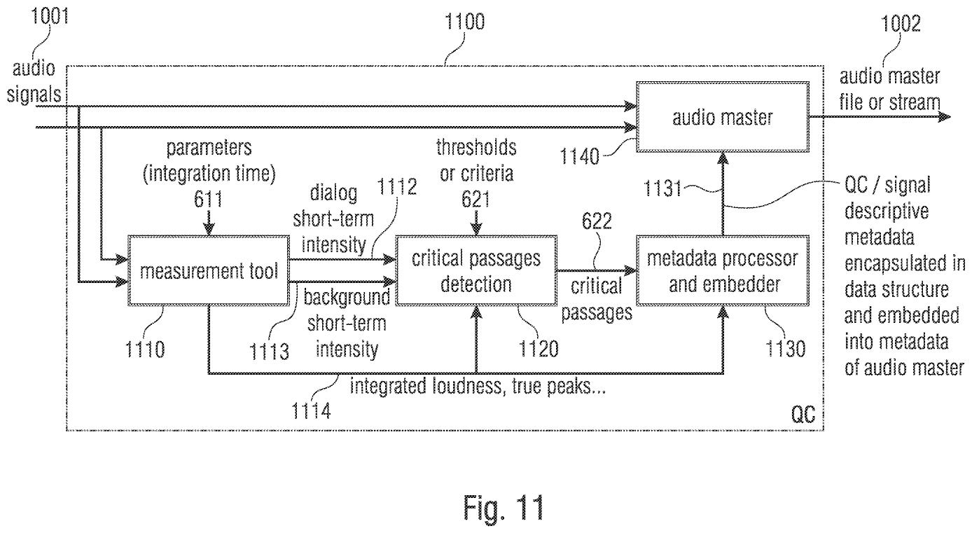

Reference is made to FIG. 11. FIG. 11 shows a schematic view of an audio processor with optional features according to embodiments of the invention. In particular, FIG. 11 shows a schematic view of an example for deriving QC metadata from the QC report and encapsulate (e.g. for encapsulating) it in an Audio Master according to embodiments. It is to be noted that all elements of processor 1100 are optional.

Audio processor 1100 comprises a measurement tool 1110, a critical passages detector 1120, a metadata processor and embedder 1130 and an audio master 1140. An audio content 1001 is indicated as audio signals in FIG. 11, which are provided to measurement tool 1110. As an optional feature, measurement tool 1110 may be provided with a set of parameters 611, such as an integration time. The measurement tool 1110 is configured to determine a short-term intensity 1112 of the speech portion and a short-term intensity 1113 of the background portion and to provide the same to the critical passages detector 1120 (Optionally, as discussed with FIG. 8, a difference may be determined, or said processing may be performed AI-based).

Furthermore, as an optional feature, the measurement tool 1110 is configured to provide an additional QC information 1114, such as an information about an integrated loudness or true peaks (e.g. corresponding to previously discussed signal 614), to the critical passages detector 1120 (e.g. corresponding to previously discussed processors 620, 820) as well as to the metadata processor and embedder 1130. In accordance with the above embodiments, the critical passages detector 1120 may optionally be provided with thresholds or other criteria 621 for determining the critical passages 622, which are provided to the metadata processor and embedder 1130. The metadata processor and embedder 1130 is configured to determine, using the critical passages 622 and optionally the additional QC information 1114 a metadata information 1131, e.g. a QC/signal descriptive metadata, which may, for example, be encapsulated in a data structure, and which may optionally be embedded into metadata of the Audio Master 1140 in order to provide Audio Master file or stream 1002.

Hence, in a possible embodiment (e.g. as shown in FIG. 11), a method and/or apparatus is proposed for creating metadata structures and/or metadata data-packets that may, for example, encapsulate quality control and/or signal descriptive metadata, for example, to drive the enhancement of the Audio Scene. Those metadata structures can, for example, be embedded into the original file that comprises or contains the audio signals and/or a newly created Audio Master file. For example in all cases the metadata structures may, for example, accompany the audio signals, the audio signals themselves may, for example, be unmodified.

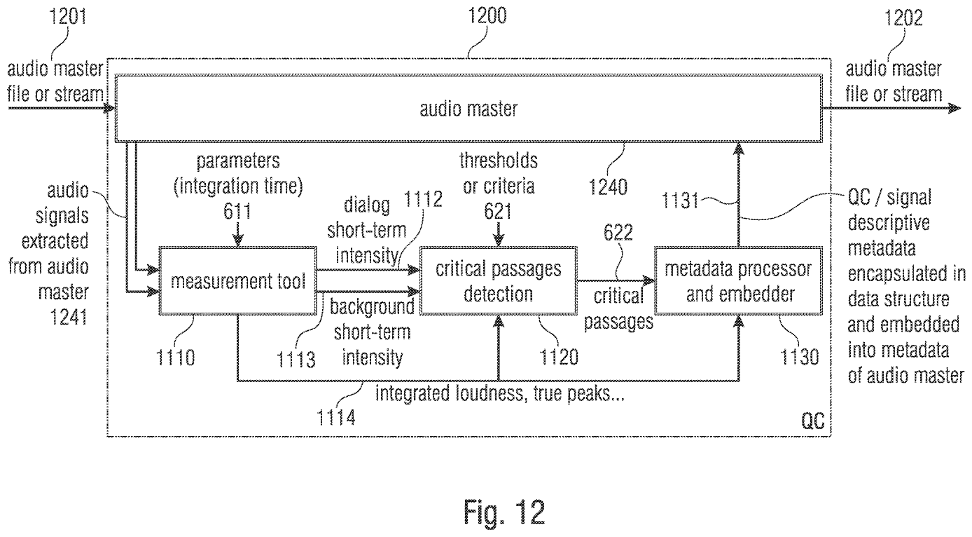

Reference is made to FIG. 12. FIG. 12 shows a schematic view of a second audio processor with optional features according to embodiments of the invention. In particular, FIG. 12 shows a schematic view of an embodiment for deriving QC metadata from the QC Report and encapsulate it (e.g. for encapsulating it) in Audio Master according to embodiments. It is to be noted that all elements of audio processor 1200 are optional. The audio processor 1200 is configured to receive an Audio Master file or stream 1201 and is configured to, e.g. in comparison to FIG. 11, extract Audio Signals 1241, and to provide the same to measurement tool 1110.

Hence, in another possible embodiment (e.g. as shown in FIG. 12), a method and/or apparatus is proposed for creating metadata structures and/or metadata data-packets that may, for example, encapsulate, for example, quality control and/or signal descriptive metadata, for example, to drive the enhancement of the Audio Scene. Those metadata structures (e.g. 1131) may, for example, be embedded into Audio Master File (e.g. 1202) that comprises or contains the audio signals and already existing Audio Scene metadata. The quality control and/or signal descriptive metadata structures or added to the audio scene metadata (may, for example, be added to the audio scene metadata), the audio signals themselves may, for example, be unmodified.

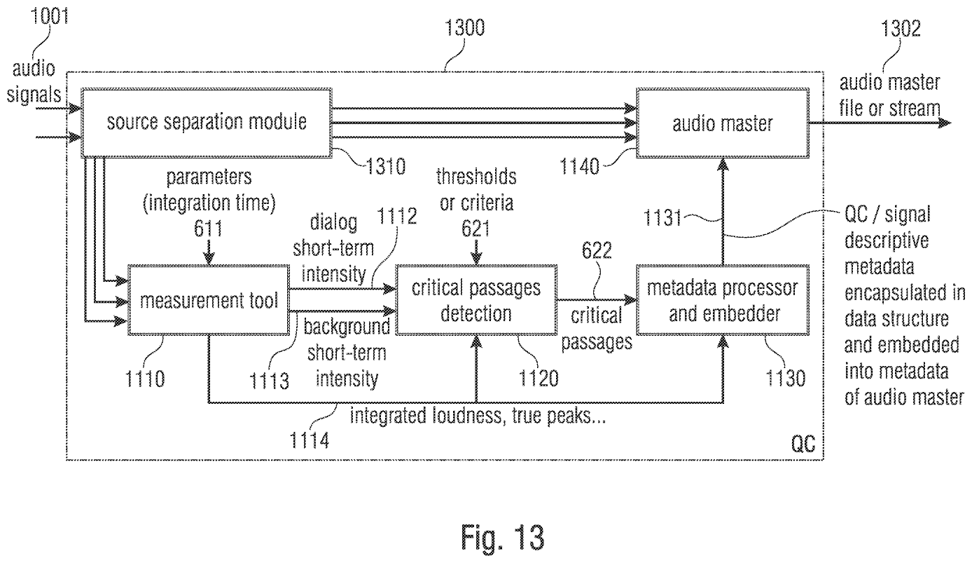

Reference is made to FIG. 13. FIG. 13 shows a schematic view of a third audio processor with optional features according to embodiments of the invention. In particular, FIG. 13 shows a schematic view of an embodiment for deriving audio elements and metadata and encapsulate it (e.g. for encapsulating it) in an Audio Master according to an embodiment. It is to be noted that all elements of audio processor 1300 are optional. In comparison to the audio processor as shown in FIG. 11, audio processor 1300 comprises an optional source separation module 1310 (e.g. corresponding to elements 630), which is configured to provide, based on audio signals 1001, separated signals (e.g. dialog, background and metadata) to measurement tool 1110, as well as to Audio Master 1140, in order to provide Audio Master file or stream 1302.

Hence, in another possible embodiment (e.g. as shown in FIG. 13), a method and/or apparatus is proposed for creating metadata structures and/or metadata data-packets that may, for example, encapsulate, for example, quality control and/or signal descriptive metadata, for example, to drive the enhancement of the Audio Scene. Those metadata structures (e.g. 1131) may, for example, be embedded into a newly created Audio Master file (e.g. 1302). In addition, the method and/or apparatus may, for example, comprise or contain a Source Separation

Module (e.g. 1310) that may, for example, be configured to estimate dialogue and/or background elements, for example, given their mixture, optionally to be used if separate dialogue and/or background (e.g. respective portions of an audio content) are not available, for example, from production. Those dialogue and/or background elements may, for example, be extracted from the input audio signals (e.g. 1001) and new audio signals for those dialogue and/or background elements may, for example, be created. Those newly created audio signals may, for example, further on be used by the Measurement Tool (e.g. 1110) and, for example, optionally be embedded into the output Audio Master file, optionally together with the metadata structures that may, for example, accompany the audio signals.

Such methods and/or apparatus may, for example, embody or comprise, but are not limited to, parts of the system described in FIGS. 11, 12 and 13, optionally comprising:
an optional Measurement Tool, e.g. 1110, for example, configured to analyze the incoming audio signals, e.g. 1001, e.g. 1241, and/or determine the shot-term intensities (e.g. short-term intensities) of the different audio components associated with dialog type (e.g., speech, commentary, audio description, etc.) and/or with background type (e.g., music and effects, stadium atmosphere, etc.)
   The short-term intensities of the audio signals may, for example, be computed using a measurement tool making use, for example of:
      The local power of the audio signals and/or
      The power of a filtered signal where the filtering optionally mimics the frequency selective sensitivity of the human ear and/or
      Short-term and/or momentary loudness, for example, as per ITU-R BS. 1770 [8] and EBU Recommendation R 128 or a variation of them, e.g., using a different time window size and/or
      A computational model of loudness and/or
      An AI-based intensity estimate.
   In different embodiments, multiple audio signals of the same and/or similar type may, for example, be combined together optionally before the measurement of the short-term intensities. The process to combine the signals may, for example, be done for example based on:
      the importance of the multiple audio signals, where the importance of the audio signals may, for example, be manually set and/or determined based on the speech parts comprises and/or contained in the signal; and/or
      the contribution of, for example each, audio signal to the final mix, for example considering audio masking effects and/or the properties of the human hearing system
an optional Critical Passage Detection module, e.g. 1120, which may, for example, be configured to receive as input the information (e.g. 1112, e.g. 1113, or a ratio or difference thereof) about the short-term intensities of the audio signals and/or decision criteria (see e.g. 621) to detect the critical passages in the audio signals.
   In a specific embodiment the decision criteria may, for example, comprise or contain at least a threshold value and the local intensity differences may, for example, be compared against or with this threshold value. Optionally, all portions of the audio signals with a local intensity difference smaller than the threshold may, for example, be marked as critical passages in the audio signals.
      In different embodiments, multiple threshold values may, for example, be used, for example, for different parts of the audio signals and/or different types of signals.
      In different embodiments, frequency-based threshold values may, for example, be set optionally according to the frequency selective sensitivity of the human ear and/or other psychoacoustic model.
      In different embodiments, the criteria may, for example, be based on an AI-based module (e.g. DNN-based) which may, for example, or would detect the critical passages.
   The result of the detection may, for example, or would return information about the critical passages which may, for example, include but not limited to:
      The start of each critical passages in the audio signals; and/or
      The end and/or the duration of each critical passages in the audio signals; and/or
      A level of the criticalness which may, for example, be associated with the intelligibility level and/or listening effort, for example, needed to understand the critical passage; and/or
      Additional information which may, for example, be used to trigger a different processing in the receiving and/or playback device, which may, for example, include filter coefficients, gain values, etc.
an optional QC Metadata Processor, e.g. 1130, that may, for example, be configured or that would format the information received from the Critical Passage Detection module into QC metadata packets optionally aligned to the audio data frame rate and, for example, provide them to QC metadata embedder.
an optional QC Metadata Embedder, e.g. 1130, that may, for example, be configured to or that would encapsulate the QC and signal descriptive metadata in data packets and/or data structures and optionally insert into the Audio Master file and/or stream. Those structures may, for example, accompany the audio signals they refer to, the QC Metadata Embedder may, for example, not modify those audio signals. Depending on the Audio Master file/stream format, different encapsulation methods may, for example, be used, e.g., ADM data structures and/or Control Track data structures. The data structures and packets may, for example, be encapsulated in the various Audio Master file and/or stream formats, either as static, file-level data, for example in case of a complete QC Report for a complete program, and/or dynamic, time-variant, for example in case of time-variant metadata, and/or realtime stream Audio Master formats.

It is to be noted that embodiments may, for example comprise only a QC metadata processor so as to provide QC metadata as output, e.g. without embedding the same in a file or stream. Furthermore, QC Metadata Processor and QC Metadata Embedder may, for example, be implemented as separate processing units.

Next, reference is made to inventive aspects regarding converting QC metadata from Audio Master to bitstream in the Audio Encoder: Devices such as bitstream providers according to embodiments may, for example, be configured to read metadata from an Audio Master and optionally to convert it into bitstream metadata structures and optionally to embed them into the audio bitstream, for example, during audio encoding.

Furthermore, reference is made to inventive aspects regarding an enhancement of the audio scene based on additional QC metadata: The following embodiments describe, for example, alternative ways to use supporting metadata and/or metadata manipulation mechanisms in the receiving device at decoder and/or systems level, for example, for changing the audio elements in the audio scene, for example, for automatically and/or dynamically improving the intelligibility and/or, for example, for reducing the listening effort for the received content.

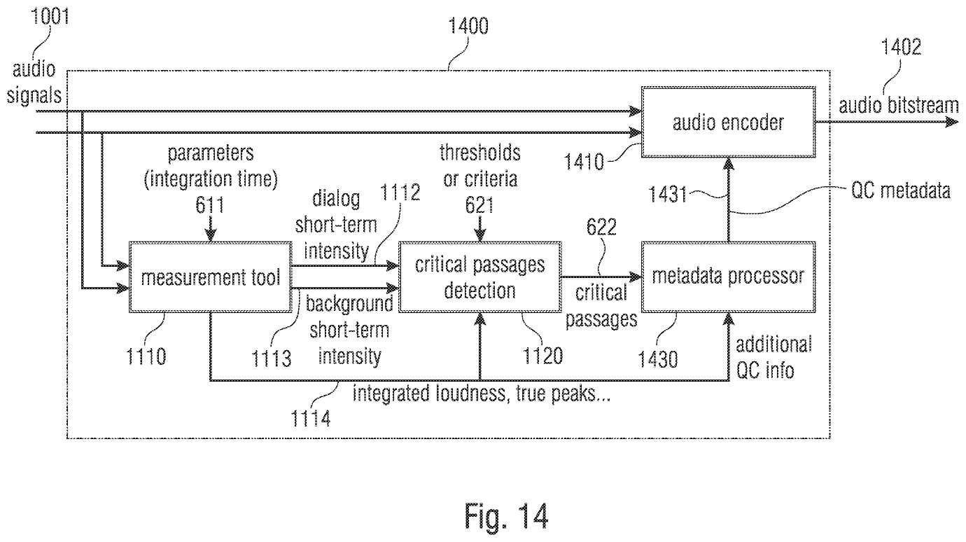

Reference is made to FIG. 14. FIG. 14 shows a schematic view of a bitstream provider with optional features according to embodiments of the invention. In particular, FIG. 14 shows a schematic view of an example system architecture using metadata for enhancing the audio scene (Encoder side) according to embodiments. It is to be noted that all elements of bitstream provider 1400 are optional. FIG. 14 shows bitstream provider 1400 comprising an audio encoder 1410 (e.g. an encoding unit, e.g. an encoder core, or an encoding core). As optional features, bitstream provider 1400 comprises a measurement tool 1110, a critical passages detector 1120 and a metadata processor 1430. The bitstream provider 1400 is configured to include an encoded representation of an audio content 1001 and a quality control information 1431 (as an example in the form of QC metadata) into a bitstream 1402.

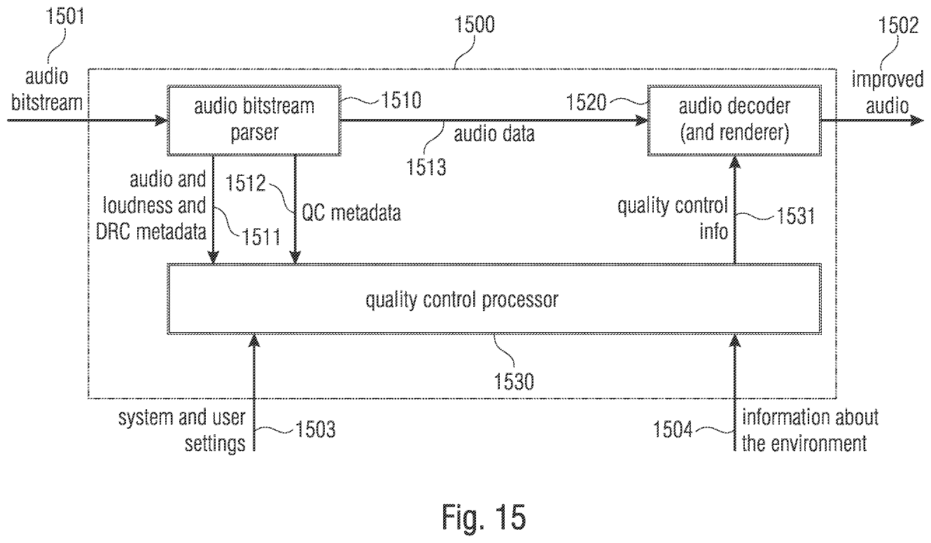

Next, reference is made to FIG. 15. FIG. 15 shows a schematic view of an audio decoder with optional features according to embodiments of the invention. In particular, FIG. 15 shows a schematic view of a system architecture using metadata for enhancing the audio scene (Decoder side) according to embodiments. It is to be noted that all elements of decoder 1500 are optional. FIG. 15 shows audio decoder 1500 comprising an audio bitstream parser 1510 and a decoding unit 1520 (which is, as an optional feature, configured to render an audio data received, e.g. a decoder core, e.g. a decoding core). Furthermore, audio decoder 1500 comprises an optional quality control processor 1530. Hence, parser 1510 may be provided with bitstream 1501, in order to extract audio data 1513 for the decoder 1520 and metadata 1511 (e.g. such as additional metadata, e.g. audio and loudness and DRC metadata) and 1512 (e.g. QC metadata) for the processor 1530. As additional, optional inputs, the processor 1530 may be provided with setting information 1503 (e.g. system and user settings) and environmental information 1504, in order to provide a quality control information 1531 to decoding unit 1520. The decoding unit 1520 may be configured to enhance the audio data 1513 based on QC information 1531 in order to obtain improved audio 1502.

Hence, in other words, example system architectures according to an embodiment using the inventive system are shown in FIG. 14 (Encoder/Emission side) and FIG. 15 (Decoder/Receiver side).

Reference is made to inventive aspects regarding a method and/or apparatus for creating an audio bitstream including QC metadata according to embodiments: In a possible embodiment, a method and/or apparatus is proposed for creating an audio bitstream including, for example, quality control and/or signal descriptive metadata, for example, to drive the enhancement of the Audio Scene. Such a method and/or apparatus may, for example, embody or comprise, but is not limited to, parts of the system described in FIG. 14, comprising:
an optional Measurement Tool, e.g. 1110, for example configured to analyze the incoming audio signals and optionally to determine the shot-term intensities (e.g. short-term intensities 1112, 1113, e.g. differences or ratios thereof) of the different audio components associated with dialog type (e.g., speech, commentary, audio description, etc.) and/or with background type (e.g., music and effects, stadium atmosphere, etc.).
   The short-term intensities of the audio signals may, for example, be computed using a measurement tool making use, for example of:
      The local power of the audio signals and/or
      The power of a filtered signal where the filtering optionally mimics the frequency selective sensitivity of the human ear; and/or
      Short-term and/or momentary loudness, for example, as per ITU-R BS. 1770 [8] and/or EBU Recommendation R 128 or a variation of them, e.g., using a different time window size; and/or
      A computational model of loudness; and/or
      An AI-based intensity estimate.
   In different embodiments, multiple audio signals of the same or similar type may, for example, be combined together before the measurement of the short-term intensities. The process to combine the signals may, for example, be done for example based on:
      the importance of the multiple audio signals, where the importance of the audio signals may, for example, be manually set and/or determined based on the speech parts comprised or contained in the signal; and/or
      the contribution of each audio signal to the final mix, for example, considering audio masking effects and/or the properties of the human hearing system
an optional Critical Passage Detection module, e.g. 1120, which may, for example, be configured to receive as input the information about the short-term intensities of the audio signals and/or decision criteria, e.g. 621, to detect the critical passages, e.g. 622, in the audio signals.
   In a specific embodiment the decision criteria may, for example, comprise or contain at least a threshold value and the local intensity differences may, for example, be compared against or with this threshold value. For example all portions of the audio signals with a local intensity difference smaller than the threshold may, for example, be marked as critical passages in the audio signals.
      In different embodiments, multiple threshold values may, for example, be used for different parts of the audio signals and/or different types of signals.
      In different embodiments, frequency-based threshold values may, for example, be set, optionally according to the frequency selective sensitivity of the human ear and/or other psychoacoustic model.
      In different embodiments, the criteria may, for example, be based on an AI-based module (e.g. DNN-based) which may, for example, or would detect the critical passages.
   The result of the detection may, for example, or would return information about the critical passages which may include but not limited to:
      The start of each critical passages in the audio signals; and/or
      The end and/or the duration of each critical passages in the audio signals; and/or
      A level of the criticalness which may, for example, be associated with the intelligibility level and/or listening effort, for example, needed to understand the critical passage; and/or
      Additional information which may, for example, be used to trigger a different processing in the receiving and/or playback device, which may, for example, include filter coefficients, gain values, etc.
an optional QC Metadata Processor, e.g. 1430, that may, for example, be configure or that would format the information received from the Critical Passage Detection module into QC metadata packets, for example, aligned to the audio data frame rate and/or provide them to the audio encoder.
   The QC metadata may, for example, not be used directly during audio production, but may, for example, be encapsulated in data packets and optionally inserted into the audio bitstream, for example, during encoding. Depending on the audio codec in use, different encapsulation methods may, for example, be used, optionally based on the capabilities of the codec, e.g., MHAS packet in the case of MPEG-H Audio or extension payload in case of MPEG AAC, XHE-AAC or USAC.

In a different embodiment the measurement tool, the Critical Passage Detection module, e.g. 1120, and the QC Metadata Processor components, e.g. 1430, may, for example, be merged into a single Intelligibility Processor. In a further embodiment the Intelligibility Processor may, for example, be configured for deriving the QC metadata, e.g. 1431, to be provided to the audio encoder, for example, using an AI-based solution, optionally trained with an audio data set which may include amongst others:
Audio Scenes that are labeled as hard/easy to understand; and/or
Audio Scenes that are labeled as needing a low/medium/high listening effort to understand

Next, reference is made to inventive aspects regarding a method and/or apparatus for receiving an audio bitstream including QC metadata: In a possible embodiment, a method and/or apparatus is proposed (hence embodiments comprise such an apparatus or such a method) for receiving an audio bitstream including, for example, QC metadata and optionally enhance (e.g. for enhancing) the Audio Scene. Such a method and/or apparatus may, for example, embody or comprise, but is not limited to, parts of the system described in FIG. 15, comprising:
An optional Bitstream Parser, e.g. 1510, which may, for example, be configured to extract the metadata (e.g. 1511, e.g. 1512) embedded in the audio bitstream, optionally decode and/or dequantize the metadata if needed and optionally provide the result to the Quality Control Processor, e.g. 1530.
   The metadata provided to the Quality Control Processor may, for example, include at least one of the following:
      QC Metadata,
      Audio Metadata,
      Loudness and/or DRC metadata
      other metadata available
      information about the audio frames and/or groups of frames and/or audio samples that optionally correspond to the available metadata
   In a specific embodiment the QC Metadata, e.g. 1512, optionally comprises or contains information about the critical passages which may, for example, include but is not limited to:
      The start of an or optionally each, critical passages in the audio signals; and/or
      The end and/or the duration of an or even each critical passages in the audio signals; and/or
      A level of the criticalness which may, for example, be associated with the intelligibility level and/or listening effort needed to understand the critical passage; and/or
      Additional information which may, for example, be used to trigger a different processing in the receiving and/or playback device, which may optionally include filter coefficients, gain values, etc.
An optional Quality Control Processor, e.g. 1530, which may, for example be configured to, in addition to the information received from the Audio Bitstream Parser, e.g. 1510, receive information from the system level, e.g. 1503, e.g. 1504.
   The information from the system level may, for example, include at least one of the following:
      Information about the system settings, such as permanent settings of the receiving devices (e.g., preferred language, Dialog Enhancement option, settings for hearing impaired or visually impaired audience, etc.)
      User settings during the current program, e.g., interaction with the Audio Scene by increasing the level of specific audio objects in the Audio Scene and/or change of the position of the audio objects.
      Information about the environment received from the different sensor interfaces of the receiving device (For example like microphones, lice microphones, cameras, GPS location information). For example, if the content is consumed on a mobile in a noisy environment like a bus or at home.
      Information about the additional devices connected to the receiving devices, if for example a TV set is using an external sound device or internal TV speakers for reproducing the sound.
   Based on the metadata received from the Audio Bitstream Parser, e.g. 1510 and the information, e.g. 1503, e.g. 1504, received from the system level the Quality Control Processor, e.g. 1530, may, for example, perform at least one of the following actions:
      Decides if a critical passage is present in any of the audio signals and needs improvement.
      Decides on the level and/or intensity of the improvement to be applied.
      Derives the Quality Control Information needed by the Audio Decoder to enhance the audio quality of the critical passages, for example, for improving the intelligibility and/or reducing the listening effort.
   The Quality Control Information, e.g. 1531, may, for example, include at least one of the following:
      One or more gain sequences which may, for example, need to be applied or can be applied to one or more audio signals part of the Audio Scene.
      Information about which audio signals may, for example, need to be processed in order to improve the critical passages.
      Information about the duration of the critical passages.
The optional Audio Decoder (and optionally Renderer), e.g. 1520, may, for example, be configured to receive the Quality Control Information, e.g. 1531, from the Quality Control Processor, e.g. 1530, and optionally to apply it to the audio signals, e.g. 1513, which may, for example, need improvement for better intelligibility.
   As an example, this may, for example, or would be a typical case for audio that is delivered as a full mix, or in case of NGA, if only static metadata is comprised or contained in the audio stream

In a further embodiment, the Quality Control Processor, e.g. 1530, may, for example, be configured for receiving information, e.g. 1503, from the system level about the current preferences, device settings and/or listening environment (e.g., noisy or quite) and optionally potentially additional information about the current playback situation, e.g., the personal situation of the user (for example, as made known to the device through preferences and/or through sensors of the device, and/or from other devices like hearing aids) and/or time of day (e.g. night or day). Based on this information the Quality Control Processor may, for example, decide if it should evaluate the information about critical passages in the audio content and apply improvements based on the QC Metadata, e.g. 1512, optionally potentially adapted to the current situation, for example, as described by the additional information optionally from the system level. For example, in cases when:
The device has an active setting for: enabling dialog enhancement, improving the dialog intelligibility, hearing impairment, and/or other settings that may be used for improving the intelligibility and/or reducing the listening effort, and/or
The device sensor interfaces indicate a noisy environment, and/or
The user has actively selected an option to improve the intelligibility and/or reduce the listening effort,
   then the Quality Control Processor may, for example, or even will trigger the improvement. Otherwise, the improvement may, for example, or even will not be triggered.

In a further embodiment, the Quality Control Processor, may, for example, or even will use information from the QC Metadata indicated if the improvement should be triggered or not.

In a further embodiment, the Quality Control Processor may, for example, be configured to derive the Quality Control Info, based on the information described in the previous embodiments and which (or wherein) the Quality Control Info comprises or includes one or more filter coefficients.

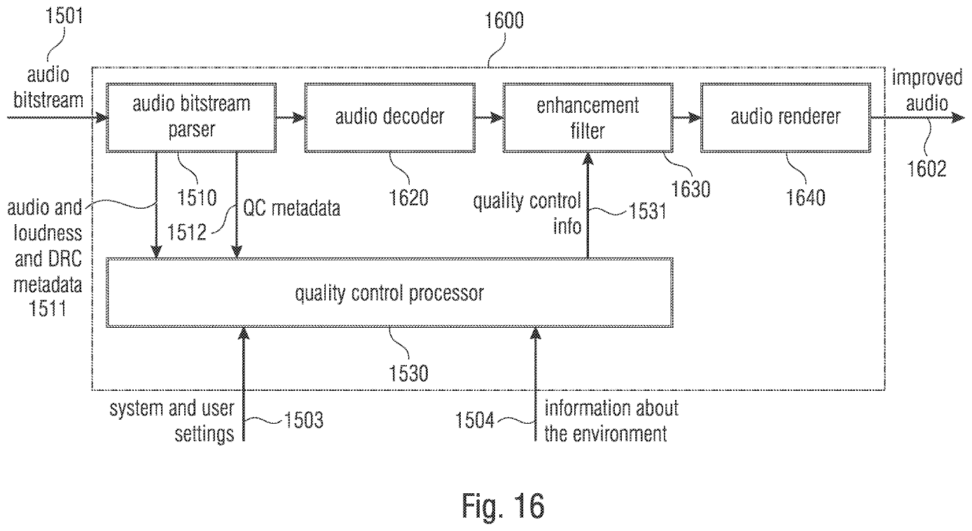

Reference is made to FIG. 16. FIG. 16 shows a schematic view of an audio decoder with filter according to embodiments of the invention. In comparison to the embodiment shown in FIG. 15 decoder 1600 comprises separated decoding and rendering units 1620 and 1640, wherein in between an enhancement filter 1630 is implemented.

As illustrated in FIG. 16, the Enhancement Filter 1630 may, for example, use the Quality Control Info 1531 to process one or more decoded audio signals, for example, for improving one or more audio signals, optionally before they are rendered together into the final audio output.

Hence, FIG. 16 may show an example system architecture using metadata for enhancing the audio scene (Decoder side) according to embodiments. It is to be noted that all elements of audio decoder 1600 are optional.

In a different embodiment, the Enhancement Filter, e.g. 1630, may, for example, be used directly on the final rendered output. In a different embodiment, the Enhancement Filter, e.g. 1630, may, for example, be used before and after the final rendered output, optionally based on the Quality Control info available.

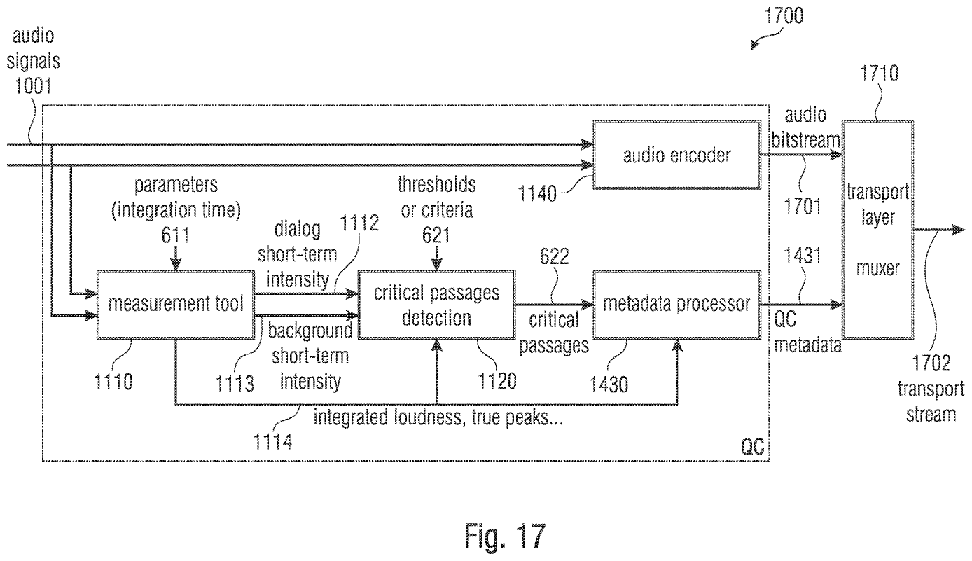

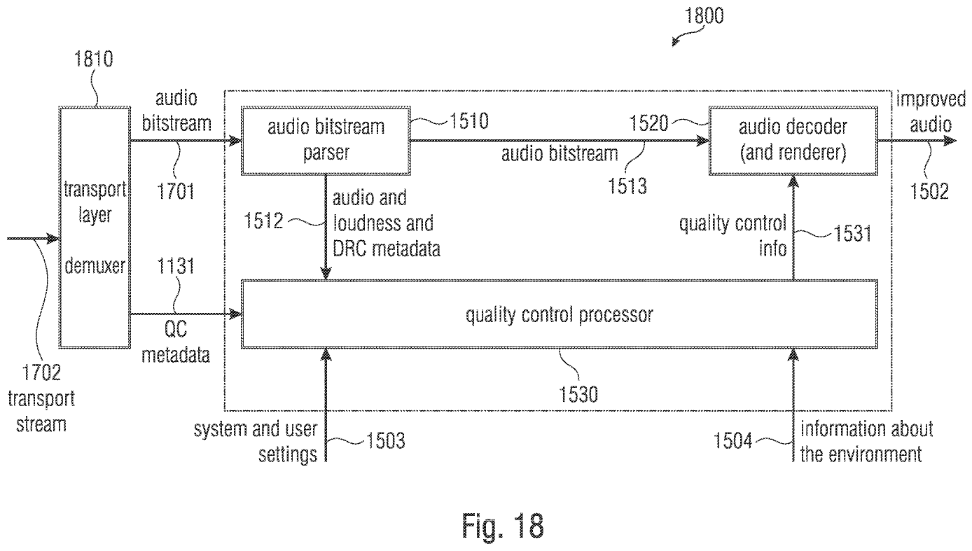

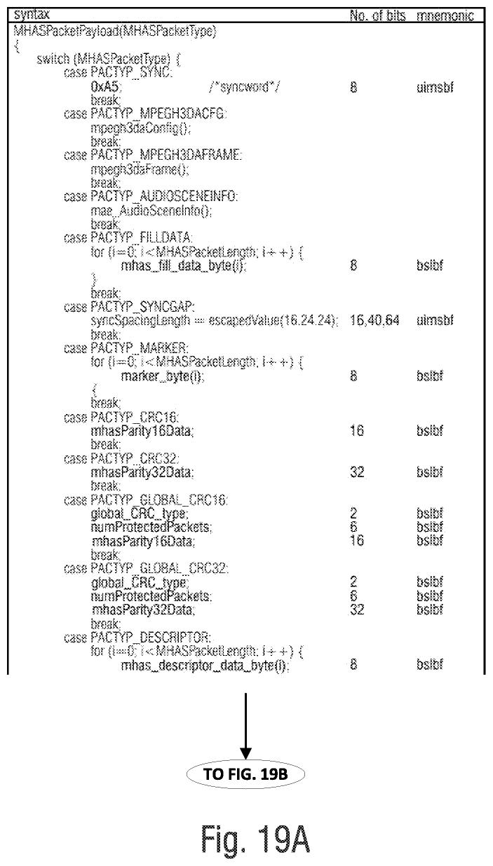

Next, reference is made to inventive aspects regarding an enhancement of the Audio Scene based on additional metadata on a different channel according to embodiments: In a further embodiment, the method and/or apparatus described above may, for example, be using a different channel to deliver the additional metadata. For example, the additional metadata could, for example, be embedded into new descriptors, for example, for MPEG-2 Transport Stream and/or file format boxes for ISOBMFF. FIGS. 17 and 18 illustrate such a workflow according to embodiments, where the QC metadata is embedded in a dedicated carriage c=mechanism on transport layer.

FIG. 17 shows a schematic view of a bitstream provider with an optional multiplexer according to embodiments of the invention. In comparison to the embodiment shown in FIG. 14, bitstream provider 1700 comprises an additional, optional multiplexer 1710 and the QC metadata 1431 is provided to said multiplexer 1710 instead of to the encoding unit 1410. Multiplexer 1710 is configured to provide a transport stream 1711 based on the audio bitstream 1702 and the QC metadata 1431. Hence, in other words, FIG. 17 shows a schematic view of an example system architecture using metadata on transport layer for enhancing the audio scene (Encoder side) according to embodiments. It is to be noted that all elements of bitstream provider 1700 are optional.

FIG. 18 shows a schematic view of an audio decoder with an optional de-multiplexer according to embodiments of the invention. In comparison to the embodiment shown in FIG. 16, audio decoder 1800 comprises an additional, optional de-multiplexer 1810, which is configured to extract audio bitstream 1701 and QC metadata 1131 from the transport stream 1702. Hence, in other words, FIG. 18 shows a schematic view of an example system architecture using metadata on transport layer for enhancing the audio scene (Decoder side) according to an embodiment. It is to be noted that all elements of audio decoder 1800 are optional.

As an illustrative example, with regard to FIGS. 6 to 18, it is to be noted that measurement tools 610, 810, 920, 1110 may comprise same, similar or corresponding features and functionalities. In particular, measurement tools 610, 810, 920, 1110 may correspond to or be examples of short-term intensity determinator 110 (or at least a portion thereof), as shown in FIG. 1 as well as in FIG. 3. Quality control processors 620, 820 and Critical Passages Detectors 1120 may correspond to or be examples for analysis result provider 120. Hence, an analysis result may comprise an information about critical passages.

Therefore, any details, features and functionalities as discussed in the context of FIGS. 6 to 18 may be incorporated (e.g. directly, similarly or in a corresponding manner) in the embodiments as discussed in FIG. 1 and FIG. 3.

Accordingly, any details, features and functionalities as discussed in the context of FIGS. 6 to 18 may be incorporated (e.g. directly, similarly or in a corresponding manner) in the embodiments as discussed in FIGS. 2, 3, and 4, e.g. with FIGS. 9 and 10 showing possible artificial intelligence based implementations of the embodiment of FIG. 2; with FIGS. 11, 12 and 13 showing possible implementations of the embodiment of FIG. 3; with FIGS. 14, and 17 showing possible implementations of the embodiment of FIG. 4; and with FIGS. 15, 16 and 18 showing possible implementations of the embodiment of FIG. 5.

Hence, as an example, audio master 1140, critical passages detector 1120 and metadata processor and embedder 1130 may correspond to or may be examples of metadata provider 320 and file or stream provider 330.

As another example, audio bitstream 1501 may correspond or be an example, of encoded media representation 501, with quality control processor 1530 corresponding to or being an example of quality control information provider 510 and with audio decoder 1520 corresponding or being an example of decoded audio representation provider 520.

Hence, for the sake of brevity, elements with same or similar names or same or similar reference signs may comprise same, similar or corresponding features and functionalities. For the sake of brevity, embodiments are explained by example. Hence it is to be noted that any combination of the respective features of the above-discussed embodiments may be performed.

Next, reference is made to inventive aspects regarding example usages of the embodiments:

Alternatives or examples of the above referenced “QC metadata” may comprise one or more of the following: clarity information metadata, accessibility enhancement metadata, speech transparency metadata, speech enhancement metadata, understandability metadata, content description metadata, local enhancement metadata, signal descriptive metadata.

Furthermore, the MPEG-H 3D Audio system can, for example, be used for caring the QC metadata and enhancing the decoded and rendered audio based on the QC metadata for better intelligibility and reduced listening effort.

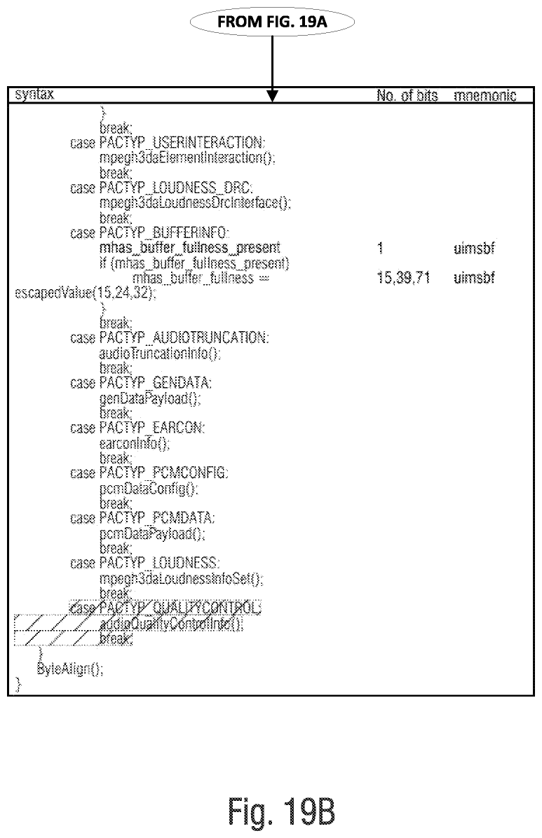

The following FIGS. 19 to 21 show examples for a respective syntax that may be implemented according to embodiments.

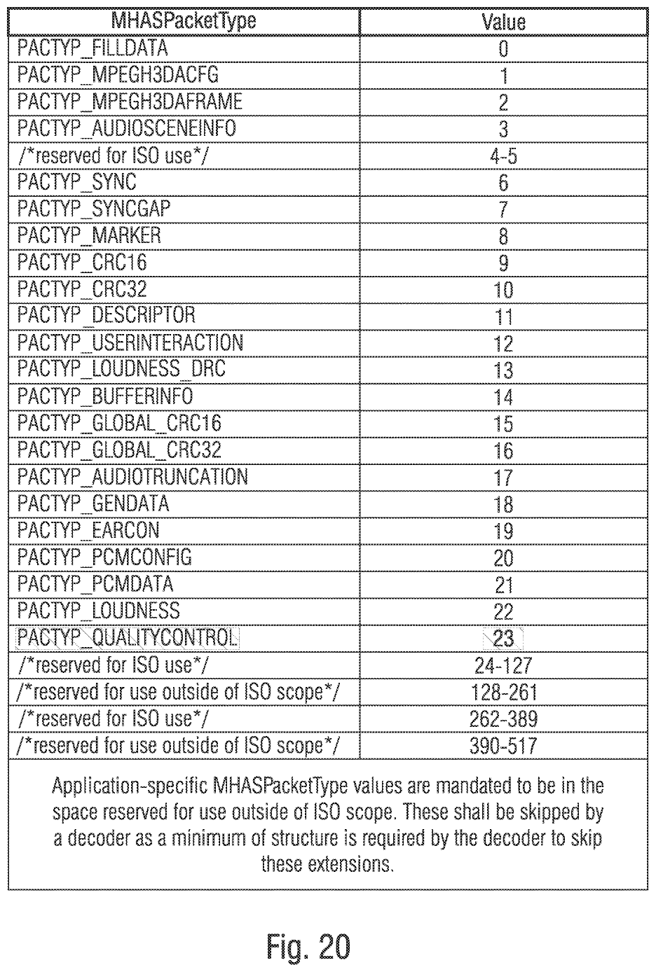

For example, a new MHAS packet may be defined for carrying the QC metadata: Reference is made to FIG. 19, e.g. also referred to as Table 1-Syntax of MHASPacketPayload( ) and FIG. 20, e.g. also referred to as Table 2-Value of MHASPacketType.

The following new definitions can, for example, be added into the MPEG-H 3D Audio standard, or into any other audio standard (wherein names of packets, of packet types and of information items may, optionally, be chosen as appropriate (e.g. in the terminology of the respective standard).

Next, an example for a PACTYP_QUALITYCONTROL according to embodiments is discussed: The MHASPacketType PACTYP_QUALITYCONTROL may, for example, be used to embed information about the audio quality control metadata available in the audioQualityControlInfo( ) structure and to feed quality control info data in the form of the audioQualityControlInfo( ) structure to the decoder.

For example, if present, the MHASPacketType PACTYP_QUALITYCONTROL shall follow PACTYP_MPEGH3DACFG for each random access point and stream access point.

Updated audio quality control information may, for example, be available for instance also in-between two random access points, in which case the quality control information is associated with the next MHAS packet of type PACTYP_MPEGH3DAFRAME. The MHASPacketType PACTYP_QUALITYCONTROL can, for example, be used to convey the updated audio quality information to the decoder without needing a reconfiguration of the audio decoder.

Next, an example for an Audio Quality Control according to embodiments is discussed: As a general aspect, it is to be noted that the audio Quality Control metadata is, for example, used for signalling the critical parts (or critical passages, or critical portions) of the audio signals audio quality for better intelligibility and reduced listening effort.

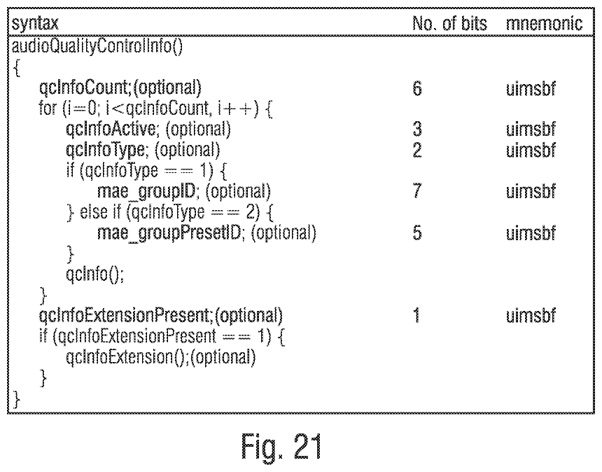

Next, reference is made to an example for a Syntax of such an Audio Quality Control: FIG. 21, e.g. also referred to as Table 334 list the syntax of audio quality metadata. FIG. 21 may in particular be referred to as Table 334-Syntax of audioQualityControlInfo( )

| | |
|---|---|
| qcInfoCount | This field signals, for example, the number of structures |
| | carrying audio quality control information are available |
| | in the stream. |
| qcInfoActive | This flag specifies, for example, when the audio quality |
| | control information shall be applied. For example, based |
| | on the values of the qcInfoActive flag the audio quality |
| | control information may be decoded and applied into |
| | the audio scene according to receiver settings. |
| qcInfoType | This field signals, for example, whether the following |
| | qcInfo( ) to a to a specific audio element (mae_groupID) |
| | or to an audio scene block refers defined, for example, |
| | by a combination of audio elements |
| | (mae_groupPresetID). |

Alternatively or, for example in addition, a new extension element may be defined, e.g., in the mpegh3daConfigExtension( ) or usacConfigExtension( ) or extension element (usacExtElement).

Hence, optionally and in general, a bitstream provider according to embodiments may be configured to include the quality control information into an extension payload of a bitstream stream, e.g. as indicated in FIG. 19. Furthermore, as shown in FIG. 19, a bitstream provider according to embodiments may be configured to include the quality control information into an MHAS packet.

Hence, embodiments may be implemented as standalone QC tool or as extension to existing audio coding standards.

Further embodiments: According to embodiments of the invention the following examples are provided:

Example 1: A method for decoding a bitstream comprising or containing an audio scene and controlling the level of improvement of the audio scene, comprising:
receiving a bitstream comprising or containing encoded audio data including one or more audio signals that comprise or contain at least two different audio types which can be characterized e.g., as dialog and/or commentator and/or background and/or music and effects;
   wherein the at least two different audio types may be comprised or contained in at least two different audio signals, e.g., stereo channel signal with music and effects and a mono dialog audio object; or may be comprised or contained in the same one or more audio signals, e.g., a stereo complete main containing a mix of the music and effects with the dialog, detecting critical passages present in at least one audio signal comprised or contained in the audio stream, which may, for example, need an improvement under the current system settings;
   wherein a passage is considered critical if the reproduction of the at least two different audio types, e.g., dialog and background, leads to an increased listening effort for the user;
   wherein the current system settings include information about user selections (e.g., enabled dialog enhancement option, or hearing-impaired option, or preferred language) and/or information about the environment (e.g., if the content is consumed on a mobile in a noisy environment like a bus or at home using a dedicated sound system)
decoding the audio data and process the detecting critical passages to improve the audio quality of the complete audio scene and reduce the listening effort for the user.

Example 2: A method according to example 1, comprising further:
receiving metadata associated with the audio scene comprising or containing information about critical passages present in at least one audio signal contained in the audio stream;
processing the information about critical passages present in at least on audio signal comprised or contained in the audio stream and at least one additional information coming from the system level or from other metadata in the audio stream, to decide if critical passages present in at least on audio signal comprised or contained in the audio stream can be improved, decoding an encoded audio stream and at the decision that critical passages present in at least on audio signal comprised or contained in the audio stream can be improved, use the information about critical passages present in at least on audio signal to improve the audio quality of the complete audio scene.

Example 3: A method according to any of the examples 1 or 2, wherein the information about critical passages comprises or contains at least one parameter associated with the short-term intensity of an audio signal in the audio scene or associated with the short-term intensity differences between two or more audio types comprised or contained in the audio scene.

Example 4: A method according to any of the examples 1 to 3, wherein the information about critical passages comprises or contains at least one of the following parameters:
Information about which audio signals comprise or contain critical passages
Information about which audio signals need to be processed in order to improve the critical passages, which might not be present all audio signals.
One or more gain sequences which need to be applied to one or more audio signals
Information about the start, end and/or duration of at least one critical passage.
Short-term intensity values associated with at least one audio signal
Short-term intensity differences associated with at least two audio types which can be characterized e.g., as dialog and/or commentator and/or background and/or music and effects;

Example 21: A system supporting audio production, post-production or quality control (QC) phase configured to receive an audio scene as input and to generate a QC report of the audio scene wherein
the input audio scene can be given in different formats commonly used in audio production such as a final mix as mono, stereo, surround, or immersive format (e.g. compressed or uncompressed), as well as a combination of audio channels and audio objects as commonly used with NGA systems, e.g., encapsulated into an audio master file, and
the QC report includes information about critical passages, i.e., passages of the audio scene for which specific signal characteristics of at least one audio component in the audio scene do not meet desired criteria, and
short-term intensities are used as signal characteristics, where the short-term intensity of the signals can be computed in one of the following ways:
   The local power of the audio signals.
   The power of a filtered signal where the filtering mimics the frequency selective sensitivity of the human ear.
   Short-term or momentary loudness as per ITU-R BS.1770 and EBU R 128 or a variation of them, e.g., using a different time window size.
   A computational model of loudness.
   An AI-based intensity estimate.

Example 22: The system of example 21 configured to use at least one absolute or relative thresholds on the audio components or group of audio components as desired criteria wherein absolute thresholds are related to the short-term intensity of selected audio components or group of audio components, and
relative thresholds are related to the short-term intensity differences between audio components or group of audio components.

Example 23: The system of one of example 21-22 configured to combine multiple audio signals of the same or similar type to form component groups. The process to combine the signals may be done for example based on:
the importance of the multiple audio signals, where the importance of the audio signals is manually set or determined based on the speech parts contained in the signal; and/or
the contribution of each audio signal to the final mix, considering audio masking effects and the properties of the human hearing system

Example 24: The system of one of examples 21-23 configured to analyze the audio components associated with dialog type (e.g., speech, commentary, audio description, etc.) and the ones associated with background type (e.g., music and effects, stadium atmosphere, etc.).

Example 25: The system of example 21 where the QC report may include but not limited to:
The start of each critical passages in the audio signals; and/or.
   The end or the duration of each critical passages in the audio signals; and/or
   A level of the criticalness which may be associated with the intelligibility level or listening effort needed to understand the critical passage; and/or
Additional information which may be used to support the production, post-production, or QC phases.

Example 26: The system of example 21 configured to use a source separation module (possibly AI-based) to estimate dialogue and background component groups given their mixture to be used if separate dialogue and background component groups are not available from input audio scene.

Example 27: The system of example 21 configured to output an enhanced audio scene where the critical passages have been automatically enhanced.

Example 28: A system supporting audio production, post-production or quality control (QC) phase configured to receive an audio scene as input and to generate a QC report of the audio scene wherein
the input audio scene in different formats commonly used in audio production such as a final mix as mono, stereo, surround, or immersive format (compressed or uncompressed), as well as a combination of audio channels and audio objects as commonly used with NGA systems, e.g., encapsulated into an audio master file, and
the QC report includes information about critical passages, i.e., passages of the audio scene for which specific signal characteristics of at least one audio component in the audio scene do not meet desired criteria, and
an end-to-end detector module (possibly AI-based) to detect critical passages directly from the inputs, where the detector can switch to different submodules (Detector 1, Detector 2, etc.) depending on the input format type.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

[1] M. Torcoli, C. Simon, J. Paulus, D. Straninger, A. Riedel, V. Koch, S. Wirts, D. Rieger, H. Fuchs, C. Uhle, S. Meltzer and A. Murtaza, “Dialog+ in Broadcasting: First Field Tests Using Deep-Learning-Based Dialogue Enhancement,” in IBC (International Broadcasting Convention), 2021.
[2] C. D. Mathers, “A Study of Sound Balances for the Hard of Hearing,” BBC White Paper, 1991.
[3] C. Simon, M. Torcoli and J. Paulus, “MPEG-H Audio for Improving Accessibility in Broadcasting and Streaming,” arXiv: 1909.11549, 2019.
[4] M. Torcoli, T. Robotham and E. Habets, “Dialogue Enhancement and Listening Effort in Broadcast Audio: A Multimodal Evaluation,” in 14th IEEE International Conference on Quality of Multimedia Experience (QoMEX), 2022.
[5] M. Armstrong, “From Clean Audio to Object Based Broadcasting,” BBC R&D White Paper WHP 324, 2016.
[6] Netflix, “Netflix Sound Mix Specifications & Best Practices v1.4,” 2021. [Online]. Available: https://partnerhelp.netflixstudios.com/hc/en-us/articles/360001794307-Netflix-Sound-Mix-Specifications-Best-Practices-v1-4.
[7] M. Torcoli, A. Freke-Morin, J. Paulus, C. Simon and B. Shirley, “Preferred Levels for Background Ducking to Produce Esthetically Pleasing Audio for TV with Clear Speech,” J. Audio Eng. Soc., vol. 67, no. 12, pp. 1003-1011, 2019.
[8] Recommendation, “ITU-RBS.1770-4, Algorithms to measure audio programme loudness and true-peak audio level,” 2015.
[9] J. Paulus and M. Torcoli, “Sampling Frequency Independent Dialogue Separation,” in 30th European Signal Processing Conference (EUSIPCO), 2022.
[10] B. C. J. Moore, B. R. Glasberg and T. Baer, “A model for the prediction of thresholds, loudness, and partial loudness,” J. Audio Eng. Soc., vol. 45, no. 4, p. 224-240, 1997.

1. An audio decoder for providing a decoded audio representation on the basis of an encoded media representation,
wherein the audio decoder is configured to acquire a quality control information from the encoded media representation; and
wherein the audio decoder is configured to provide the decoded audio representation in dependence on the quality control information.

2. Audio decoder according to claim 1,
wherein the encoded media representation comprises a representation of an audio content comprising a speech portion and a background portion;
wherein the audio decoder is configured to receive a quality control information comprising at least one of
an information for modifying a relationship between an intensity of the speech portion of the audio content and the background portion of the audio content;
an information for modifying a speech portion of the audio content;
an information for improving a speech intelligibility of a speech portion of the audio content;
an information for selectively enabling and disabling an improvement of a speech intelligibility of the speech portion of the audio content;
an information indicating for which passages of the audio content an improvement of a speech intelligibility of the speech portion of the audio content is allowable;
an information indicating critical time portions of the audio content;
an information indicating for which passages of the audio content an improvement of a speech intelligibility of the speech portion of the audio content is considered recommendable under hindered listening conditions;
an information indicating whether a portion of the audio content comprises a speech intelligibility measure or a speech intelligibility related characteristic which is in a predetermined relationship with one or more threshold values;
an information indicating whether an audio scene is considered to be hard to understand or easy to understand,
an information indicating whether an audio scene is considered to be understandable with low listening effort, or to be understandable with medium listening effort, or to be understandable with high listening effort;
an information indicating passages in the audio content in which a short-term intensity difference between the speech portion of the audio content and the background portion of the audio content is smaller than a threshold value or equal to a threshold value;
an information indicating passages in the audio content in which a short-term intensity of the speech portion of the audio content is smaller than a threshold value or equal to a threshold value; and
to provide the decoded audio information in dependence thereof.

3. Audio decoder according to claim 1,
wherein the audio decoder is configured to perform a speech enhancement in dependence on the quality control information; and/or
wherein the audio decoder is configured to selectively perform the speech enhancement for passages of the audio content indicated by the quality control information; and/or
wherein the audio decoder is configured to selectively perform the speech enhancement for passages of the audio content for which the quality control information indicates a difficult intelligibility; and/or

4. Audio decoder according to claim 1,
wherein the audio decoder is configured to receive a control information defining whether a speech enhancement should be performed, and
wherein the audio decoder is configured to activate and deactivate the speech enhancement in dependence on the control information defining whether a speech enhancement should be performed.

5. Audio decoder according to claim 1,
wherein the audio decoder is configured to receive a control information defining an interaction with an audio scene; and
wherein the audio decoder is configured to activate and deactivate the speech enhancement in dependence on the control information defining an interaction with the audio scene, and/or
wherein the audio decoder is configured to adjust one or more parameters of the speech enhancement in dependence on the control information defining an interaction with the audio scene.

6. Audio decoder according to claim 1,
wherein the audio decoder is configured to adjust one or more parameters of a speech enhancement in dependence on the quality control information.

7. Audio decoder according to claim 1,
wherein the audio decoder is configured to acquire an information about a listening environment, and wherein the audio decoder is configured to decide whether to perform a speech enhancement or not in dependence on the information about the listening environment and in dependence on the quality control information, and/or
wherein the audio decoder is configured to adjust one or more parameters of a speech enhancement in dependence on the quality control information and in dependence on the information about the listening environment, and/or
wherein the audio decoder is configured to acquire a user input, and wherein the audio decoder is configured to decide whether to perform a speech enhancement or not in dependence on the user input and in dependence on the quality control information, and/or
wherein the audio decoder is configured to acquire a system level information, and wherein the audio decoder is configured to decide whether to perform a speech enhancement or not in dependence on the information about the listening environment and in dependence on the quality control information, and/or
wherein the audio decoder is configured to acquire an information about one or more sound reproduction devices, and wherein the audio decoder is configured to adjust one or more parameters of a speech enhancement in dependence on the quality control information and in dependence on the information about the one or more sound reproduction devices.

8. Audio decoder according to claim 1,
wherein the audio decoder is configured to acquire one or more out of the following system level information:
an information about a system setting,
an information about a user setting,
an information about an environment and
an information about one or more additional devices, and
wherein the audio decoder is configured to perform one or more of the following functionalities in dependence on the quality control information and the system level information:
decide of a critical passage is present in the audio content and needs improvement
decide on the level and/or intensity of the quality improvement to be applied
derive a quality control information needed by an audio decoder to enhance an audio quality of one or more critical passages for improving an intelligibility and/or reducing a listening effort.

9. Audio decoder according to claim 1,
wherein the quality control information comprises one or more of
one or more gain sequences which need to be applied to one or more audio signals part of an audio scene or to one or more portions of an audio content
information about which signals or which portions of an audio content should be processed in order to improve one or more critical passages
information about a duration of the one or more critical passages.

10. Audio decoder according to claim 1,
wherein the audio decoder is configured to apply the quality control information in order to acquire a quality-enhanced version of the audio content.

11. Audio decoder according to claim 1,
wherein the audio decoder is configured to apply the quality control information to the audio content in order to acquire a quality-enhanced version of the audio content.

12. Audio decoder according to claim 1,
wherein the audio decoder is configured to perform a filtering in order to acquire a quality-enhanced version of the audio content,
wherein the audio decoder is configured to determine one or more filter coefficients of the filtering in dependence on the quality control information.

13. Audio decoder according to claim 1,
wherein the audio decoder is configured to determine one or more filter coefficients of the filtering
in dependence on a system level information., and/or
in dependence on an information about one or more sound reproduction devices, and/or
in dependence on an information about a listening environment, and/or
in dependence on an information about a user input.

14. Audio decoder according to claim 1,
wherein the audio decoder is configured to apply the filtering to one or more output signals of a decoder core, or wherein the audio decoder is configured to apply the filtering to one or more rendered audio signals which are acquired using a rendering of output signals of a decoder core.

15. Audio decoder according to claim 1,
wherein the audio decoder is configured to trigger a time-frequency modification in dependence on the quality control information.

16. Audio decoder according to claim 1,
wherein the audio decoder is configured to detect one or more critical passages present in at least one audio signal comprised in the encoded media representation.

17. Audio decoder according to claim 1,
wherein the audio decoder is configured to decode encoded audio data and to process one or more detected critical passages,
wherein the audio decoder is configured to process the one or more detected critical passages to improve an audio quality of an audio scene and/or to reduce a listening effort for the user.

18. Audio decoder according to claim 1,
wherein the quality control information comprises metadata associated with the audio scene comprising information about critical passages present in at least one audio signal comprised in the audio stream;
wherein the audio decoder is configured to process the information about critical passages present in at least one audio signal comprised in the encoded media representation and at least one additional information coming from a system level or from other metadata in the encoded media representation, to decide if critical passages present in at least one audio signal comprised in the encoded media representation can be improved,
wherein the audio decoder is configured to decode an encoded audio stream comprised in the encoded media representation or making up the encoded media representation, and at the decision that critical passages present in at least on audio signal comprised in the audio stream can be improved, use the information about critical passages present in at least on audio signal to improve the audio quality of the complete audio scene.

19. Audio decoder according to claim 1,
wherein the information about critical passages comprises at least one parameter associated with the short-term intensity of an audio signal in the audio scene or associated with the short-term intensity differences between two or more audio types comprised in the audio scene.

20. Audio decoder according to claim 1,
wherein the information about critical passages comprises at least one of the following parameters:
Information about which audio signals comprise critical passages;
Information about which audio signals need to be processed in order to improve the critical passages, which might not be present all audio signals;
One or more gain sequences, or with a temporal resolution of no more than 1000 ms, or with a temporal resolution of no more than 400 ms, or of no more than 100 ms, or of no more than 40 ms, or of no more than 20 ms, or with a temporal resolution between 3000 ms and 400 ms, or of one audio frame, or of two audio frames, or of no more than ten audio frames] which need to be applied to one or more audio signals;
Information about the start, and/or end and/or duration of at least one critical passage,
Short-term intensity values associated with at least one audio signal;
Short-term intensity differences associated with at least two audio types, which can be characterized e.g., as dialog and/or commentator and/or background and/or music and effects.

21. Audio decoder according to claim 1,
wherein the audio decoder is configured to evaluate the quality control information, which is comprised in an MHAS packet.

22. Audio decoder according to claim 1,
wherein the audio decoder is configured to evaluate an audio quality control metadata (e.g. qcInfo( )) and an information about the audio quality control metadata;
wherein the information about the audio quality control metadata describes how many data structures qcInfo( )) carrying audio quality control metadata are present in an MHAS packet, and/or
wherein the information about the audio quality control metadata describes, or gives an indication, when the audio quality control metadata should be applied (e.g. qcInfoActive), and/or
wherein the information about the audio quality control metadata describes, or gives an indication, in which cases the audio quality control metadata should be applied, and/or
wherein the information about the audio quality control metadata describes, or gives an indication, in which cases a respective decoder or respective renderer may choose to apply the audio quality control metadata, and/or
wherein the information about the audio quality control metadata indicates whether the audio quality control metadata is associated with a specific audio element or with an audio scene defined by a combination of audio elements; and/or
wherein the information about the audio quality control metadata indicates a type of audio content the audio quality control metadata is associated with; and/or
wherein the information about the audio quality control metadata indicates to which type of audio content the audio quality control metadata may be applied to, in order to manipulate the an audio element with the respective type; and/or
wherein the information about the audio quality control metadata comprises an identifier indicating to which audio element or group of audio elements a respective audio quality control metadata is associated.

23. Audio decoder according to claim 1,
wherein the audio decoder is configured to evaluate audio quality control information with a first granularity and audio quality control information with a second granularity.

24. Audio decoder according to claim 1,
wherein the audio decoder is configured to evaluate a plurality of different audio quality control metadata associated with different audio elements and/or different combinations of audio elements.

25. Method for providing a decoded audio representation on the basis of an encoded media representation, comprising:
acquiring a quality control information from the encoded media representation; and
providing the decoded audio representation in dependence on the quality control information.

26. A non-transitory digital storage medium having a computer program stored thereon to perform the method for providing a decoded audio representation on the basis of an encoded media representation, the method comprising:
acquiring a quality control information from the encoded media representation; and
providing the decoded audio representation in dependence on the quality control information,
when said computer program is run by a computer.
